(19) United States
(12) Patent Application Publication
(10) Pub. No.: US 2017/0338470 A1
(43) Pub. Date: Nov. 23, 2017

(54) NEGATIVE ELECTRODE ACTIVE MATERIAL, SECONDARY BATTERY, MANUFACTURING METHOD OF NEGATIVE ELECTRODE, AND PROCESSING DEVICE OF NEGATIVE ELECTRODE

(71) Applicant: SEMICONDUCTOR ENERGY LABORATORY CO., LTD., Atsugi-shi, Kanagawa-ken (JP)

(72) Inventors: Nobuhiro INOUE, Atsugi (JP); Hiroyuki MIYAKE, Atsugi (JP); Yuika SATO, Isehara (JP)

(21) Appl. No.: 15/535,596

(22) PCT Filed: Dec. 16, 2015
(86) PCT No.: PCT/IB2015/059649

§ 371 Date: Jun. 13, 2017

(30) Foreign Application Priority Data
Dec. 26, 2014 (JP) 2014-264414

(51) Int. Cl. H01M 4/36; H01M 4/58; H01M 4/505; H01M 4/04; H01M 4/48; H01M 4/38; H01M 10/0525; H01M 4/525

(52) U.S. Cl. CPC H01M 4/364; H01M 10/0525; H01M 4/5825; H01M 4/525; H01M 4/0459; H01M 4/483; H01M 4/386; H01M 4/505

(57) ABSTRACT

Although a material containing silicon attracts attention as a high-capacity negative electrode active material, it has a problem of having a large irreversible capacity at the initial charge and discharge cycle.

As a negative electrode active material, a particle which is a mixture of silicon, lithium metasilicate, and lithium oxide is used. Because lithium metasilicate and lithium oxide are already contained in the particle of the negative electrode active material, a compound containing lithium and oxygen (lithium orthosilicate and lithium metasilicate), which is a cause of the irreversible capacity at the initial charge, is not generated any more. This enables a negative electrode active material with a small irreversible capacity.

### TECHNICAL FIELD

The present invention relates to an object, a method, or a manufacturing method. The present invention relates to a process, a machine, manufacture, or a composition of matter. One embodiment of the present invention particularly relates to a semiconductor device, a display device, a light-emitting device, a power storage device, an imaging device, a driving method thereof, or a manufacturing method thereof. One embodiment of the present invention particularly relates to a negative electrode active material for a secondary battery, a negative electrode for a secondary battery, a secondary battery, a manufacturing method of a negative electrode for a secondary battery, and a processing device of a negative electrode for a secondary battery.

### BACKGROUND ART

In recent years, the widespread use of portable information terminals typified by smart phones and tablet terminals and mobile devices such as laptop PCs and portable game machines has raised expectations of small, lightweight, and high-energy-density secondary batteries incorporated in these terminals or devices.

Increasing the capacity density of a negative electrode is important to increase the energy density of a secondary battery. Graphite, which is widely used as a negative electrode active material of a lithium-ion secondary battery, already has a capacity density of 360 mAh/g or more, which is close to the theoretical capacity density of graphite of 372 mAh/g.

To further increase the energy density of a secondary battery, negative electrode active materials with higher theoretical capacity densities have been examined, and silicon (Si), tin (Sn), germanium (Ge), and gallium (Ga) which are alloyed with lithium, an oxide thereof, an alloy thereof, and the like have attracted attention.

For example, Patent Document 1 and patent Document 2 disclose secondary batteries in which a material containing silicon is used as a negative electrode active material.

### REFERENCE

### Patent Document

[Patent Document 1] Japanese Published Patent Application No. 2004-47404

[Patent Document 2] PCT International Publication No. WO2012/049826

### SUMMARY OF THE INVENTION

### Problems to be Solved by the Invention

However, a material containing silicon has a problem of having a large irreversible capacity at the initial charge and discharge cycle. For example, in the case where silicon monoxide (SiO) is used as a negative electrode active material, the reaction expressed by the following formula (1) occurs in the initial charge.

4SiO+17.2Li→3Li_{4.4}Si+Li₄SiO₄ (1)

Lithium of lithium orthosilicate (Li₄SiO₄) cannot be eliminated at the negative electrode potential, causing an irreversible capacity, which makes the theoretical initial charge and discharge efficiency of SiO be 76.9%.

Thus, in the case where SiO is used as a negative electrode active material, about one fourth of the capacity of the negative electrode becomes the irreversible capacity by the initial charge and discharge to lower the capacity of the secondary battery.

In consideration of these conditions, with one embodiment of the present invention, a novel negative electrode active material for a lithium-ion secondary battery is provided. Furthermore, a novel lithium-ion secondary battery is provided. Moreover, a novel manufacturing method of a negative electrode for a lithium-ion secondary battery and a processing device of a negative electrode that can be used in the manufacturing method are provided. More specifically, a negative electrode active material for a high-capacity lithium-ion secondary battery and a high-capacity lithium-ion secondary battery are provided. Furthermore, a manufacturing method of a negative electrode for a high-capacity lithium-ion secondary battery and a processing device of a negative electrode that can be used in the manufacturing method are provided.

An object of one embodiment of the present invention is to provide a novel power storage device, an electronic device including a novel secondary battery, or the like. Note that the description of these objects does not disturb the existence of other objects. In one embodiment of the present invention, there is no need to achieve all of these objects. Other objects will be apparent from and can be derived from the description of the specification, the drawings, the claims, and the like.

### Means for Solving the Problems

To achieve the above-described objects, in one embodiment of the present invention, a particle which is a mixture of silicon, lithium metasilicate, and lithium oxide is used as a negative electrode active material.

Because lithium metasilicate and lithium oxide are already contained in the particle of the negative electrode active material, a compound containing lithium and oxygen (lithium orthosilicate and lithium metasilicate), which is a cause of the irreversible capacity at the initial charge, is not generated any more. This enables a negative electrode active material with a small irreversible capacity.

One embodiment of the present invention is a negative electrode active material for a lithium-ion secondary battery, in which the negative electrode active material is a particle including Si, Li₂SiO₃, and Li₂O and in which, in a ²⁹Si-NMR spectrum of the particle, an intensity at −78 ppm of the ²⁹Si-NMR spectrum is higher than or equal to 50 times an intensity at −108 ppm.

Furthermore, another embodiment of the present invention is a lithium-ion secondary battery including a positive electrode and a negative electrode, in which the positive electrode includes a positive electrode active material, in which the positive electrode active material includes a positive electrode active material particle satisfying LiₐMn_{b}Ni_{c}O_{d} (1.6≦a≦1.848, 0.19≦d/b≦0.935, 2.5≦d≦3), in which the negative electrode includes a negative electrode active material, in which the negative electrode active material includes a negative electrode active material particle including Si, Li₂SiO₃, and Li₂O, and in which, in a ²⁹Si-NMR spectrum of the negative electrode active material particle, an intensity at −78 ppm of the ²⁹Si-NMR spectrum is higher than or equal to 50 times an intensity at −108 ppm.

### Effect of the Invention

with one embodiment of the present invention, a novel negative electrode active material for a lithium-ion secondary battery can be provided. Furthermore, a novel lithium-ion secondary battery can be provided. More specifically, a negative electrode active material for a high-capacity lithium-ion secondary battery and a high-capacity lithium-ion secondary battery can be provided.

Furthermore, a novel power storage device, an electronic device including a novel secondary battery, or the like can be provided. Note that the description of these effects does not disturb the existence of other effects. One embodiment of the present invention does not necessarily have all of these effects. Other effects will be apparent from and can be derived from the description of the specification, the drawings, the claims and the like.

### BRIEF DESCRIPTION OF DRAWINGS

FIG. 1 A plan view and cross-sectional view of a negative electrode.

FIG. 2 Cross-sectional views of a negative electrode current collector and a negative electrode active material layer.

FIG. 3 A plan view and cross-sectional views of a negative electrode.

FIG. 4 Plan views and cross-sectional view of negative electrodes.

FIG. 5 Views illustrating a manufacturing method of a negative electrode active material, a negative electrode active material layer, and a negative electrode.

FIG. 6 Cross-sectional views illustrating positive electrode active materials that can be used for a secondary battery.

FIG. 7 A perspective view, a plan view, and a cross-sectional view illustrating a structure example of a secondary battery.

FIG. 8 A perspective view, a plan view, and a cross-sectional view illustrating a structure example of a secondary battery.

FIG. 9 Plan views and a cross-sectional view illustrating structure examples of a secondary battery.

FIG. 10 A perspective view, a plan view, and a cross-sectional view illustrating a structure example of a secondary battery.

FIG. 11 Views illustrating an example of a manufacturing method of a secondary battery.

FIG. 12 A perspective view, a plan view, and cross-sectional views illustrating a structure example of a secondary battery.

FIG. 13 Views illustrating an example of a manufacturing method of a secondary battery.

FIG. 14 Cross-sectional views illustrating structure examples of a secondary battery.

FIG. 15 Views illustrating an example of a secondary battery.

FIG. 16 Views illustrating an example of a secondary battery.

FIG. 17 Views illustrating an example of a secondary battery.

FIG. 18 Views illustrating an example of a power storage system.

FIG. 19 Views illustrating an example of a power storage system.

FIG. 20 Views illustrating an example of a power storage system.

FIG. 21 A block diagram illustrating a battery management unit of a power storage device.

FIG. 22 Conceptual diagrams illustrating a battery management unit of a power storage device.

FIG. 23 A circuit diagram illustrating a battery management unit of a power storage device.

FIG. 24 A circuit diagram illustrating a battery management unit of a power storage device.

FIG. 25 Conceptual diagrams illustrating a battery management unit of a power storage device.

FIG. 26 A block diagram illustrating a battery management unit of a power storage device.

FIG. 27 A flow chart showing a battery management unit of a power storage device.

FIG. 28 A view illustrating an example of an electronic device.

FIG. 29 Views illustrating examples of an electronic device.

FIG. 30 Views illustrating an example of an electronic device.

FIG. 31 Views illustrating examples of an electronic device.

FIG. 32 Views illustrating examples of an electronic device.

FIG. 33 Views illustrating examples of an electronic device.

FIG. 34 Cross-sectional views of a conventional negative electrode current collector and a conventional negative electrode active material layer.

FIG. 35 Cross-sectional TEM (transmission electron microscopy) images of a negative electrode active material.

FIG. 36 A ²⁹Si-NMR spectrum of a negative electrode active material.

FIG. 37 A ²⁹Si-NMR spectrum of a negative electrode active material.

FIG. 38 A graph showing discharge capacities of the case where a particle which is a mixture of Si, Li₂SiO₃, and Li₂O is used as a negative electrode active material, the case where gallium is used as a negative electrode active material, and the case where graphite is used as a negative electrode active material.

FIG. 39 A graph showing cycle characteristics of the case where a particle which is a mixture of Si, Li₂SiO₃, and Li₂O is used as a negative electrode active material and the case where gallium is used as a negative electrode active material.

### MODE FOR CARRYING OUT THE INVENTION

Embodiments of the present invention will be described in detail below with reference to the accompanying drawings. Note that the present invention is not limited to the description below, and it is easily understood by those skilled in the art that modes and details of the present invention can be modified in various ways. In addition, the present invention should not be construed as being limited to the description in the embodiments given below.

The term “electrically connected” includes the case where components are connected through an “object having any electric function”. There is no particular limitation on the “object having any electric function” as long as electric signals can be transmitted and received between the components connected through the object.

The position, size, range, or the like of each component illustrated in drawings and the like is not accurately represented in some case for easy understanding. Therefore, the disclosed invention is not necessarily limited to the position, size, range, or the like as disclosed in the drawings and the like.

The ordinal numbers such as “first”, “second”, and “third” are used to avoid confusion among components.

### Embodiment 1

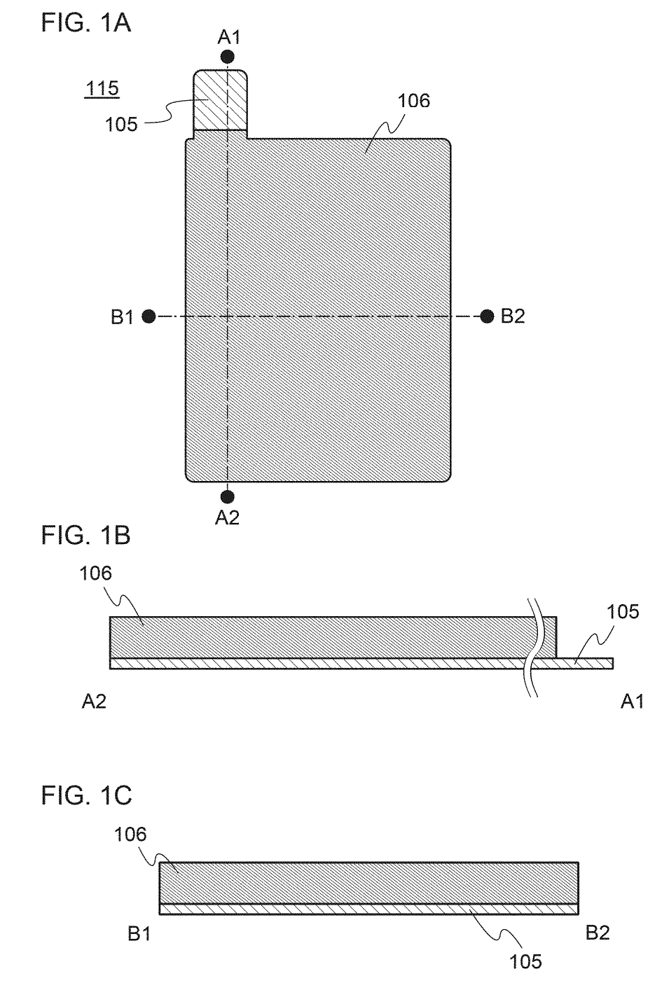

In this embodiment, examples of a negative electrode active material, a negative electrode including the negative electrode active material, and a manufacturing method of them according to one embodiment of the present invention are described with reference to FIG. 1 to FIG. 5 and FIG. 34.

### [1. Basic Structure]

FIG. 1(A) shows a plan view of a negative electrode 115. A cross section taken along a dashed-dotted line in FIG. 1(A) is illustrated in FIG. 1(B), and a cross section taken along a dashed-dotted line Y1-Y2 illustrated in FIG. 1(C).

The negative electrode 115 includes a negative electrode current collector 105 and a negative electrode active material layer 106 formed over the negative electrode current collector 105. The negative electrode active material layer 106 includes a negative electrode active material. The negative electrode active material layer 106 may further include a binder for increasing adhesion of the negative electrode active material, a conductive additive for increasing the conductivity of the negative electrode active material layer, and the like.

As the negative electrode active material, a particle which is a mixture of silicon (Si), lithium metasilicate (Li₂SiO₃), and lithium oxide (Li₂O) is used. When the particle is represented by xSi+yLi₂SiO₃+zLi₂O, the mixing ratio of silicon, lithium metasilicate, and lithium oxide is preferably 2.8≦x≦3.1 and 1.8≦y+z≦2.2, further preferably x=3 and y+z=2, still further preferably x=3, y=1, and z=1.

Because lithium metasilicate is stable with respect a atmospheric components except water vapor, the above-described negative electrode active material can be handled and stored in an atmosphere other than an inert atmosphere. This widens the range of handling and storage means of the negative electrode active material and leads to a simple process and a reduced cost, which is preferable.

Lithium metasilicate can be identified by ²⁹Si NMR (nuclear magnetic resonance spectrometry. Specifically, the chemical shift value of lithium metasilicate obtained by ²⁹Si-NMR is −78 ppm, while the chemical shift value of lithium orthosilicate (Li₄SiO₄) obtained by ²⁹Si-NMR is −65 ppm. Furthermore, the chemical shift value of silicon dioxide (SiO₂) obtained by ²⁹Si-NMR is −108 ppm.

For example, in the ²⁹S-NMR spectrum of a particle, when the intensity at −78 ppm is equal to or more than 50 times the intensity at −108 ppm, it can be said that the particle includes lithium metasilicate.

Similarly, in the ²⁹Si-NMR spectrum of a particle, when the intensity at −65 ppm is equal to or more than 50 times the intensity at −108 ppm, it can be said that the particle includes lithium orthosilicate.

Since the negative electrode active material is the mixture of silicon (Si), lithium metasilicate (Li₂SiO₃), and lithium oxide (Li₂O), a compound containing lithium and oxygen (lithium orthosilicate and lithium metasilicate), which is a cause of the irreversible capacity at the initial charge, is not generated any more at the negative electrode using the negative electrode active material. This enables a negative electrode with a small irreversible capacity.

In the negative electrode active material, preferable that silicon, lithium metasilicate, and lithium oxide be uniformly mixed. The mixing state can be observed with a cross-sectional TEM (transmission electron microscope) of the negative electrode active material particle, for example. In the case where silicon, lithium metasilicate, and lithium oxide are uniformly mixed, an amorphous state without crystal grains or the like is observed.

Furthermore, the identification of lithium metasilicate and lithium oxide can be performed also by EELS (electron energy loss spectroscopy) or ⁷Li-NMR.

There is no particular limitation on the material used for the negative electrode current collector 105 as long as it has high conductivity without causing a significant chemical change in the secondary battery. For example, a metal such as gold, platinum, iron, nickel, copper, aluminum, titanium, tantalum, or manganese, or an alloy thereof (e.g., stainless steel) can be used. Furthermore, coating with carbon, nickel, titanium, or the like may be performed. Moreover, silicon, neodymium, scandium, molybdenum, or the like may be added to improve heat resistance. The current collector can each have any of various shapes including a foil-like shape, a sheet-like shape, a plate-like shape, a net-like shape, a cylindrical shape, a coil shape, a punching-metal shape, an expanded-metal shape, a porous shape, and a shape of non-oven fabric as appropriate. The current collector may have micro irregularities on its surface in order to enhance adhesion to the active material. The current collector preferably has a thickness of more than or equal to 5 μm and less than or equal to 30 μm.

As a binder which can be used in the negative electrode active material layer 106, polyimide, PVDF, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, nitrocellulose, or the like is given. Polyimide is particularly preferable because polyimide can withstand expansion and contraction of the negative electrode active material due to charging and discharging.

As the conductive additive that can be used in the negative electrode active material layer 106, natural graphite, artificial graphite such as mesocarbon microbeads, carbon fiber, or the like can be used, for example. As the carbon fiber, carbon fiber such was mesophase pitch-based carbon fiber or isotropic pitch-based carbon fiber can be used, for example. Furthermore, as the carbon fiber, carbon nanofiber, carbon nanotube, or the like can be used. Carbon nanotube can be formed by, for example, a vapor deposition method or the like. As the conductive additive, a carbon material such as carbon black (e.g., acetylene black (AB)), graphite (black lead) particles, graphene, or fullerene can be used, for example. Alternatively, metal powder or metal fibers of copper, nickel, aluminum, silver, gold, or the like, a conductive ceramic material, or the like can be used, for example.

Flaky graphene has an excellent electrical characteristic of high conductivity and excellent physical properties of high flexibility and high mechanical strength. Thus, the use of graphene as the conductive additive can increase contact points and the contact area in the active material.

Note that graphene in this specification includes single-layer graphene and multiplayer graphene including two to hundred layers. Single-layer graphene refers to a one-atom-thick sheet of carbon molecules having π bonds. Graphene oxide refers to a compound formed by oxidation of such graphene. When graphene oxide is reduced to form graphene, oxygen contained in the graphene oxide is not entirely released and part of the oxygen remains in the graphene. In the case where graphene contains oxygen, the proportion of oxygen in the whole graphene measured by XPS is higher than or equal to 2 atomic % and lower than or equal to 11 atomic %, preferably higher than or equal to 3 atomic % and lower than or equal to 10 atomic %.

Graphene is capable of making low-resistance surface contact and has extremely high conductivity even with a small thickness. Therefore, even a small amount of graphene can efficiently form a conductive path in an active material layer.

In the case where an active material with a small average particle size (e.g., 1 μm or less) is used, the specific surface area of the active material is large and thus more conductive paths for the active material are needed. In such a case, it is particularly preferable to use graphene with extremely high conductivity that can efficiently form a conductive path even in a small amount.

A cross-sectional structure example of a negative electrode active material layer containing graphene as a conductive additive is described below. Note that a positive electrode active material layer may contain graphene as a conductive additive.

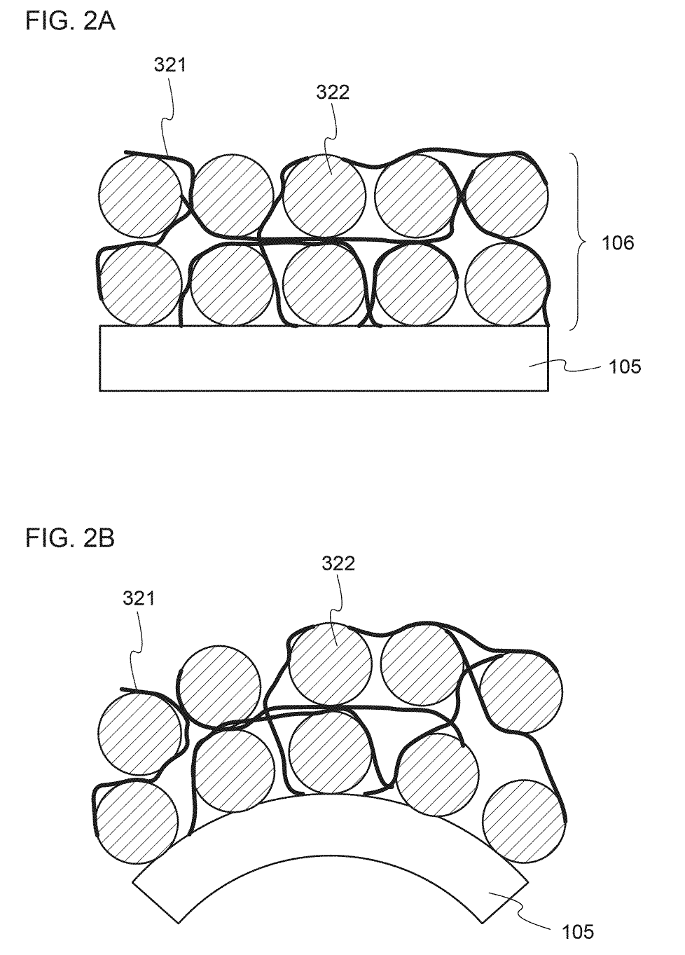

FIG. 2(A) is a longitudinal sectional view illustrating the negative electrode active material layer 106 and the negative electrode current collector 105. The negative electrode active material layer 106 includes a particulate negative electrode active material 322, graphenes 321 as a conductive additive, and a binder (not illustrated).

In the longitudinal section of the negative electrode active material layer 106, as illustrated in FIG. 2(A), the sheet-like graphenes 321 are substantially uniformly dispersed in the negative electrode active material layer 106. The graphenes 321 are schematically shown by thick lines in FIG. 2(A) but are actually thin films having a thickness corresponding to the thickness of a single layer or a multi-layer of carbon molecules. The plurality of graphenes 321 are formed in such a way as to wrap, cover, or adhere to the surfaces of the plurality of particles of the negative electrode active material 322, so that the graphenes 321 make surface contact with the plurality of particles of the negative electrode active material 322. Furthermore, the graphenes 321 are also in surface contact with each other; consequently, the plurality of graphenes 321 form a three-dimensional network for electric conduction.

This is because graphene oxide with extremely high dispersibility in a polar solvent is used for the formation of the graphenes 321. The solvent is removed by volatilization from a dispersion medium in which graphene oxide is uniformly dispersed, and the graphene oxide is reduced to graphene; hence, the graphenes 321 remaining in the negative electrode active material layer 106 partly overlap with each other and cover the negative electrode active material 106 such that surface contact is made, thereby forming an electrical conductive path. Note that graphene oxide may be reduced by, for example, heat treatment or with the use of a reducing agent such as ascorbic acid.

Unlike a conductive additive in the form of particles, such as acetylene black, which makes point contact with an active material, the graphenes 321 are capable of making low-resistance surface contact; accordingly, the electrical conduction between the particulate negative electrode active material 322 and the graphenes 321 can be improved without an increase in the amount of a conductive additive. Thus, the proportion of the negative electrode active material 322 in the negative electrode active material layer 106 can be increased. Accordingly, the discharge capacity of a power storage device can be increased.

Graphenes are bonded to each other to form net-like graphene (hereinafter referred to as a graphene net). The graphene net covering the active material can also function as a binder for binding particles. The amount of a binder can thus be reduced, or the binder does not have to be used. This can increase the proportion of the active material in the electrode volume or weight. That is to say, the capacity of the power storage device can be increased.

A structure where graphene is used as a conductive additive in a positive electrode active material layer or a negative electrode active material layer as described above is particularly effective for a curved or flexible secondary battery.

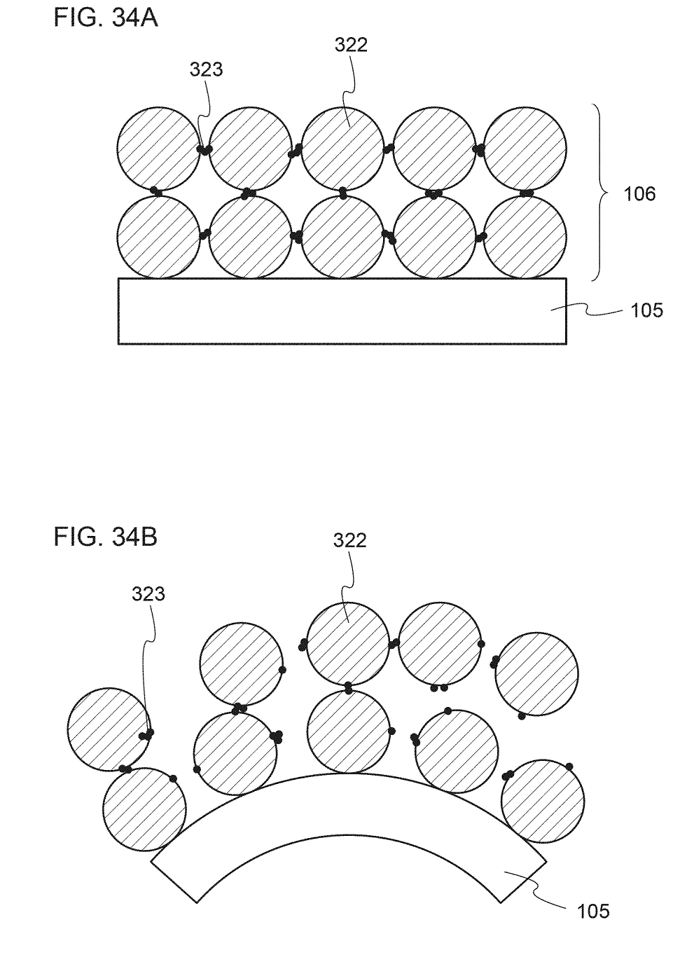

FIG. 34(A) is a longitudinal sectional view illustrating the negative electrode active material layer 106 and the negative electrode current collector 105 of the case where a particulate conductive additive 323 such as acetylene black is used as a conductive additive, as a conventional example. A network for electrical conduction is formed in the negative electrode active material 322 by contact with the particulate conductive additive 323.

FIG. 34(B) shows the case where the negative electrode active material layer 106 and the negative electrode current collector 105 in FIG. 34(A) are curved. As illustrated in FIG. 34(B), when the particulate conductive additive 323 is used as a conductive additive, the distance between the negative electrode active materials 322 is changed because of curving of the negative electrode active material layer 106, and part of the network for electrical conduction in the negative electrode active materials 322 may be broken.

In contrast, FIG. 2(B) shows the case where the negative electrode current collector 105 and the negative electrode active material layer 106, which contains graphene as a conductive additive, in FIG. 2(A) curved. Even when the distance between the negative electrode active materials 322 is changed because of curving of the negative electrode active material layer 106 as in FIG. 2(B), the network for electrical conduction can be maintained because graphene is a flexible sheet.
[2. Modification Example]

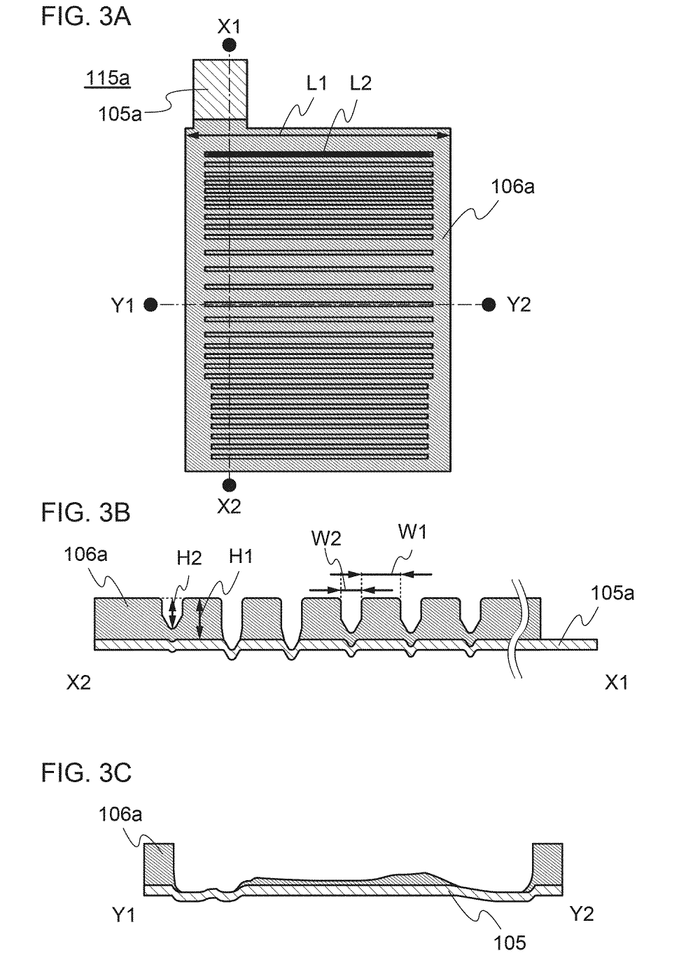

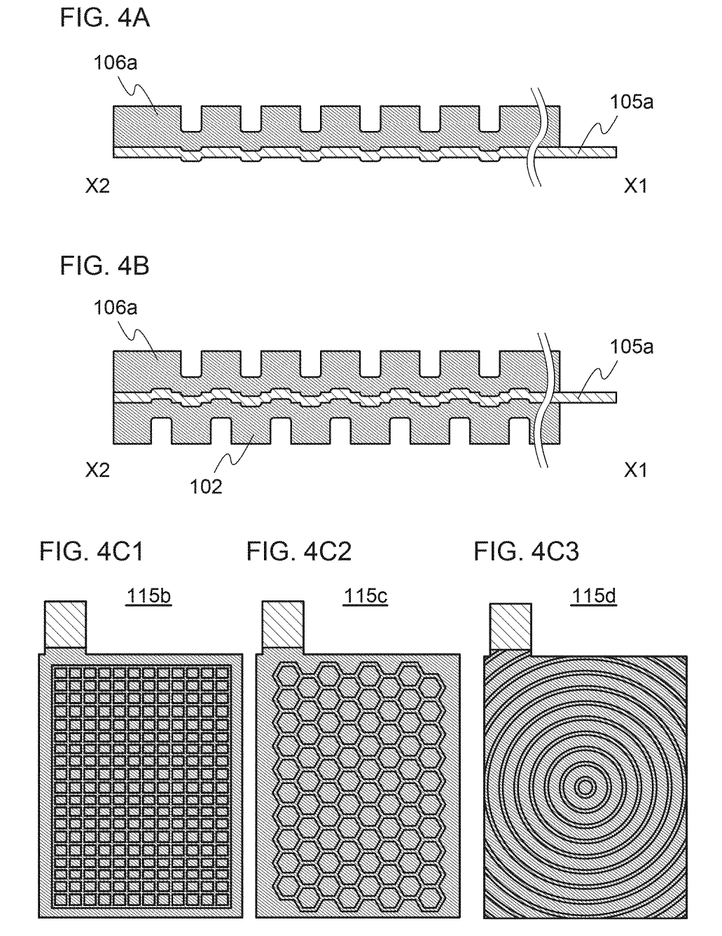

Moreover, the shapes of the negative electrode current collector 105 and the negative electric active material layer 106 may be processed. Examples of the shapes of the negative electrode current collector 105 and the negative electrode active material layer 106 are described with reference to FIG. 3 and FIG. 4.

FIG. 3(A) is a plan view of a negative electrode 115a. A cross section taken along X1-X2 in FIG. 3(A) and a Y1-Y2 cross section are illustrated in FIG. 3(B) and FIG. 3(C), respectively.

A negative electrode current collector 105a and a negative electrode active material layer 106a of the negative electrode 115a each have a plurality of projections and depressions. In addition, the projections and depressions of the negative electrode current collector 105a and those of the negative electrode active material layer 106a overlap with each other. FIG. 3 illustrates an example in which the negative electrode current collector 105a and the negative electrode active material layer 106a have a plurality of linear depressions which are parallel to each other.

As illustrated in FIG. 3(B) and FIG. 3(C), the depressions of the negative electrode active material layer 106a may have a smaller depth than the thickness of the negative electrode active material layer 106a, or may be deep enough to expose the negative electrode current collector 105a. In other words, the negative electrode current collector 105a may be exposed at part of the bottom of the depressions of the negative electrode active material layer 106a. Furthermore, the depressions with different depths may be formed. As illustrated in FIG. 3(A), the depressions may be provided with different intervals.

The depressions in the negative electrode active material layer 106a can absorb expansion of the negative electrode active material layer 106a and suppress the deformation of the negative electrode active material layer 106a even when a negative electrode active material having a large volume change caused by charging and discharging, such as the particle which is a mixture of silicon (Si), lithium metasilicate (Li₂SiO₃), and lithium oxide (Li₂O), is used. Thus, it is possible to suppress separation of the negative electrode active material from the current collector due to pulverization caused by repetitive volume expansion and contraction, and improve the cycle characteristics of the secondary battery. Since wrinkles in the negative electrode current collector 105a, which axe generated when the negative electrode current collector 105a is stretched as the volume of the negative electrode active material layer 106a, increases, can be suppressed, the volume increase of the negative electrode 115a can be suppressed, so that the energy density of the secondary battery can be improved.

In addition, depressions in the negative electrode current collector 105a can suppress deformation of the negative electrode current collector caused by expansion and contraction of the negative electrode active material layer.

The region where projections and depressions are formed in the negative electrode current collector 105a and the negative electrode active material layer 106a is preferably a region overlapping with a positive electrode when incorporated in the secondary battery. This is because a negative electrode in region overlapping with the positive electrode expands and contracts largely. Therefore, it is preferable that a length L2 of the projections and depressions in the negative electrode current collector 105a and the negative electrode active material layer 106a be approximately the same as a width of the overlapping positive electrode.

It is effective to make the area of the negative electrode larger than that of the positive electrode in order to suppress lithium deposition on the surface of the negative electrode 115a caused by charging and discharging of the secondary battery. However, in the case where the difference in area between the positive electrode and the negative electrode 115a is too large, an improvement in the energy density of the secondary battery is difficult. Therefore, for example, L2 is preferably more than or equal to 80% and less than or equal to 100% of a length L1 of a side of the negative electrode current collector 105 which is parallel to L2, further preferably more than or equal to 85% and less than or equal to 98% of the length L1.

A depth H2 of a depression in the projections and depressions of the negative electrode active material layer 106a is preferably as deep as possible because expansion of the negative electrode active material layer 106a can be absorbed more easily. Therefore, H2 is preferably more than or equal to 90% and less than or equal to 100% of a thickness H1 of the negative electrode current collector layer, for example.

A smaller width W1 of the projections and depressions in the negative electrode current collector 105a and the negative electrode active material layer 106a is advantageous in absorbing expansion of the negative electrode active material layer 106a; however, when W1 is too small, the negative electrode capacity is decreased and an improvement in the energy density of the secondary battery is difficult. Therefore, W1 is preferably greater than or equal to 0.1 mm and less than or equal to 5 mm, further preferably greater than or equal to 0.5 mm and less than or equal to 2 mm, for example.

A larger width W2 of the projections and depressions in the negative electrode current collector 105a and the negative electrode active material layer 106a is advantageous in absorbing the expansion of the negative electrode active material layer 106a; however, when W2 is too large, the negative electrode capacity is decreased and an improvement in the energy density of the secondary battery is difficult. Therefore, W2 is preferably less than or equal to W1. Furthermore, W2 is preferably greater than or equal to 0.1 mm and less than or equal to 1 mm, further preferably greater than or equal to 0.25 mm and less than or equal to 0.45 mm.

The shape of the projections and depressions of the negative electrode active material layer 106a and the negative electrode current collector 105a is not limited to that illustrated in FIG. 3. For example, the depressions may have a shape close to a quadrangular prism as illustrated in FIG. 4(A).

Furthermore, although the negative electrode active material layer 106a is formed on one surface of the negative electrode current collector 105a in the examples in FIG. 3 and FIG. 4(A), the negative electrode active material layer 106a may be formed on both surfaces of the negative electrode current collector 105a as illustrated in FIG. 4(B), for example. Forming the negative electrode active material layer 106a on both surfaces of the negative electrode current collector 105 increases the capacity of the secondary battery.

In the case where the negative electrode active material layer 106a is formed on both surfaces of the negative electrode current collector 105a, it is preferable that the projections and depressions in one surface of the negative electrode active material layer 106a do not overlap with the projections and depressions in the other surface of the negative electrode active material layer 106a as illustrated in FIG. 4(B). This is because the strength of the negative electrode current collector 105a might be reduced when the projections and depressions on both surfaces overlap with each other.

Furthermore, the pattern forming the projections and depressions is not limited to that illustrated in FIG. 3. For example, the projections an depressions of the negative electrode active material layer 106a and the negative electrode current collector 105a may be formed parallel to the long side of the negative electrode current collector 105. Alternatively, as indicated by a negative electrode 115b in FIG. 4(C1), they may be formed to have a lattice pattern. Alternatively, as indicated by a negative electrode 115c in FIG. 4(C2), they may be formed to have a shape in which hexagons are connected. Alternatively, as indicated by a negative electrode 115d in FIG. 4(C3), they may be formed concentrically.
[3. Manufacturing Method]

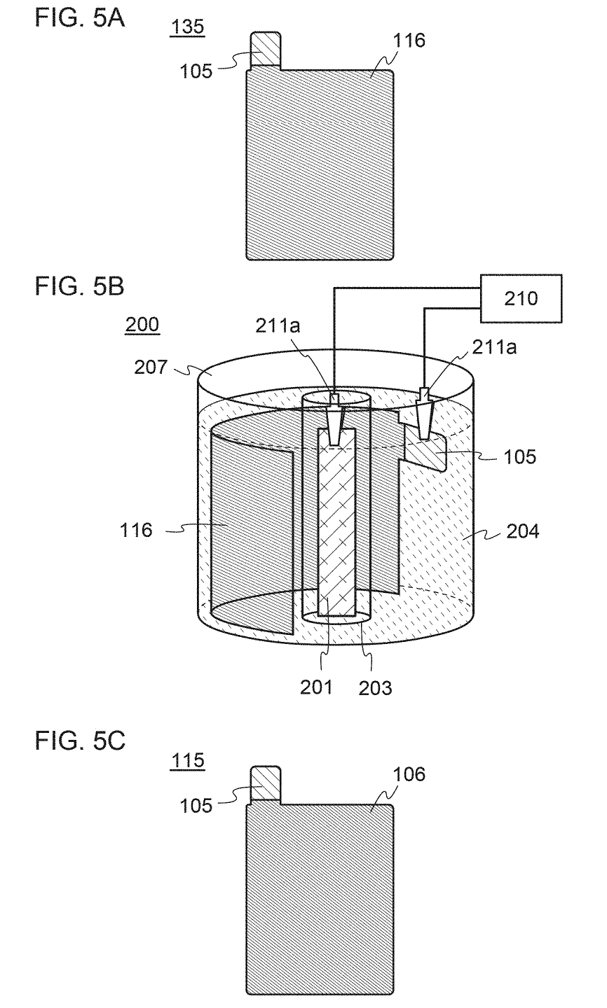

A manufacturing method of the negative electrode active material and the negative electrode 115 is described below with reference to FIG. 5.

First, the negative electrode current collector 105 is prepared.

Next, as a material of a negative electrode active material layer 116, a material of the negative electrode active material, a binder, and a conductive additive are prepared. As the material of the negative electrode active material, a particle including silicon is used. Here, a particle of silicon monoxide (SiO) covered with carbon is prepared as the material of the negative electrode active material. As the binder and the conductive additive, polyimide and acetylene black are used, respectively.

As the negative electrode active material layer 116, these materials are mixed and applied over the negative electrode current collector 105.

Next, the negative electrode active material layer 116 and the negative electrode current collector 105 are processed into desired shapes, so that an electrode 135 is manufactured (FIG. 5(A)).

Here, an electrode processing device 200 is described. The electrode processing device 200 includes lithium 201, a separator 203, and an electrolytic solution 204 in a container 207. The electrode processing device 200 includes a voltage application device 210, and the voltage application device 210 includes a terminal 211a and a terminal 211b. The electrode 135 and the lithium 201 can be electrically connected to the electrode processing device 200 through the terminal 211a and the terminal 211b.

Next, the electrode 135 is placed in the above-described electrode processing device 200 and the electrode 135 and the lithium 201 are made to be in contact with the electrolytic solution 204. Furthermore, the lithium 201 is electrically connected to the terminal 211a of the voltage application device 210. The negative electrode current collector 105 is electrically connected to the terminal 211b of the voltage application device 210 (FIG. 5(B)).

Next, voltage is applied between the electrode 135 and the lithium 201 with the voltage application device 210. The applied voltage is set to the voltage at which lithium metasilicate is formed and alloyed LiₓSi is not formed. Thus, the applied voltage is preferably higher than or equal to 0.25 V and lower than or equal to 0.65 V, further preferably higher than or equal to 0.3 V and lower than or equal to 0.6 V on the lithium basis. An applied voltage of approximately 0.4 V is particularly preferably because of a good balance between the easy formation of lithium metasilicate and the lithium insertion rate.

The application of voltage between the electrode 135 and the lithium 201 inserts lithium into the SiO particle included in the electrode 135, thereby forming silicon, lithium metasilicate, and lithium oxide. The lithium insertion amount, for example in the electric charge amount, can be 600 mAh/g per SiO weight.

Through the above-described steps, a particle which is a mixture of silicon, lithium metasilicate, and lithium oxide serving as a negative electrode active material of one embodiment of the present invention can be manufactured. Furthermore, the negative electrode active material layer 106 including the negative electrode active material and the negative electrode 115 can be manufactured (FIG. 5(C)).

In this embodiment, one embodiment of the present invention has been described. Other embodiments of the present invention are described in the other Embodiments. Note that one embodiment of the present invention is not limited to the above. In other words, various embodiments of the invention are described in this embodiment and the other embodiments, and one embodiment of the present invention is not limited to a particular embodiment. The example in which one embodiment of the present invention is applied to a lithium-ion secondary battery is described as one embodiment of the present invention; however, one embodiment of the present invention is not limited thereto. Depending on circumstances or conditions, one embodiment of the present invention can be used for a variety of secondary batteries, a lead storage battery, a lithium-ion polymer secondary battery, a nickel-hydrogen storage battery, a nickel-cadmium storage battery, a nickel-iron storage battery, a nickel-zinc storage battery, a silver oxide-zinc storage battery, a solid-state battery, an air battery, a primary battery, a capacitor, a lithium ion capacitor, and the like. Alternatively, for example, depending on circumstances or conditions, one embodiment of the present invention is not necessarily applied to a lithium-ion secondary battery. For example, the example in which the negative electrode active material includes silicon, lithium metasilicate, and lithium oxide is described as one embodiment of the present invention; however, one embodiment of the present invention is not limited to this example. Depending on circumstances or conditions, the negative electrode active material in one embodiment of the present invention does not necessarily include silicon, lithium metasilicate, or lithium oxide. For example, the example in which the negative electrode current collector or the negative electrode active material layer has projections and depressions is described as one embodiment of the present invention; however, one embodiment of the present invention is not limited to this example. Depending on circumstances or conditions, a material other than the negative electrode current collector or the negative electrode active material layer may have projections and depressions in one embodiment of the present invention. Alternatively, for example, depending on circumstances or conditions, the negative electrode current collector or the negative electrode active material layer may have a shape other than the projections and depressions in one embodiment of the present invention. Alternatively, for example, depending on circumstances or conditions, the negative electrode current collector or the negative electrode active material layer does not necessarily have projections an depressions in one embodiment of the present invention.

This embodiment can be implemented in appropriate combination with any of the other embodiments and examples.

### Embodiment 2

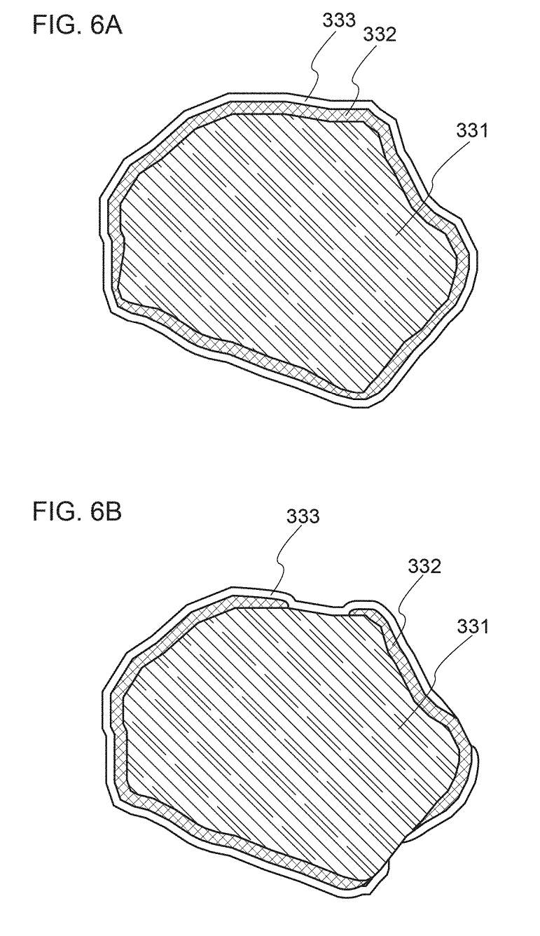

In this embodiment, materials that can be used in the secondary battery of one embodiment of the present invention will be described in detail with reference to FIG. 6.
[1. Positive Electrode]

A positive electrode 111 includes a positive electrode current collector 101, a positive electrode active material layer 102 formed over the positive electrode current collector 101, and the like.

The positive electrode current collector 101 can be formed using a material that has high conductivity and does not dissolve at the potential of the positive electrode, such as a metal typified by stainless steel, gold, platinum, aluminum, or titanium, or an alloy thereof. Alternatively, an aluminum alloy to which an element which improves heat resistance, such as silicon, titanium, neodymium, scandium, or molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, and nickel. The positive electrode current collector 101 can have a foil-like shape, a plate-like shape (sheet-like shape), a net-like shape, a punching-metal shape, an expanded-metal shape, or the like as appropriate. The positive electrode current collector 101 preferably has a thickness greater than or equal to 5 μm and les than or equal to 30 μm. The surface of the positive electrode current collector 101 may be provided with an undercoat layer using graphite or the like.

The positive electrode active material layer 102 may further include a binder for increasing adhesion of the positive electrode active material, a conductive additive for increasing the conductivity of the positive electrode active material layer 102, and the like in addition to the positive electrode active material.

Examples of the positive electrode active material that can be used for the positive electrode active material layer 102 include a composite oxide with an olivine crystal structure, a layered rock-salt crystal structure, or a spinel crystal structure, and the like. For example, a compound such as LiFeO₂, LiCoO₂, LiNiO₂, LiMn₂O₄, V₂O₅, Cr₂O₅, or MnO₂ can be used as the positive electrode active material.

In particular, LiCoO₂ is preferable because it has high capacity, stability in the air higher than that of LiNiO₂, and thermal stability higher than that of LiNiO₂, for example.

It is preferably to add a small amount of lithium nickel oxide (LiNiO₂or LiNi₁₋ₓMO₂ (0<x<1)) (M=Co, Al, or the like)) to a lithium-containing material with a spinel crystal structure which contains manganese such as LiMn₂O₄ because characteristics of the secondary battery using such a material can be improved.

In addition, a lithium-manganese composite oxide that is represented by the composition formula LiₐMn_{b}M_{c}O_{d} can be used as the positive electrode active material. Here, the element M is preferably silicon, phosphorus, or a metal element other than lithium and manganese, and further preferably nickel. Furthermore, in the case where the whole particle of the lithium-manganese composite oxide is measured, it is preferable to satisfy the following at the time of discharging: 0<a/(b+c)<2; c>0; and 0.26≦(b+c)/d<0.5. Note that the composition of the metal, silicon, phosphorus, or the like in the whole particle of the lithium-manganese composite oxide can be measured with an ICP-MS (inductively coupled plasma mass spectrometer), for example. The composition of oxygen in the whole particle of the lithium-manganese composite oxide can be measured with an EDX (energy dispersive X-ray spectrometer), for example, or can be obtained using fusion gas analysis or valence evaluation of XAFS (X-ray absorption fine structure), analysis together with ICP-MS analysis. Note that the lithium-manganese composite oxide is an oxide containing at least lithium and manganese, and may contain at least one kind of element selected from chromium, cobalt, aluminum, nickel, iron, magnesium, molybdenum, zinc, indium, gallium, copper, titanium, niobium, silicon, phosphorus, and the like.

To achieve high capacity, the lithium-manganese composite oxide preferably includes a region in the surface portion and a region in the middle portion which are different in crystal structure, crystal orientation, or oxygen content. In order that such a lithium-manganese composite oxide can be obtained, the composition formula is preferably LiₐMn_{b}Ni_{c}O_{d} (1.6≦a≦1.848; 0.19≦c/b≦0.935; and 2.5≦d≦3). For example, it is particularly preferable to use a lithium-manganese composite oxide represented by the composition formula Li_{1.68}Mn_{0.8062}Ni_{0.318}O₃. In this specification and the like, a lithium-manganese composite oxide represented by the composition formula Li_{1.68}Mn_{0.8062}Ni_{0.318}O₃ refers to that formed at a ratio (molar ratio) of the amounts of raw materials of Li₂CO₃:MnCO₃:NiO=0.84:0.8062:0.318. although this lithium-manganese composite oxide is represented by the composition formula Li_{1.68}Mn_{0.8062}Ni_{0.318}O₃, the composition might deviate from this.

FIG. 6 illustrates examples of a cross-sectional view of a particle of the lithium-manganese composite oxide including regions which are different in crystal structure, crystal orientation, or oxygen content.

As illustrated in FIG. 6(A), the lithium-manganese composite oxide including the regions which are different in crystal structure, crystal orientation, or oxygen content preferably includes a first region 331, a second region 332, and a third region 333. The second region is in contact with at least part of the outside of the first region. Here, the term “outside” refers to the side closer to a surface of the particle. The third region preferably includes a region corresponding to the surface of the particle including the lithium-manganese composite oxide.

As shown in FIG. 6(B), the first region 331 may include a region not covered with the second region 332. The second region 332 may include a region not covered with the third region 333. For example, the first region 331 may include a region in contact with the third region 333. The first region 331 may include a region covered with neither the second region 332 nor the third region 333.

The composition of the second region is preferably different from that of the first region.

For example, the case is described where the composition of the first region and that of the second region are separately measured, the first region contains lithium, manganese, the element M, and oxygen; the second region contains lithium, manganese, the element M, and oxygen; the atomic ratio of manganese to the element M and oxygen in the first region is represented by a1:b1:c1:d1; and the atomic ratio of manganese to the element M and oxygen in the second region is represented by a1:b2:c2:d2. Note that the composition of each of the first region and the second region can be measured by, for example, EDX (energy dispersive X-ray spectroscopy) using a TEM (transmission electron microscope). In the case where measurement is performed by EDX, the ratio of lithium is difficult to measure. Thus, a difference in the composition of the elements other than lithium between the first region and the second region is described below. Here, d1/(b1+c1) is preferably greater than or equal to 2.2, further preferably greater than or equal to 2.3, and still further preferably greater than or equal to 2.35 and less than or equal to 3. Furthermore, d2/(b2+c2) is preferably less than 2.2, further preferably less than 2.1, and still further preferably greater than or equal to 1.1 and less than or equal to 1.9. Also in this case, the composition of the whole particle of the lithium-manganese composite oxide including the first region and the second region preferably satisfies 0.26≦(b+c)/d<0.5as described above.

The valence of manganese in the second region may be different from that of manganese in the first region. The valence of the element M in the second region may be different from that of the element M in the first region.

Specifically the first region 331 is preferably a lithium-manganese composite oxide having a layered rock-salt crystal structure. The second region 332 is preferably a lithium-manganese composite oxide having a spinel crystal structure.

Here, in the case where there is a spatial distribution of the composition or the valence of an element in any of the regions, the compositions or the valences in a plurality of portions in the region are obtained, and the average value thereof is calculated to be regarded as the composition or the valence of the example.

A transition layer may be provided between the second region and the first region. Here, the transition layer is, for example, a region where the composition is changed continuously or gradually, a region where the crystal structure is changed continuously or gradually, or a region where the lattice constant of a crystal is changed continuously or gradually. A mixed layer may be provided between the second region and the first region. The mixed layer is a region in which, for example, two or more crystals having different crystal orientations are mixed, two or more crystals having different crystal structures are mixed, or two or more crystals having different compositions are mixed.

For the third region, carbon or a metal compound can be used. Examples of the metal include cobalt aluminum, nickel iron, manganese, titanium, zinc, and lithium. The third region may contain an oxide, a fluoride, or the like of the metal as an example of the metal compound.

In particular, the third region preferably contains carbon among the above. Since carbon has high conductivity, a particle coated with carbon in an electrode of a storage battery can reduce the resistance of the electrode, for example. When the third region contains carbon, the second region in contact with the third region can e oxidized. The third region may contain graphene, graphene oxide, or reduced graphene oxide. Graphene and reduced graphene oxide have excellent electrical characteristics of high conductivity and excellent physical properties of high flexibility and high mechanical strength. Moreover, the particle of the lithium-manganese composite oxide can be coated efficiently.

When the third region contains carbon such as graphene, the secondary battery using the lithium-manganese composite oxide as its positive electrode material can have improved cycle characteristics.

The thickness of a layer containing carbon is preferably greater than or equal to 0.4 nm and less than or equal to 40 nm.

Furthermore, the average diameter of primary particles of the lithium-manganese composite oxide is preferably greater than or equal to 5 nm and less than or equal to 50 μm, further preferably greater than or equal to 100 nm and less than or equal to 500 nm, for example. Furthermore, the specific surface area is preferably greater than or equal to 5 m²/g and less than or equal to 15 m²/g. Furthermore, the average diameter of secondary particles is preferably greater than or equal to 5 μm and less than or equal to 50 μm. Note that the average particle diameter can be measured with a particle size distribution analyzer or the like using a laser diffraction and scattering method or by observation with a scanning electron microscope (SEM) or a TEM. The specific surface area can be measured by a gas adsorption method.

By combining a positive electrode that uses the lithium-manganese composite oxide as a positive electrode active material with the negative electrode described in Embodiment 1, a secondary battery having an extremely high capacity can be formed.

Alternatively, a complex material (LiMPO₄ (general formula ) (M is one or more of Fe(II), Mn(II), Co(II), and Ni(II))) can be used for the positive electrode active material. As the material, lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐMn_{b}PO₄ (a+b is less than or equal to 1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e is less than or equal to 1, 0<c<1, 0<d<1, and 0<e<1), and LiFe_{f}Ni_{g}CoₕMnᵢPO₄ (f+g+h+i is less than or equal to 1, 0<f<1, 0<g<1, 0<h<1, and 0<i<1), which are typical examples of the general formula LiMPO₄, can be used.

LiFePO₄ is particularly preferably because it satisfies properties necessary for the positive electrode active material with good balance, such a safety, stability, high capacity density, and the existence of lithium ions that can be extracted in initial oxidation (charging).

Alternatively, a complex material such as the general formula Li(₂₋ⱼ)MSiO₄ (M is one or more of Fe(II), Mn(II), Co(II), and Ni(II); 0≦j≦2) can be used. As the material, lithium compounds such as Li(₂₋ⱼ)FeSiO₄, Li(₂₋ⱼ)NiSiO₄, Li(₂₋ⱼ)CoSiO₄, Li(₂₋ⱼ)MnSiO₄, Li(₂₋ⱼ)FeₖNiₗSiO₄, Li(₂₋ⱼ)FeₖCoₗSiO₄, Li(₂₋ⱼ)FeₖMnₗSiO₄, Li(₂₋ⱼ)NiₖCoₗSiO₄, Li(₂₋ⱼ)NiₖMnₗSiO₄ (k+1 is less than or equal to 1, 0<k<1, and 0<1<1), Li(₂₋ⱼ)FeₘNiₙCo_{q}SiO₄, Li(₂₋ⱼ)FeₘNiₙMn_{q}SiO₄, Li(₂₋ⱼ)NiₘCoₙMn_{q}SiO₄ (m+n+q is less than or equal to 1, 0<m<1, 0<n<1, and 0<q<1), and Li(₂₋ⱼ)FeᵣNiₛCoₜMnᵤSiO₄ (r+s+t+u≦1, 0<r<1, 0<s<1, 0<t<1, and 0<u<1), which are typical examples of the general formula Li(₂₋ⱼ)MSiO₄, can be used.

Still alternatively, a NASICON compound represented by a general formula, AₓM₂(XO₄)₃ (A=Li, Na, or Mg, M=Fe, Mn, Ti, V, or Nb, and X=S, P, Mo, W, As, or Si), can be used as the positive electrode active material. Examples of the NASICON compound include Fe₂(MnO₄)₃, Fe₂(SO₄)₃, and Li₃Fe₂(PO₄)₃. Still further alternatively, a metal such as a compound represented by a general formula, Li₂MPO₄F, Li₂MP₂O₇, or Li₅MO₄ (M=Fe or Mn), a perovskite fluoride such as NaFeF₃ or FeF₃, a metal chalcogenide (a sulfide, a selenide, or a telluride) such as TiS₂ or MoS₂, an oxide with an inverse spinel crystal structure such as LiMVO₄, a vanadium oxide (e.g., V₂O₅, V₆O₁₃, or LiV₃O₈), a manganese oxide, or an organic sulfur compound can be used as the positive electrode active material.

In the case where carrier ions are alkali metal ions other than lithium ions or alkaline-earth metal ions, the positive electrode active material may contain, instead of lithium, an alkali metal (e.g., sodium or potassium) or an alkaline-earth metal (e.g., calcium, strontium, barium, beryllium, or magnesium). For example, the positive electrode active material may be a layered oxide containing sodium such as NaFeO₂ or Na_{2/3}[Fe_{1/2}Mn_{1/2}]O₂.

Note that although not shown, a conductive material such as a carbon layer may be provided on a surface of the positive electrode active material layer 102. With the conductive material such a the carbon layer, the conductivity of the electrode can be increased. For example, the positive electrode active material layer 102 can be coated with the carbon layer by mixing a carbohydrate such as glucose at the time of baking the positive electrode active material.

The average particle diameter of the primary particle of the positive electrode active material layer 102 is preferably greater than or equal to 50 nm and less than or equal to 100 μm.

As the conductive additive, a carbon material, a metal material, a conductive ceramic material, or the like can be used, for example. Alternatively, a fiber material may be used as the conductive additive. The content of the conductive additive in the whole active material layer is preferably greater than or equal to 1 wt % and less than or equal to 10 wt %, further preferably greater than or equal to 1 wt % and less than or equal to 5 wt %.

A network for electrical conduction can be formed in the electrode by the conductive additive. The conductive additive also allows maintaining of a path for electric conduction in the active material. The addition of the conductive additive to the active material layer enables the active material layer having high electrical conductivity.

For the material that can be used as the conductive additive, the description of the conductive additive that can be used in the negative electrode active material layer 106 can be referred to.

Various methods can be used for forming an electrode which is used for the secondary battery of one embodiment of the present invention. For example, in the case where an active material layer is formed over a current collector by a coating method, the active material, the binder, the conductive additive, and the dispersion medium (also referred to as solvent) are mixed to form a paste, the paste is applied to the current collector, and the dispersion medium is vaporized. After that, the active material layer may be pressed by a compression method such as a roll pres method or a flat plate press method so as to be consolidated if necessary.

As the dispersion medium, water, a polar organic solvent such as N-methylpyrrolidone (NMP) or dimethylformamide, or the like can be used. Water is preferably used in terms of the safety and cost.

It is preferable for the binder to include, for example, water-soluble polymers. As the water-soluble polymers, a polysaccharide or the like can be used. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used.

As the binder, a rubber material such as styrene-butadiene rubber (SBR), styrene-isoprene-styrene rubber, acrylonitrile-butadiene rubber, butadiene rubber, fluorine rubber, or ethylene-propylene-diene copolymer is preferably used. Any of these rubber materials is further preferably used in combination with the aforementioned water-soluble polymers.

Alternatively, as the binder, a material such as polystyrene, poly(methyl acrylate), poly(methyl methacrylate) (PMMA), sodium polyacrylate, polylvinyl alcohol (PVA), polyethylene oxide (PEO), polypropylene oxide, polyimide, polyvinyl chloride, polytetraafluoroethylene, polyethylene, polypropylene, isobutylene, polyethylene terephthalate, nylon, polyvinylidene fluoride (PVdF), polyacrylonitrile (PAN), polyvinyl chloride, ethylene-propylene-diene polymer, polyvinyl acetate, polymethyl methyacrylate or nitrocellulose is preferably used.

Two or more, kinds of the above materials may be used in combination as the binder.

The content of the binder in the whole the positive electrode active material layer 102 is preferably greater than or equal to 1 wt % and less than or equal to 10 wt %, further preferably greater than or equal to 2 wt % and less than or equal to 8 wt %, and still further preferably greater than or equal to 3 wt % and less than or equal to 5 wt %. The content of the conductive additive in the whole positive electrode active material layer 102 is preferably greater than or equal to 1 wt % and less than or equal to 10 wt %, further preferably greater than or equal to 1 wt % and less than or equal to 5 wt %.

In the case where the positive electrode active material layer 102 is formed by a coating method, the positive electrode active material, the binder, and the conductive additive are mixed to form a positive electrode paste (slurry), and the positive electrode paste is applied to the positive electrode current collector 101 and dried.
[2. Negative Electrode]

As the negative electrode 115, the negative electrode described in Embodiment 1 is used.

A coating film of an oxide or the like may be formed on the surface of the negative electrode active material layer 106 of the negative electrode 115 described in Embodiment 1. A coating film formed by decomposition or the like of an electrolytic solution or the like in charging cannot release electric charges used at the formation, and therefore forms irreversible capacity. In contrast, the film of an oxide or the like provided on the surface of the negative electrode active material layer 106 in advance can reduce to prevent generation of irreversible capacity.

As the coating film coating the negative electrode active material layer 106, an oxide film including any one of niobium, titanium, vanadium, tantalum, tungsten, zirconium, molybdenum, hafnium, chromium, aluminum, and silicon or an oxide film including any one of these elements and lithium can be used. Such a coating film is much denser than a conventional coating film on a surface of a negative electrode due to a decomposition product of an electrolytic solution.

For example, niobium oxide (Nb₂O₅) ha a low electric conductivity of 10⁻⁹ S/cm and a high insulating property. For this reason, a niobium oxide film inhibits an electrochemical decomposition reaction between the negative electrode active material and the electrolytic solution. On the other hand, niobium oxide has a lithium diffusion coefficient of 10⁻⁹ cm²/sec and high lithium ion conductivity. Therefore, niobium oxide can transmit lithium ions. Alternatively, silicon oxide or aluminum oxide may be used.

A sol-gel method can be used to coat the negative electrode active material layer 106 with the coating film, for example. The sol-gel method is a method for forming a thin film in such a manner that a solution of metal alkoxide, a metal salt, or the like is changed into a gel, which has lost its fluidity, by hydrolysis reaction and polycondensation reaction and the gel is baked. Since a thin film is formed from a liquid phase in the sol-gel method, raw materials can be mixed uniformly on the molecular scale. For this reason, by adding a negative electrode active material such as graphite to a raw material of the metal oxide film which is a solvent, the active material can be easily dispersed into the gel. In such a manner, the coating film can be formed on the surface of the negative electrode active material layer 106. A decrease in the capacity of the power storage unit can be prevented by using the coating film.
[3. Separator]

As a material for the separator 103 used in a secondary battery 100 and the separator 203 used for the electrode processing device, a porous insulator such as cellulose, polypropylene (PP), polyethylene (PE), polybutene, nylon, polyester, polysulfone, polyacrylonitrile, polyvinylidene fluoride, or tetrafluoroethylene can be used. Alternatively, nonwoven fabric of a glass fiber or the like, or a diaphragm in which a glass fiber and a polymer fiber are mixed may be used. Alternatively, to increase heat resistance, a polyester nonwoven fabric to which ceramic is applied to which is coated with aramid may be used as a separator.
[4. Electrolytic Solution]

As a solvent for an electrolytic solution 104 used in the secondary battery 100 and the electrolytic solution 204 used in the electrode processing device, an aprotic organic solvent is preferably used. For example, one of ethylene carbonate (EC), propylene carbonate (PC), butylene carbonate, chlorethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more kinds of these can be used in an appropriate combination in an appropriate ratio.

When a gelled high-molecular material is used as the solvent of the electrolytic solution, safety against liquid leakage is improved. Further, the secondary battery can be thinner and more lightweight. Typical examples of the gelled high-molecular material include a silicone gel, an acrylic gel, an acrylonitrile gel, a polyethylene oxide-based gel, a polypropylene oxide-based gel, and a fluorine-based polymer gel.

Alternatively, the use of one or more ionic liquids (room temperature molten salts) that have non-inflammability and non-volatility as the solvent for the electrolytic solution can prevent the secondary battery from exploding or catching fire even when the power storage unit internally shorts out or the internal temperature increases due to overcharging or the like.

In the case of using lithium ions as carriers, as an electrolyte dissolved in the above-described solvent, one kind of lithium salts such as LiPF₆, LiClO₄, LiAsF₆, LiBF₄, LiAlCl₄, LiSCN, LiBr, LiI, Li₂SO₄, Li₂B₁₀C₁₁₀, Li₂B₁₂C₁₁₂, LiCF₃SO₃, LiC_{f}F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more kinds of these can be used in an appropriate combination in an appropriate ratio.

The electrolytic solution used for the secondary battery is preferably a highly purified one so as to contain a negligible amount of dust particles and elements other than the constituent elements of the electrolytic solution (hereinafter, also simply referred to as “impurities”). Specifically, the weight ratio of impurities to the electrolytic solution is less than or equal to 1%, preferably less than or equal to 0.1%, and further preferably less than or equal to 0.01%. An additive agent such as vinylene carbonate may be added to the electrolytic solution.
[5. Exterior Body]

The secondary battery can have a variety of structures, and a film is used in formation of an exterior body 107 in this embodiment. Note that the film for forming the exterior body 107 is a single-layer film selected from a metal film (e.g., an aluminum film, a stainless steel film, and a nickel steel film), a plastic film made of an organic material, a hybrid material film including an organic material (e.g., an organic resin or fiber) and an inorganic material (e.g., ceramic), and a carbon-containing inorganic film (e.g., a carbon film or a graphite film); or a stacked-layer film including a plurality of these films. A metal film is easy to emboss, and forming depressions or projections by embossing increases the surface area of the exterior body 107 exposed to outside air, achieving an excellent heat dissipation effect.

In the case where the secondary battery 100 is changed in form by application of force from the outside, bending stress is externally applied to the exterior body 107 of the secondary battery 100. This might partly deform or damage the exterior body 107. Depressions or projections formed on the exterior body 107 can relieve a strain caused by stress applied to the exterior body 107. Thus, the secondary battery 100 can be highly reliable. Note that a “strain” is the scale of change in form indicating the displacement of a point of an object relative to the reference (initial) length of the object. The depressions or projections formed on the exterior 107 can reduce the influence of a caused by application of external force to the secondary battery to an acceptable level. Thus, a highly reliable secondary battery can be provided.

This embodiment can be implemented in appropriate combination with any of the other embodiments and examples.

### Embodiment 3

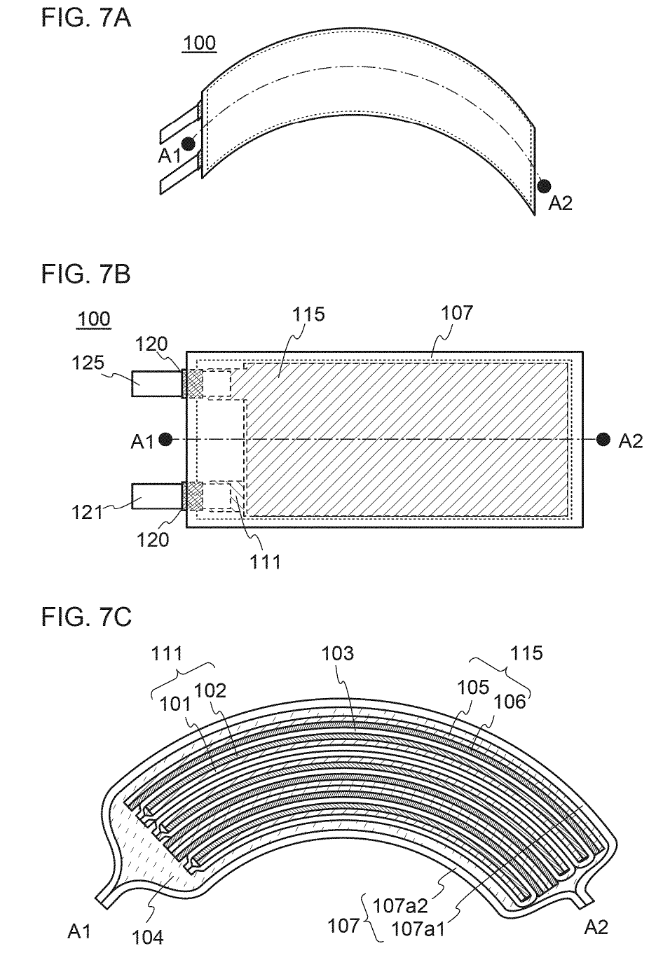

In this embodiment, structure examples of the secondary battery of one embodiment of the present invention including the negative electrode described in Embodiment 1 are described with references to FIGS. 7 to 14.

<Bendable Battery 1> FIGS. 7(A), (B), and (C) illustrate a structure example of the secondary battery 100. FIG. 7(A) is a perspective view of the secondary battery 100, and FIG. 7(B) is a plan view of the secondary battery 100. FIG. 7(C) is a cross-sectional view taken along a dashed-dotted line A1-A2 in FIG. 7(Z) and FIG. 7(B).

The secondary battery 100 illustrated in FIG. 7 includes a plurality of positive electrodes 111, a positive electrode lead 121 electrically connected to the plurality of positive electrodes 111, a plurality of negative electrodes 115, and a negative electrode lead 125 electrically connected to the plurality of negative electrodes 115. The positive electrodes 111 are each covered with the separator 103. The secondary battery 100 includes an exterior body 107 which covers the plurality of positive electrodes 111, the plurality of negative electrodes 115, and the plurality of separators 103. The positive electrode lead 121 and the negative electrode lead 125 include a sealing layer 120. The secondary battery 100 includes the electrolytic solution 104 in a region covered with the exterior body 107.

As illustrated in the drawings, the secondary battery 100 is a secondary battery curved in a single axis direction.

Note that the secondary battery 100 in FIG. 1 includes three positive electrodes 111 in each of which the positive electrode active material layer 102 is formed on one surface of the positive electrode current collector 101 and three negative electrodes 115 in each of which the negative electrode active material layer 106 is formed on one surface of the negative electrode current collector 105. These electrodes are positioned so that the negative electrode active material layer 102 and the negative electrode active material layer 106 face each other with the separator 103 provided therebetween. Furthermore, these electrodes are positioned so that the surfaces of the negative electrodes 115 that are not provided with the negative electrode active material layer 106 are in contact with each other.

With the above-described arrangement, a contact surface between metals such as a contact surface between the surfaces of the negative electrodes 115 which are not provided with the negative electrode active material layers 106 can be formed. The contact surface between metals can have a lower coefficient of friction than a contact surface between the active material layer and the separator 103.

Thus, when the positive electrodes 111 and the negative electrodes 115 are curved, the surfaces of the negative electrodes 115 which are not provided with the negative electrode active material layers 106 slide, so that stress caused by the difference between the inner diameter and the outer diameter of a curved portion can be reduced. Accordingly, the positive electrode 111 and the negative electrode 115 can be prevented from deteriorating. In addition, the secondary battery 100 can be highly reliable.

Note that the secondary battery 100 may include one or two positive electrodes 111 and one or two negative electrodes 115. The secondary battery 100 can be thinner and easily curved by the reduction in the number of stacked layers. Alternatively, four or more positive electrodes 111 and four or more negative electrodes 115 may be stacked. The capacity of the secondary battery 100 can be increased by the increase in the number of the stacked layers.

Although the example in which the separator 103 covers the positive electrode 111 is described with the secondary battery 100 in FIG. 1, one embodiment of the present invention is not limited thereto. A structure in which the separator 103 coves the negative electrode 115 may be employed. Because it is enough if the separator 103 is provided anywhere between the positive electrode active material layer 102 and the negative electrode active material layers 106, a structure in which the separator 103 does not cover the positive electrode 111 or the negative electrode 115 may be employed.

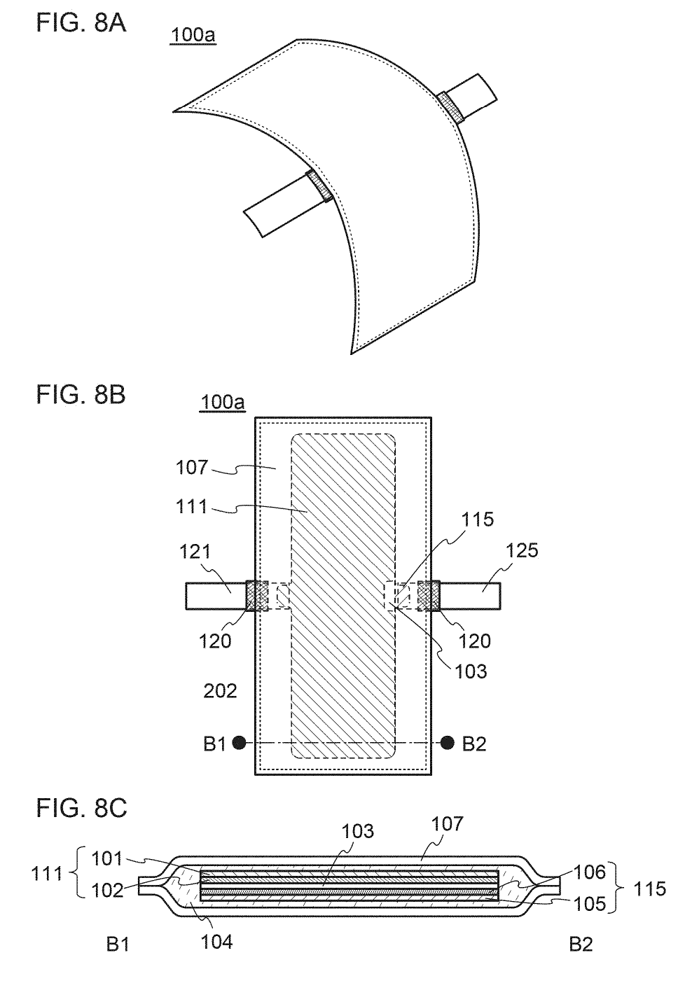

Furthermore, one of the electrodes (the positive electrode 111 and the negative electrode 115) of the secondary battery 100 that is positioned on the outer diameter side of bending is preferably longer, in the bending axis direction, than the other electrode that is positioned on the inner diameter side of bending. With such a structure, end portions of the positive electrode 111 and those of the negative electrode 115 can be aligned when the secondary battery 100 is curved at a certain curvature as illustrated in FIG. 7(C). That is, the entire region of the positive electrode active material layer 102 included in the positive electrode 111 can be provided so as to face the negative electrode active material layer 106 included in the negative electrode 115. Thus, positive electrode active materials included in the positive electrode 111 can efficiently contribute to a battery reaction. Therefore, the capacity of the secondary battery 100 per volume can be increased. Such a structure is particularly effective in the case where the curvature of the secondary battery 100 is fixed in using the secondary battery 100.

<Bendable Battery 2> FIG. 8 illustrates a secondary battery 100a different from the battery in FIG. 7. FIG. 8(A) is a perspective view of the secondary battery 100a, and FIG. 8(B) is a plan view of the secondary battery 100a. FIG. 8(C) is a cross-sectional view taken along a dashed-dotted line B1-B2 in FIG. 8(B).

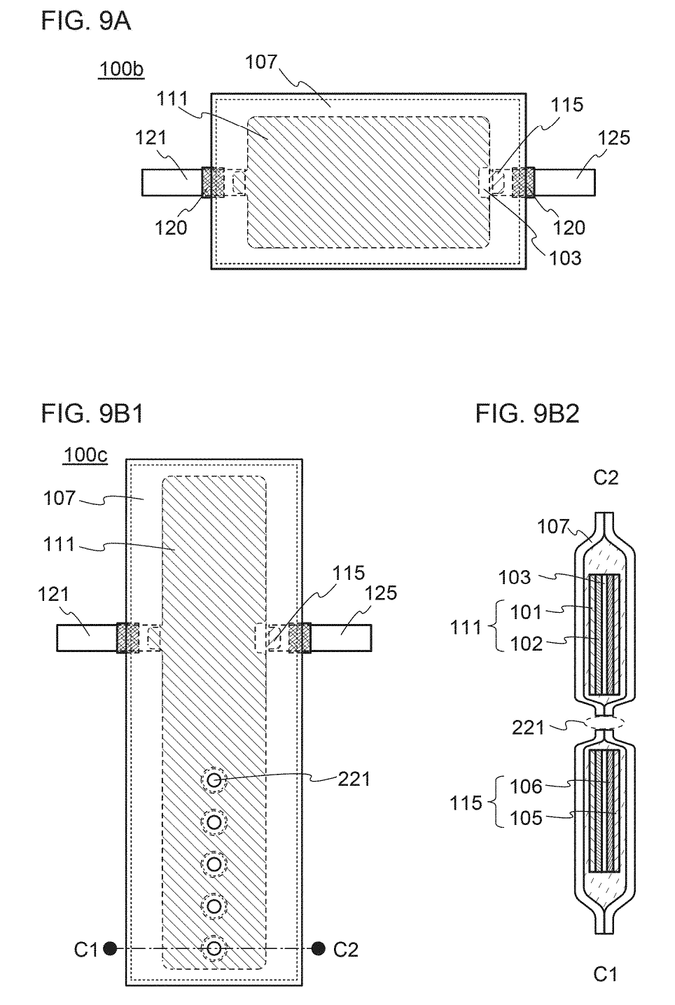

The secondary battery 100a of FIG. 9 is different from the secondary battery 100 of FIG. 7 in the positions of the positive electrode lead 121 and the negative electrode lead 125 and the shapes of the positive electrode 111, the negative electrode 115, and the separator 103.

In the secondary battery 100a of FIG. 9, the positive electrode lead 121 and the negative electrode lead 125 are drawn out from the facing sides of the exterior body 107. The line connecting the positive electrode lead 121 and the negative electrode lead 125 is not parallel to the bending axis of the secondary battery 100a. With this structure, a tab portion of the positive electrode 111 and a tab portion of the negative electrode 115, which are electrically connected to the positive electrode lead 121 and the negative electrode lead 125, can be provided in a region where the influence of bending is relatively small. A tab of the positive electrode 111 and a tab of the negative electrode 115 have a thinly extending shape and are likely to be weak in repetitive bending because of being thinner than the electrode portion where the active material is formed. Providing the tab of the electrode 1111 and the tab of the negative electrode 115 in a region where the influence of bending is small enables the secondary battery 100a with higher reliability.

For the structures of the secondary battery 100a other than the positions of the positive electrode lead 121 and the negative electrode lead 125 and the shapes of the positive electrode 111, the negative electrode 115, and the separator 103, the description with reference to FIG. 7 can be referred to.

<Bendable Battery 3> FIG. 9(A) illustrates a plan view of a secondary battery 100b different from the battery of FIG. 8.

The secondary battery 100b of FIG. 9(A) is different from the secondary battery 100a of FIG. 9 in the shapes of the positive electrode 111, the negative electrode 115, the separator 103, and the exterior body 107. The positive electrode 111, the negative electrode 115, the separator 103, and the exterior body 107 of the secondary battery 100b in FIG. 9(A) are long in the direction connecting the tab portion of the positive electrode 111 and the tab portion of the negative electrode 115 than in the bending axis direction. Even in the secondary battery 100b with such a structure, the tab of the positive electrode 111 and the tab of the negative electrode 115 can be provided in a region where the bending influence is relatively small.

For the structures of the secondary battery 100b other than the shapes of the positive electrode 111, the negative electrode 115, the separator 103, and the exterior body 107 and the positions and shapes of the positive electrode lead 121 and the negative electrode lead 125, the description with reference to FIG. 7 can be referred to.

<Bendable Battery 4> FIG. 9(B1) and FIG. 9(B2) illustrate a secondary battery 100c different from the battery of FIG. 8. FIG. 9(B1) is a plan view of the secondary battery 100c. FIG. 9(B2) is a cross-sectional view taken along a dashed-dotted line C1-C2 in FIG. 9(B1).

In the secondary battery 100c in FIG. 9(B1) and FIG. 9(B2), the positive electrode 111, the negative electrode 115, the separator 103, and the exterior body 107 have a plurality of holes 221. Since the secondary battery 100c illustrated in FIG. 9(B1) and FIG. 9(B2) has the structure including the holes 221, the secondary battery 100c can be provided in an electronic device which needs holes, such as a band portion of a watch-type device. Thus, the capacity of the secondary battery 100c can be increased.

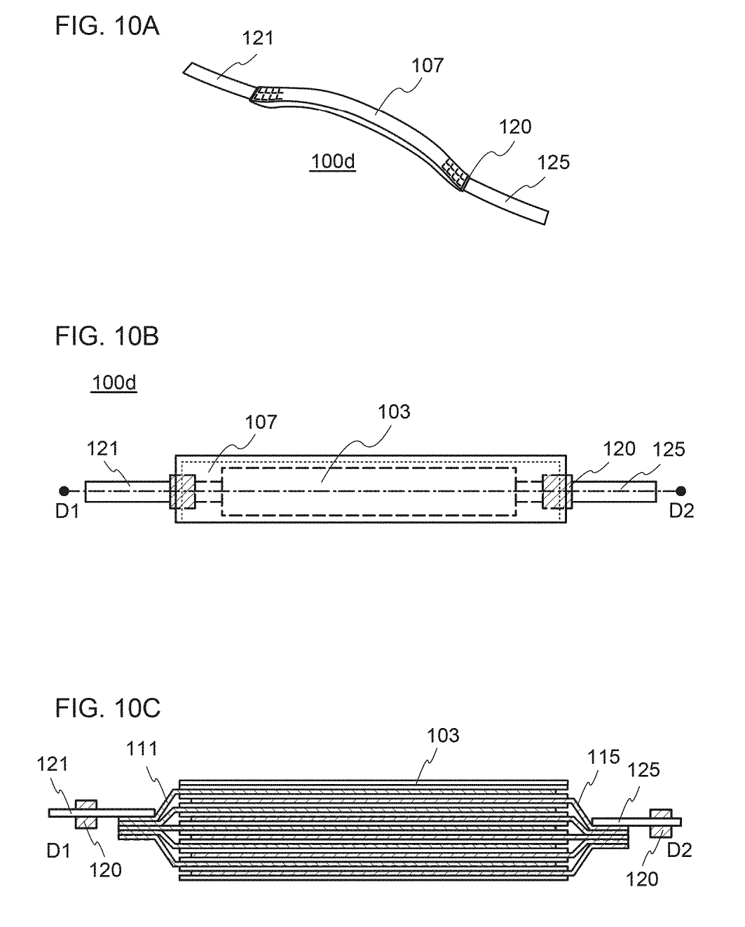

For the structures of the secondary battery 100c other than the shapes of the positive electrode 111, the negative electrode 115, the separator 103, and the exterior body 107 and the positions and shapes of the positive electrode lead 121 and the negative electrode lead 125, the description with reference to FIG. 7 can be referred to.

<Bendable Battery 5> FIG. 10 illustrates a secondary battery 100d different from the battery in FIG. 8. FIG. 10(A) is a perspective view of the secondary battery 100d, and FIG. 10(B) is a plan view of the secondary battery 100d. FIG. 10(C) is a cross-sectional view taken along a dashed-dotted line D1-D2 in FIG. 10(B). In FIG. 10(C), the positive electrode 111, the negative electrode 115, the separator 103, the positive electrode lead 121, the negative electrode lead 125, and the sealing layer 120 are selectively illustrated for the sake of clarity.

The secondary battery 100d illustrated in FIG. 10 is different from the secondary battery 100 of FIG. 7 in that sealing is performed by bonding three sides of the exterior body 107. Furthermore, it is also different from the secondary battery 100 of FIG. 7 in the positions of the positive electrode lead 121 and the negative electrode lead 125 and the shapes of the positive electrode 111, the negative electrode 115, and the separator 103. Note that for the structures other than the positions of the positive electrode lead 121 and the negative electrode lead 125 and the shapes of the positive electrode 111, the negative electrode 115, and the separator 103, the description with reference to FIG. 7 can be referred to.

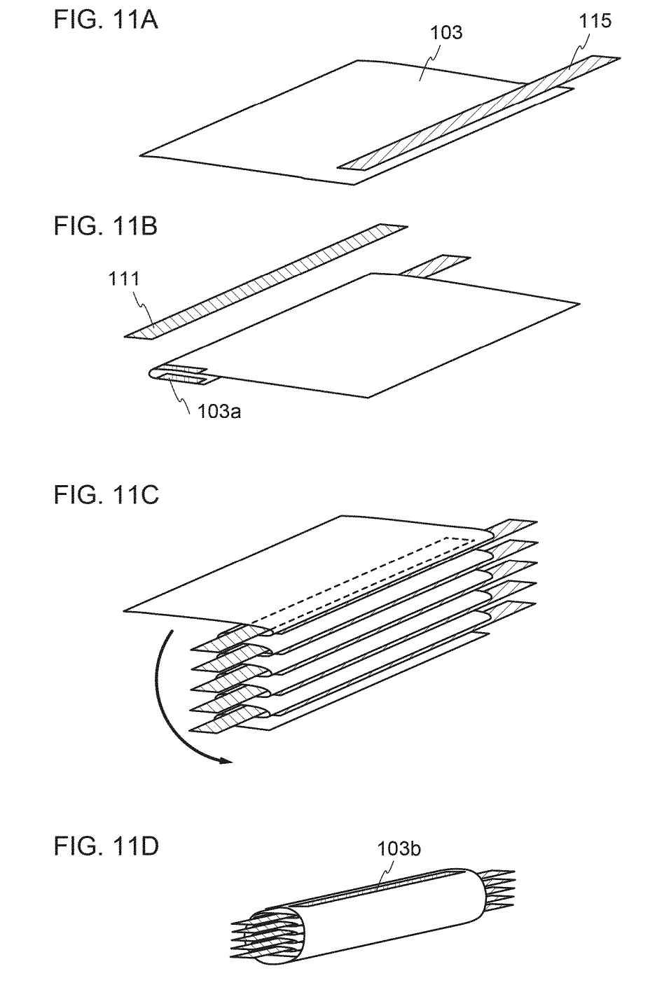

Here, some steps in a method for manufacturing the secondary battery 100d illustrated in FIG. 10 will be described with reference to FIG. 11.

First, the negative electrode 115 is placed over the separator 103 (FIG. 11(A)). The negative electrode active material layer included in the negative electrode 115 is placed so as to overlap with the separator 103.

Then, the separator 103 is folded such that the separator 103 is positioned over the negative electrode 113. Next, the positive electrode 111 is positioned over the separator 103 (FIG. 11(B)) such that the negative electrode active material layer 102 included in the positive electrode 111 overlaps with the separator 103 and the negative electrode active material layer 106. In the case where an electrode in which only one surface of a current collector is provided with an active material layer is used, the negative electrode active material layer 102 of the positive electrode 111 and the negative electrode active material layer 106 of the negative electrode 115 are positioned so as to face each other with the separator 103 provided therebetween.

In the case where the separator 103 is formed using a material that can be thermally welded, such as polypropylene, a region where the separator 103 overlaps with itself is thermally welded and then another electrode is made to overlap with the separator 103, whereby the slippage of the electrode in the fabrication process can be suppressed. Specifically, a region which does not overlap with the negative electrode 115 or the positive electrode 111 and in which the separator 103 overlaps with itself, e.g., a region denoted by a region 103a in FIG. 11(B), is preferably thermally welded.

By repeating the above steps, the positive electrode 111 and the negative electrode 115 can overlap with each other with the separator 103 therebetween as illustrated in FIG. 11(C).

Note that the plurality of negative electrodes 115 and the plurality of positive electrodes 111 may be placed to be alternately sandwiched by the separator 103 that is repeatedly folded in advance.

Next, as illustrated in FIG. 11(C), the plurality of positive electrodes 111 and the plurality of negative electrodes 115 are covered with the separator 103.

Then, as illustrated in FIG. 11(D), a region where the separator 103 overlaps with itself, e.g., a region 103b in FIG. 11(D), is thermally welded, and the plurality of positive electrodes 111 and the plurality of negative electrodes 115 are covered with the separator 103 to be bound.

Note that the plurality of positive electrodes 111, the plurality of negative electrodes 115, and the separator 103 may be bound with a binding material.

Since the positive electrodes 111 and the negative electrodes 115 are stacked through the above steps, one separator 103 has regions sandwiched between the plurality of positive electrodes 111 and the plurality of negative electrodes 115 and regions positioned so as to covet the plurality of positive electrodes 111 and the plurality of negative electrodes 115.

In other words, the separator 103 included in the secondary battery 100d in FIG. 11 is a single separator which is partly folded. In the folded parts of the separator 103, the plurality of positive electrodes 111 and the plurality of negative electrodes 115 are interposed.

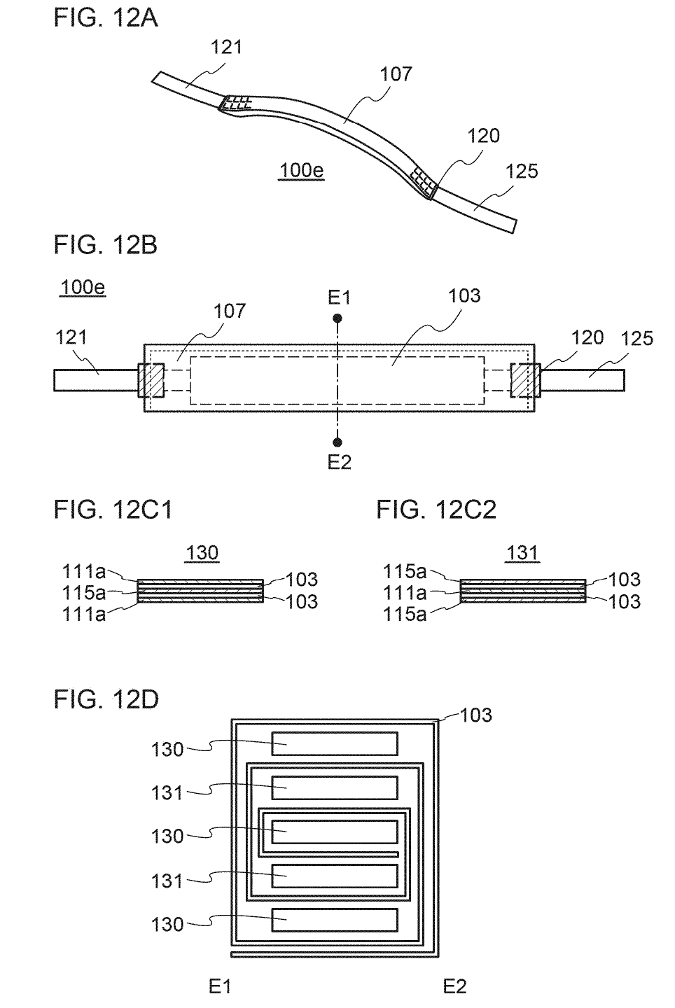

For the structures of the secondary battery 100d other than the shapes of the bonding region of the exterior body 107, the positive electrode 111, the negative electrode 115, the separator 103, and the exterior body 107 and the positions and shapes of the positive electrode lead 121 and the negative electrode lead 125, the description with reference to FIG. 7 can be referred to.

<Bendable Battery 6> FIG. 12 illustrates a secondary battery 100e different from the battery in FIG. 10. FIG. 12(A) is a perspective view of the secondary battery 100e, and FIG. 12(B) is a plan view of the secondary battery 100e. FIG. 12(C1) and FIG. 12(C2) are cross-sectional views of a first electrode assembly 130 and a second electrode assembly 131, respectively. FIG. 12(D) is a cross-sectional view taken along a dashed-dotted line E1-E2 in FIG. 12(B). In FIG. 12(D), the first electrode assembly 130, the electrode assembly 131, and the separator 103 are selectively illustrated for the sake of clarity.

The secondary battery 100e illustrated in FIG. 12 is different from the secondary battery 100d in FIG. 11 in the positions of the positive electrodes 111 and the negative electrodes 115 and the position of the separator 103.

As illustrated in FIG. 12(D), the secondary battery 100e includes a plurality of first electrode assemblies 130 and a plurality of electrode assemblies 131.

As illustrated in FIG. 12(C1), in the first electrode assembly 130, a positive electrode 11a including the positive electrode active material layers 102 on both surfaces of the positive electrode current collector 101, the separator 103, the negative electrode 115a including the negative electrode active material layers 106 on both surfaces of the negative electrode current collector 105, the separator 103, and another positive electrode 111a including the positive electrode active material layers 102 on both surfaces of the positive electrode current collector 101 are stacked in this order. As illustrated in FIG. 12(C2), in the second electrode assembly 13, the negative electrode 115a including the negative electrode active material layers 106 on both surfaces of the negative electrode current collector 105, the separator 103, the positive electrode 111a including the positive electrode active material layers 102 on both surfaces of the positive electrode current collector 101, the separator 103, and the negative electrode 115a including the negative electrode active material layers 106 on both surfaces of the negative electrode current collector 105 are stacked in this order.

As illustrated in FIG. 12(D), the plurality of first electrode assemblies 130 and the plurality of electrode assemblies 131 are covered with the would separator 103.

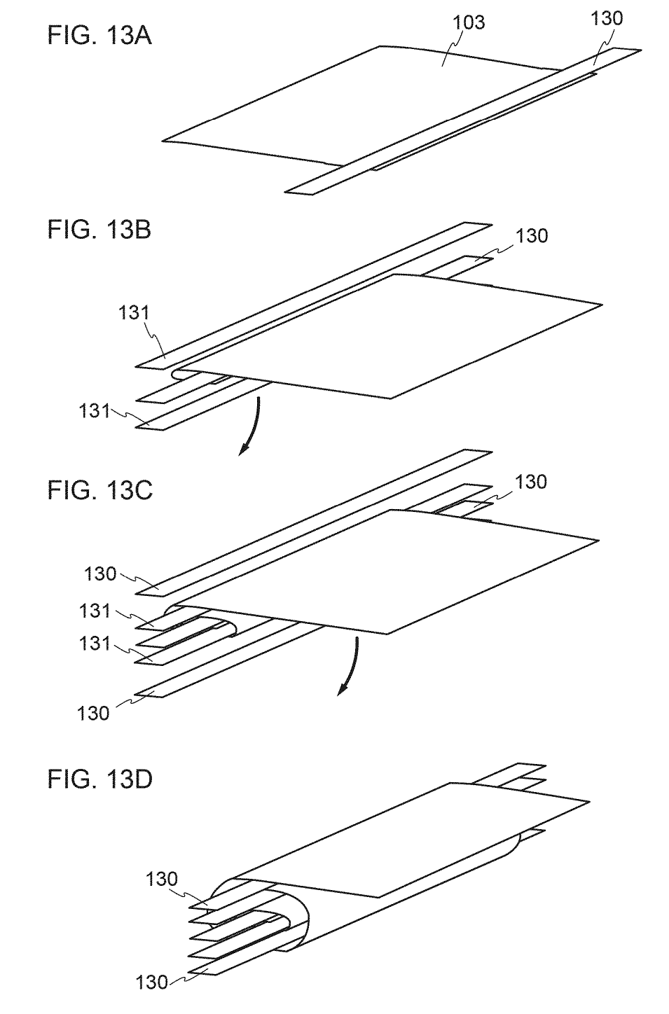

Here, some steps in a method for manufacturing the secondary battery 100e illustrated in FIG. 12 will be described with reference to FIG. 13.

First the first electrode assembly 130 is placed over the separator 103 (FIG. 13(A)).

Then, the separator 103 is folded such that the separator 103 is positioned over the first electrode assembly 130. Next, two sets of second electrode assemblies 131 are placed over and under the first electrode assembly 130 with the separator 103 therebetween (FIG. 13(B)).

Then, the separator 103 is wound so as to cover the two sets of second electrode assemblies 131. Moreover, two sets of first electrode assemblies 130 are placed over and under the two sets of second electrode assemblies 131 with the separator 103 positioned therebetween (FIG. 13(C)).

Then, the separator 103 is wound so as to cover the two sets of first electrode assemblies 130 (FIG. 13(D)).

Since the plurality of first electrode assemblies 130 and the plurality of electrode assemblies 131 are stacked through the above steps, the electrode assemblies are positioned between the separator 103 that is spirally wound.

It is preferable that the positive electrode 111a of the electrode assembly 130 that is positioned on the outermost side not include the positive electrode active material layer 102 on the outer side.

Although FIGS. 12(C1) and (C2) illustrate the electrode assemblies each having a structure including three electrodes and two separators, one embodiment of the present invention is not limited to this. The electrode assembly may include four or more electrodes and three or more separators. A larger number of electrodes lead to higher capacity of the secondary battery 100e. Note that the electrode assembly may include two electrodes and one separator. In the case where the number of electrodes is small, the secondary battery 100e in which a defect is unlikely to occur even when bending is performed repeatedly can be provided. Although a structure in which the secondary battery 100e includes three sets of first electrode assemblies 130 and two sets of second electrode assemblies is illustrated in FIG. 12(D), one embodiment of the present invention is not limited to this. A structure including ore electrode assemblies may be employed. A larger number of electrode assemblies lead to higher capacity of the secondary battery 100e. A structure including a smaller number of electrode assemblies may be employed. In the case where the number of electrode assemblies is small, the secondary battery 100e in which a defect is unlikely to occur even when bending is performed repeatedly can be provided.

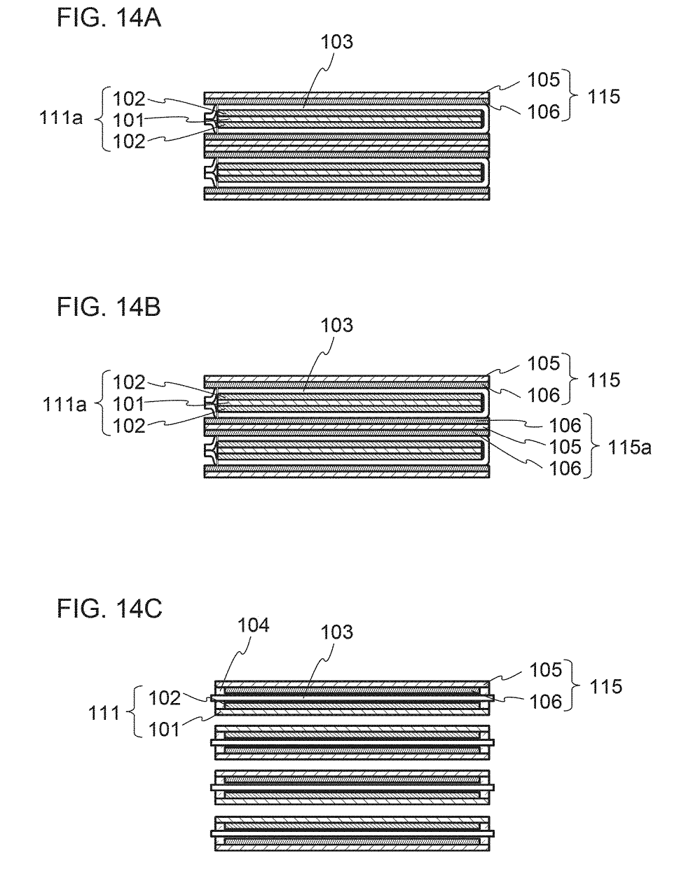

The description of FIG. 10 can be referred to for structures of the secondary battery 100e other than the positions of the positive electrodes 111 and the negative electrodes 115 and the position of the separator 103.

<Bendable Battery 7> FIG. 14(A) illustrates an example of the positive electrode 111, the negative electrode 115, and the stacked structure thereof, which is different from that of FIG. 7. In FIG. 14(A), two positive electrodes 111a in each of which the positive electrode active material layer 102 is provided on both surfaces of the positive electrode current collector 101, and four negative electrodes 115 in each of which the negative electrode active material layer 106 is provided on one surface of the negative electrode current collector 105 are stacked. Even in the structure in FIG. 14(A), a contact surface between metals such as a contact surface between surfaces of the negative electrodes 115 on which the negative electrode active material layer 106 is not provided can be formed. At the same time, providing the active material layer on the both surfaces of the positive electrode current collector 101 can increase the capacity of the secondary battery 100 per unit volume.

As for the positive electrode 111a, the negative electrode 115, and the stacking order thereof, the description with reference to FIG. 7 can be referred to.

<Bendable Battery 8> FIG. 14(B) illustrates an example of the positive electrode 111a, the negative electrode 115a, and the stacked structure thereof, which is different from that of FIG. 7. In FIG. 14(B), two positive electrodes 111a in each of which the positive electrode active material layer 102 is provided on both surfaces of the positive electrode current collector 101, two negative electrodes 115 in each of which the negative electrode active material layer 106 is provided on one surface of the negative electrode current collector 105, and one negative electrode 115a in which the negative electrode active material layer is provided on both surfaces of the negative electrode current collector 105 are stacked. Providing the active material layer on the both surfaces of the current collector as illustrated in FIG. 14(B) can increase the capacity of the secondary battery 100 per unit volume.

As for the positive electrode 111a, the negative electrode 115, the negative electrode 115a, and the stacking order thereof, the description with reference to FIG. 7 can be referred to.

<Bendable Battery 9> FIG. 14(C) illustrates an example of the positive electrode 111, the negative electrode 115, and the stacked structure thereof, which is different from that of FIG. 7. In FIG. 14(C), an electrolytic solution including a polymer is used as the electrolytic solution 104, and a set of the positive electrode 111, the negative electrode 115, and the separator 103 is bonded by the electrolytic solution 104. With this structure, the slide between the positive electrode 111 and the negative electrode 115 whose a battery reaction occurs can be prevented when the secondary battery 100 is curved.

In addition, many contact surfaces between metals, such as a contact surface between surfaces of the positive electrodes 111 on which the positive electrode active material layer 103 is not provided and a contact surface between surfaces of the negative electrodes 115 on which the negative electrode active material layer 106 is not provided, can be obtained. These contact surfaces slide on each other when the secondary battery 100 is curved, so that stress on the electrodes caused by the difference between the inner diameter and the outer diameter of a curved portion can be reduced.

Therefore, the deterioration of the secondary battery 100 can be further suppressed. In addition, the secondary battery 100 can be more reliable.

As the polymer included in the electrolytic solution 104 in the example of FIG. 14(C), for example, a polyethylene oxide-based, polyacrylonitrile-based, polyvinylidene fluoride-based, polyacrylate based, or polymethacrylate-based polymer can be used. A polymer which can gelate the electrolytic solution 104 t normal temperature (e.g., 25° C.) is preferably used. In this specification and the like, the term polyvinylidene fluoride-based polymer, for example, refers to a polymer including polyvinylidene fluoride (PVDF), and includes a poly(vinylidene fluoride-hexafluoropropylene) copolymer and the like.

The above polymer can be qualitatively analyzed using an FT-IR (Fourier transform infrared spectrometer) or the like. For example, the polyvinylidene fluoride-based polymer has an absorption peak showing a C—F bond in a spectrum obtained with the FT-IR. Furthermore, the polyacrylonitrile-based polymer has an absorption peak showing a C≡N bond in a spectrum obtained with FT-IR.

Note that as for the positive electrode 111, the negative electrode 115, and the stacking order thereof, the description with reference to FIG. 7 can be referred to.

This embodiment can be implemented in appropriate combination with any of the other embodiments. In addition, the structure examples of the secondary battery of this embodiment can be implemented in appropriate combination with any of the other structure examples.

### Embodiment 4

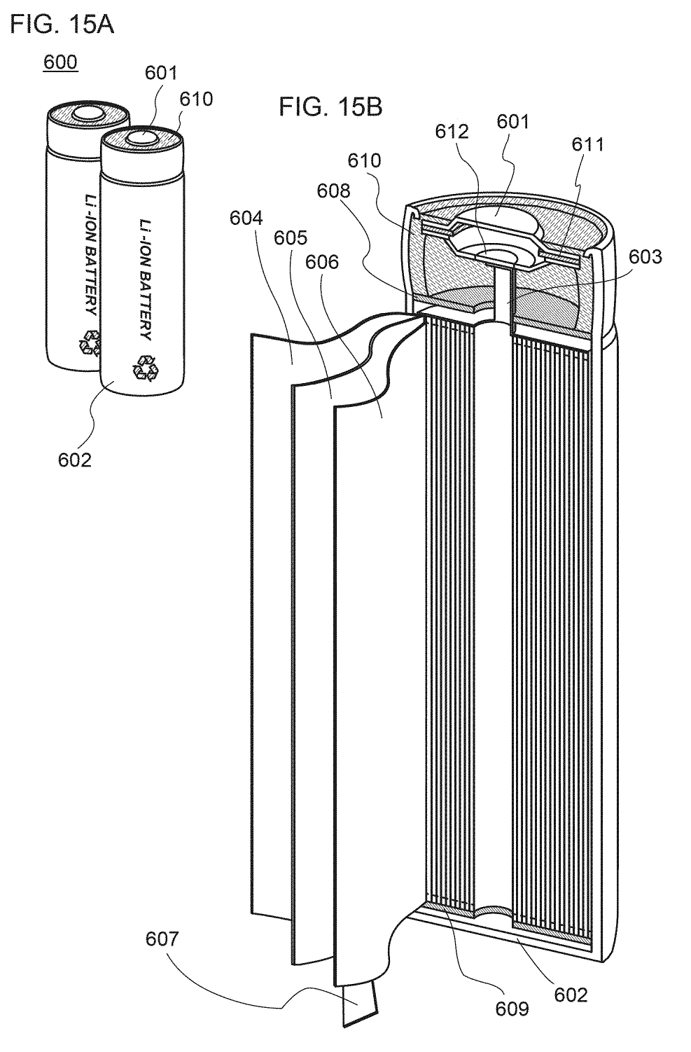

In this embodiment, other structure examples of the secondary battery of the present including the negative electrode described in Embodiment 1 are described with reference to FIG. 15 to FIG. 20.

<Cylindrical Secondary Battery> First, as another example of the secondary battery, a cylindrical secondary battery is shown. A cylindrical secondary battery is described with reference to FIG. 15. As illustrated in FIG. 15(A), a cylindrical secondary battery 600 includes a positive electrode cap (battery cap) 601 on its top surface and a battery can (outer can) 602 on its side surface and bottom surface. The positive electrode cap and the battery can (outer can) 602 are insulated from each other by a gasket (insulating gasket) 610.

FIG. 15(B) is a schematic view of a cross-section of the cylindrical secondary battery. Inside the battery can 602 having a hollow cylindrical shape, a battery element in which a strip-like positive electrode 604 and a strip-like negative electrode 606 are would with a separator 605 interposed therebetween is provided. although not illustrated, the battery element is wound around a center pin as a center. One end of the battery can 602 is close and the other end thereof is open. For the battery can 602, a metal having a corrosion-resistant property to an electrolytic solution, such as nickel, aluminum, or titanium, an alloy of such a metal, or an alloy of such a metal and another metal (e.g., stainless steel or the like) can be used. Alternatively, the battery can 602 is preferably covered with nickel, aluminum, or the like in order to prevent corrosion caused by a nonaqueous electrolytic solution. Inside the battery can 602, the battery element in which the positive electrode, the negative electrode, and the separator are wound is interposed between a pair of insulating plates 608 and 609 which face each other. Further, a nonaqueous electrolytic solution (not illustrated) is injected inside the battery can 602 provided with the battery element. As the nonaqueous electrolytic solution, a nonaqueous electrolytic solution which is similar to that of a secondary battery of the above embodiments can be used.

The positive electrode 604 and the negative electrode 606 can be formed in a manner similar to that of the positive electrode and the negative electrode of the thin secondary battery described in the above embodiment. Since the positive electrode and the negative electrode of the cylindrical secondary battery are wound, active materials are preferably termed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 is welded to a safety valve mechanism 612, and the negative electrode terminal 607 is welded to the inner bottom of the battery can 602. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. Further, the PTC element 611, which serves as a thermally sensitive resistor whose resistance increases as temperature rises, limits the amount of current by increasing the resistance, in order to present abnormal heat generation. Note that barium titanate (BaTiO₃)-based semiconductor ceramic or the like can be used for the PTC element.

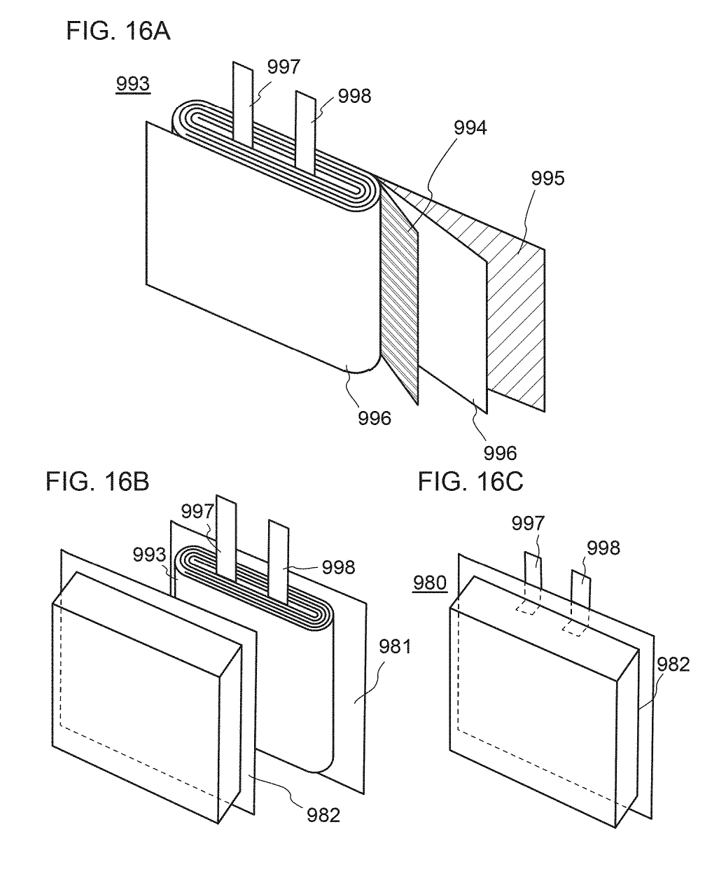

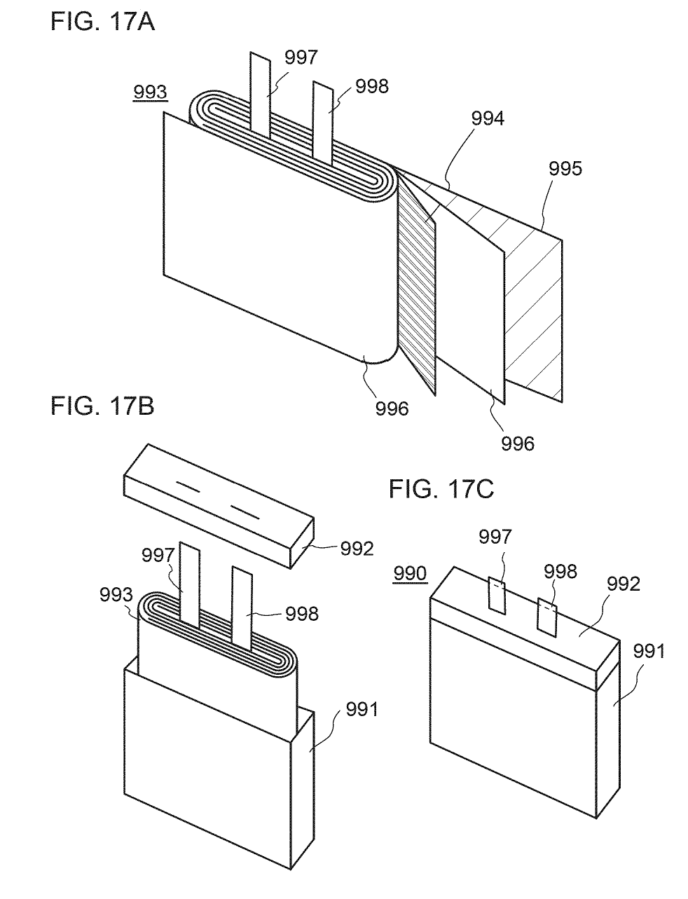

Note that in FIG. 15, the cylindrical secondary battery is given as an example of the secondary battery; however, any of secondary batteries with a variety of shapes, such as a sealed secondary battery and a rectangular secondary battery, can be used. Further, a structure in which a plurality of positive electrodes, a plurality of negative electrodes, and a plurality of separators are stacked or wound may be employed. FIG. 16 to FIG. 20 illustrate examples of other secondary batteries.

<Structure Example of Secondary Battery> FIG. 16 and FIG. 17 illustrate structural examples of thin secondary batteries. A wound body 993 illustrated in FIG. 16(A) includes a negative electrode 994, a positive electrode 995, and a separator 996.

The wound body 993 is obtained by winding a sheet of a stack in which the negative electrode 994 overlaps with the positive electrode 995 with the separator 996 provided therebetween. The wound body 993 is covered with a rectangular sealed container or the like; thus, a rectangular secondary battery is fabricated.

Note that the number of stacks each including the negative electrode 994, the positive electrode 995, and the separator 996 may be determined as appropriate depending on the required capacity and element volume. The negative electrode 994 connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

In a secondary battery 990 illustrated in FIG. 16(B) and FIG. 16(C), the wound body 993 is packed in a space formed by bonding a film 981 and a film 982 having a depressed portion that serve as exterior bodies by thermocompression bonding or the like. The wound body 993 includes the lead electrode 997 and the lead electrode 998, and is soaked in an electrolytic solution inside a space surrounded by the film 981 and the film 982 having a depressed portion.

For the film 981 and the film 982 having a depressed portion, a metal material such as aluminum or a material can be used, for example. With the use of a resin material for the film 981 and the film 982 having a depressed portion, the film 981 and the film 982 having a depressed portion can be deformed when external force is applied; thus, a flexible secondary battery can be manufactured.

Although FIG. 16(B) and FIG. 16(C) illustrate an example where two films are used, the wound body 993 may be placed in a space formed by bending one film.

Furthermore, a flexible secondary battery can be fabricated when a resin material or the like is used for the exterior body and the sealed container of the secondary battery. Note that in the case where a resin material is used for the exterior body and the sealed container, a conductive material is used for a portion connected to the outside.

For example, FIG. 17 illustrates another example of a flexible thin secondary battery. Because the wound body 993 illustrated in FIG. 17(A) is the same as that illustrated in FIG. 16(A), a detailed description thereof is omitted.

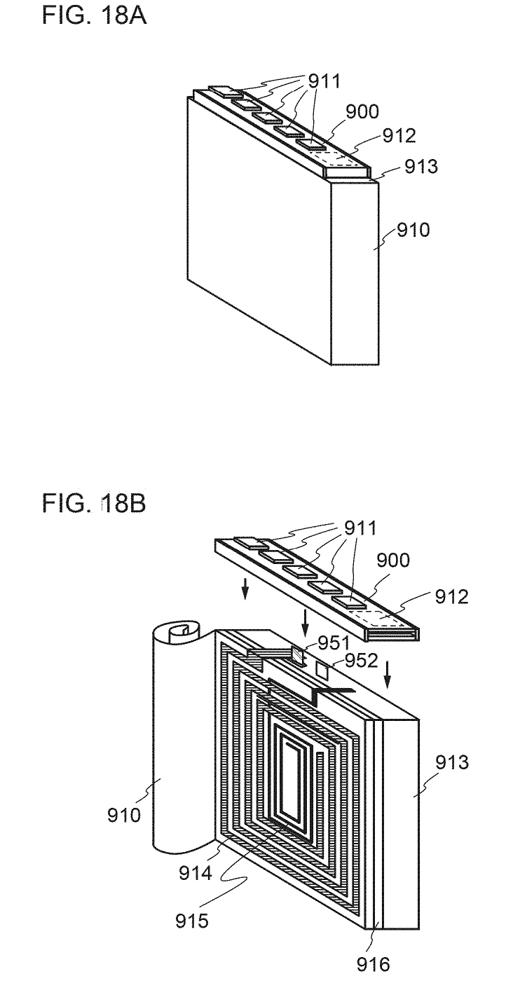

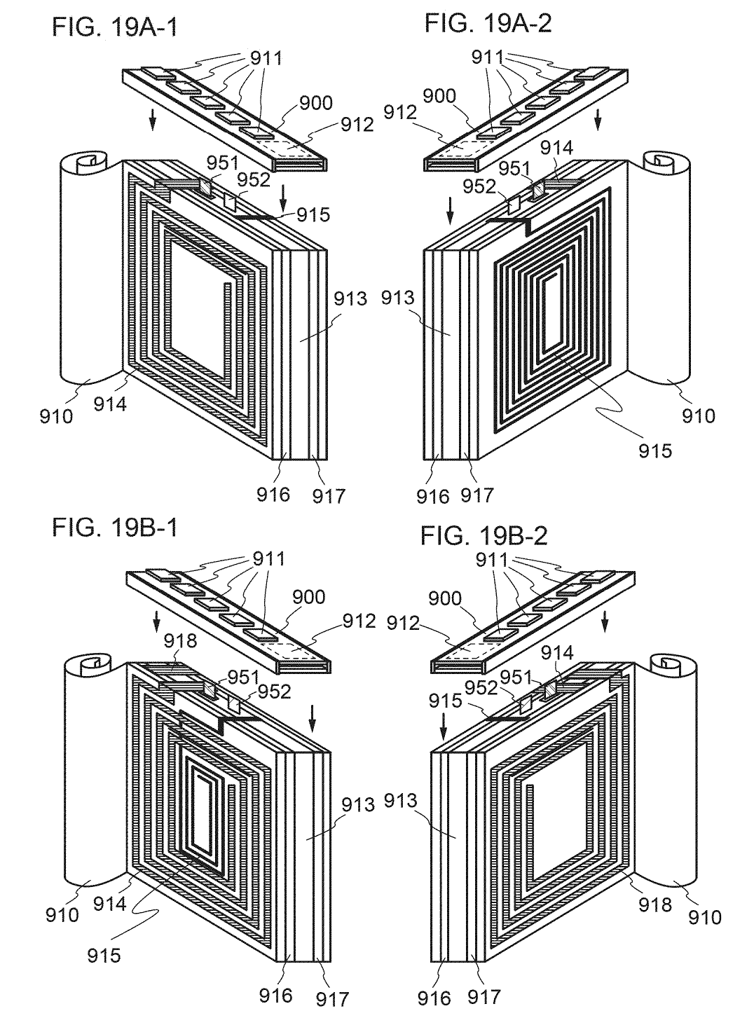

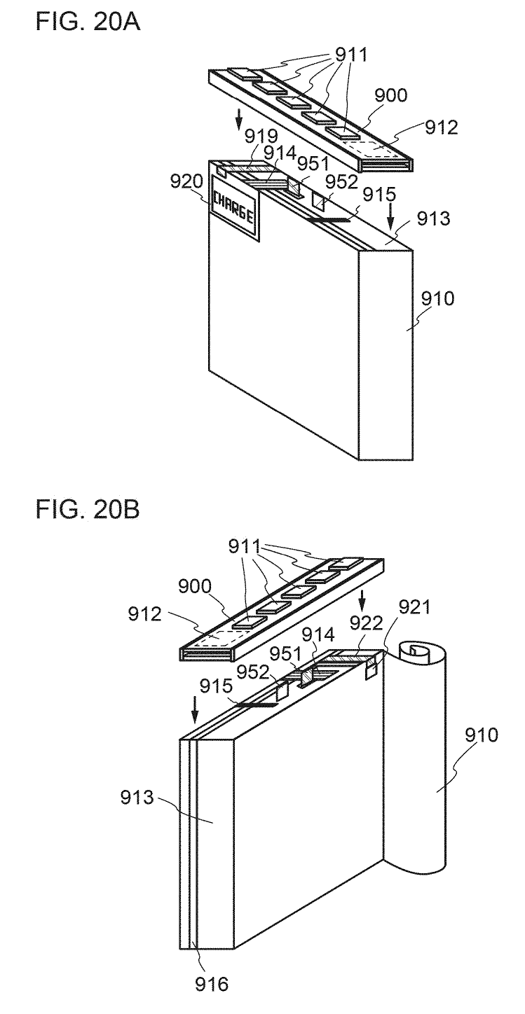

In the secondary battery 990 illustrated in FIG. 17(B) and FIG. 17(C), the wound body 993 is surrounded by the exterior body 991. The wound body 993 includes the lead electrode 997 and the lead electrode 998, and is soaked in an electrolytic solution inside a space surrounded by the exterior bodies 991 and 992. For example, a metal material such as aluminum or a resin material can be used for the exterior bodies 991 and 992. With the use of a resin material as a material of the exterior bodies 991 and 992, the exterior bodies 991 and 992 can be changed in their forms when external force is applied; thus, a flexible thin secondary battery can be fabricated.

<Structural Example of Power Storage System> Structural examples of power storage systems will be described with reference to FIG. 18, FIG. 19, and FIG. 20. Here, a power storage system refers to, for example, a device including a secondary battery.

FIG. 18(A) and FIG. 18(B) are external views of a power storage system. The power storage system includes a circuit board 900 and a secondary battery 913. A label 910 is attached to the secondary battery 913. As shown in FIG. 18(B), the power storage system further includes a terminal 951, a terminal 952, an antenna 914, and an antenna 915.

The circuit board 900 includes terminals 911 and a circuit 912. The terminals 911 are connected to the terminal 951, the terminal 952, the antenna 914, the antenna 915, and the circuit 912. Note that a plurality of terminals serving as a control signal input terminal, a power supply terminal, and the like may be provided.

The circuit 912 may be provided on the rear side of the circuit board 900. Each of the antennas 914 and 915 is not limited to having a coal shape and may have a linear shape or a plate shape, for example. Further, an antenna such as a planar antenna, an aperture antenna, a traveling-wave antenna, an EH antenna, a magnetic-field antenna, or a dielectric antenna may be used. Alternatively, the antenna 914 or the antenna 915 may be a flat-plate conductor. The flat-plate conductor can serve as one of conductors for electric field coupling. That is, the antenna 914 or the antenna 915 may serve as one of two conductors included in a capacitor. Thus, power can be transmitted and received not only by an electromagnetic field or a magnetic field but also by an electric field.

The line width of the antenna 914 is preferably larger than that of the antenna 915. This makes it possible to increase the amount of electric power received by the antenna 914.

The power storage system includes a layer 916 between the secondary battery 913 and the antennas 914 and 915. The layer 916 has a function of blocking an electromagnetic field from the secondary battery 913, for example. As the layer 916, for example, a magnetic body can be used.

Note that the structure of the power storage system is not limited to that shown in FIG. 18.

For example, as shown in FIG. 19(A-1) and FIG. 19(A-2), two opposite surfaces of the secondary battery 913 in FIG. 18(A) and FIG. 18(B) may be provided with antennas. FIG. 19(A-1) is an external view seen from a direction of one of the two surfaces, and FIG. 19(A-2) is an external view seen from a direction of the other of the two surfaces. For portions similar to those of the power storage system in FIG. 18(A) and FIG. 18(B), a description of the power storage system illustrated in FIG. 18(A) and FIG. 18(B) can be referred to as appropriate.

As illustrated in FIG. 19(A-1), the antenna 914 is provided on one of the two surfaces of the secondary battery 913 with the layer 916 interposed therebetween, and as illustrated in FIG. 19(A-2), the antenna 915 is provided on the other of the two surfaces of the secondary battery 913 with a layer 917 interposed therebetween. The layer 917 has a function of blocking an electromagnetic field from the secondary battery 913, for example. As the layer 917, for example, a magnetic body can be used.

With the above structure, both of the antennas 914 and 915 can be increased in size.

Alternatively, as illustrated in FIG. 19(B-1) and FIG. 19(B-2), two opposite surfaces of the secondary battery 913 in FIG. 18(A) and FIG. 18(B) may be provided with different types of antennas. FIG. 19(B-1) is an external view seen from a direction of one of the two surfaces, and FIG. 19(B-2) is an external view seen from a direction of the other of the two surfaces. For portions similar to those of the power storage system in FIG. 18(A) and FIG. 18(B), a description of the power storage system illustrated in FIG. 18(A) and FIG. 18(B) can be referred to as appropriate.

As illustrated in FIG. 19(B-1), the antenna 914 and the antenna 915 are provided on one of the two surfaces of the secondary battery 913 with the layer 916 provided therebetween, and as illustrated in FIG. 19(A-2), an antenna 918 is provided on the other of the two surfaces of the secondary battery 913 with the layer 917 provided therebetween. The antenna 918 has a function of performing data communication with an external device, for example. An antenna with a shape that can be applied to the antennas 914 and 915, for example, can be used as the antenna 918. As an example of a method for communication between the power storage system and another device via the antenna 918, a response method that can be used between the power storage system and another device, such as NFC, can be employed.

Alternatively, as illustrated in FIG. 20(A), the secondary battery 913 in FIG. 18(A) and FIG. 18(B) may be provided with a display device 920. The display device 920 is electrically connected to the terminal 911 via a terminal 919. It is possible that the label 910 is not provided in a portion where the display device 920 is provided. For portions similar to those of the power storage system in FIG. 18(A) and FIG. 18(B), a description of the power storage system illustrated in FIG. 18(A) and FIG. 18(B) can be referred to as appropriate.

The display device 920 can display, for example, an image showing whether or not charging is being carried out, an image showing the amount of stored power, or the like. As the display device 920, electronic paper, a liquid crystal display device, an electroluminescent (EL) display device, or the like can be used. For example, power consumption of the display device 920 can be reduced when electronic paper is used.

Alternatively, as illustrated in FIG. 20(B), the secondary battery 913 illustrated in FIG. 18(A) and FIG. 18(B) may be provided with a sensor 921. The sensor 921 is electrically connected to the terminal 911 via a terminal 922. For portions similar to those of the power storage system in FIG. 18(A) and FIG. 18(B), a description of the power storage system illustrated in FIG. 18(A) and FIG. 18(B) can be referred to as appropriate.

As the sensor 921, a sensor that has a function of measuring, for example, force, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays can be used. With the sensor 921, for example, data on the environment (e.g., temperature) where the power storage system is placed can be acquired and stored in a memory in the circuit 912.

The electrode of one embodiment of the present invention is used in the secondary battery and the power storage system that are described in this embodiment. The capacity of the secondary battery and the power storage system can thus be high. Furthermore, energy density can be high. Moreover, reliability can be high, and life can be long.

This embodiment can be implemented in an appropriate combination with any of the other embodiments.

### Embodiment 5

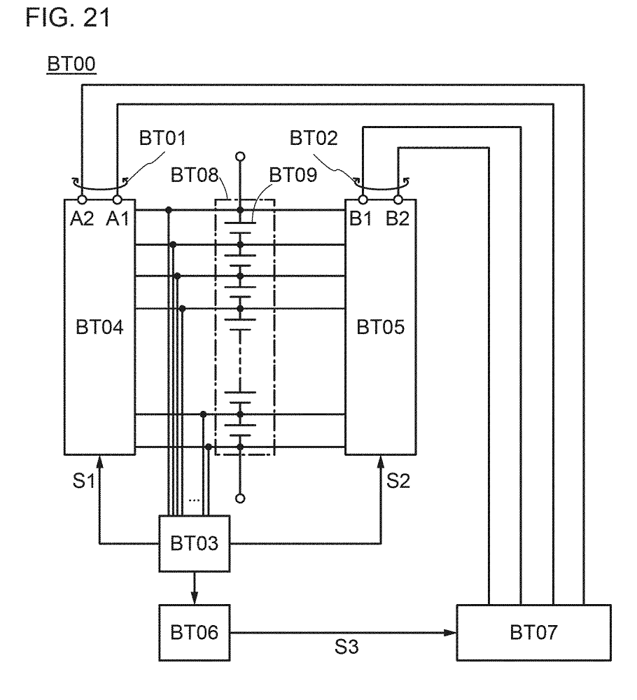

A battery management unit (Battery Management Unit: BMU) that can be used in combination with the secondary battery including the negative electrode described in the above embodiment and transistors that are suitable for a circuit included in the battery management unit will be described with reference to FIG. 21 to FIG. 27. In this embodiment, in particular, a battery management unit of a power storage device including battery cells connected in series will be described.

When a plurality of battery cells connected in series are charged and discharged repeatedly, the battery cells have different capacity (output voltage) from one another due to the variation in characteristics among the battery cells. A discharge capacity of all of the battery cells connected in series depends on a battery cell with small capacity. The variation in capacity reduces the capacity at the time of discharging. Charging based on a battery cell with small capacity may cause insufficient charging. Moreover, charging based on a battery cell with high capacity may cause overcharge.

Thus, the battery management unit of the power storage device including the battery cells connected in series has a function of reducing variations in capacity among the battery cells, which cause an undercharge and an overcharge. Examples of a circuit configuration for reducing variations in capacity among battery cells include a resistive type, a capacitive type, and an inductive type, and a circuit configuration that can reduce variations in capacity using transistors with a low off-state current will be explained here as an example.

A transistor including an oxide semiconductor in its channel formation region (an OS transistor) is preferably used as the transistor with a low off-state current. When an OS transistor with a low off-state current is used in the circuit configuration of the battery management unit of the power storage device, the amount of charge that leaks from the battery can be reduced, and reduction in capacity with the lapse of time can be suppressed.

As the oxide semiconductor used in the channel formation region, an In—M—Zn oxide (M is Ga, Sn, Y, Zr, La, Ce, or Nd) is used. In the case where the atomic ratio of the metal elements of a target used for forming an oxide semiconductor film is In:M:Zn=x₁:y₁:z₁, x₁/y₁ is preferably greater than or equal to ⅓ and less than or equal to 6, further preferably greater than or equal to 1 and less than or equal to 6, and z₁/y₁ is preferably greater than or equal to ⅓ and less than or equal to 6, further preferably greater than or equal to 1 and less than or equal to 6. Note that when z₁/y₁ is greater than or equal to 1 and less than or equal to 6, a CAAC-OS film as the oxide semiconductor film is easily formed.

Here, the CAAC-OS film will be described.

A CAAC-OS film is one of oxide semiconductor films having a plurality of c-axis aligned crystal parts.

In a combined analysis image (also referred to as a high-resolution TEM image) of a bright-field image and a diffraction pattern of a CAAC-OS film, which is obtained using a transmission electron microscope (TEM), a plurality of crystal parts can be observed. However, in the high-resolution TEM image, a boundary between crystal parts, that is, a grain boundary is not clearly observed. Thus, in the CAAC-OS film, it can be said that a reduction in electron mobility due to the grain boundary is less likely to occur.

According to the high-resolution cross-sectional TEM image of the CAAC-OS film observed from the direction substantially parallel to the sample surface, metal atoms are arranged in a layered manner in the crystal parts. Each metal atom layer reflects unevenness of a surface over which the CAAC-OS film is formed (hereinafter, also referred to as a formation surface) or the top surface of the CAAC-OS film, and is arranged parallel to the formation surface or the top surface of the CAAC-OS film.

On the other hand, according to the plan high-resolution TEM image of the CAAC-OS film observed from the direction substantially parallel to the sample surface, metal atoms are arranged in a triangular or hexagonal arrangement in the crystal parts. However, there is no regularity of arrangement of metal atoms between different crystal parts.

For example, when the structure of a CAAC-OS film including an InGaZnO₄ crystal is analyzed by an out-of-plane method using an X-ray diffraction (XRD) apparatus, a peak may appear at a diffraction angle (2θ) of around 31°. This peak is derived from the (009) plane of the InGaZnO₄ crystal, which indicates that crystals in the CAAC-OS film having C-axis alignment, and that the c-axes are aligned in the direction substantially perpendicular to the formation surface or the top surface of the CAAC-OS film.

Note that in the analysis of the CAAC-OS film including an InGaZnO₄ crystal by an out-of-plane method, another peak may appear when 2θ is around 36°, in addition to the peak at 2θ of around 31°. The peak at 2θ of around 36° indicates that a crystal having no c-axis alignment is included in part of the CAAC-OS film. It is preferable that in the CAAC-OS film, a peak appear when 2θ is around 31° and that a peak not appear when 2θ is around 36°.

The CAAC-OS film is an oxide semiconductor film with low impurity concentration. The impurity is an element other than the main components of the oxide semiconductor film, such as hydrogen, carbon, silicon, or a transition metal element. In particular, an element (specifically, silicon or the like) having higher strength of bonding to oxygen than a metal element included in an oxide semiconductor film extracts oxygen from the oxide semiconductor film, which results in disorder of the atomic arrangement and reduced crystallinity of the oxide semiconductor film. Furthermore, a heavy metal such as iron or nickel, argon, carbon dioxide, or the like has a large atomic radius (molecular radius), and thus disturbs the atomic arrangement of the oxide semiconductor film and causes a decrease in crystallinity when it is contained in the oxide semiconductor film. Note that the impurity contained in the oxide semiconductor might serve as a carrier trap or a carrier generation source.

The CAAC-OS film is an oxide semiconductor film having a low density of defect states. In some cases, oxygen vacancies in the oxide semiconductor film serve as carrier traps or serve as carrier generation sources when hydrogen is captured therein, for example.

The state in which the impurity concentration is low and the density of defect states is low (the number of oxygen vacancies is small) is referred to as a “highly purified intrinsic” or “substantially highly purified intrinsic” state. A highly purified intrinsic or substantially highly purified intrinsic oxide semiconductor film has few carrier generation sources, and thus can have a low carrier density. Therefore, a transistor including the oxide semiconductor film rarely has negative threshold voltage (is rarely normally on). The highly purified intrinsic or substantially intrinsic oxide semiconductor film has few carrier traps. Accordingly, the transistor including the oxide semiconductor film has little variation in electrical characteristics and high reliability. Charge trapped by the carrier traps in the oxide semiconductor film takes a long time to be released and might behave like fixed charge. Thus, the transistor including the oxide semiconductor film having high impurity concentration and a high density of defect states has unstable electrical characteristics in some cases.

In a transistor that causes the CAAC-OS film, variation in electrical characteristics due to irradiation with visible light or ultraviolet light is small.

Since the OS transistor has a wider band gap than a transistor including silicon in its channel formation region (a Si transistor), dielectric breakdown is unlikely to occur when a high voltage is applied. Although a voltage of several hundreds of volts is generated when battery cells are connected in series. The above-described OS transistor is suitable for a circuit configuration of a battery management unit which is used for such battery cells in the power storage device.

FIG. 21 is an example of a block diagram of the power storage device. A power storage device BT00 illustrated in FIG. 21 includes a terminal pair BT01, a terminal pair BT02, a switching control circuit BT03, a switching circuit BT04, a switching circuit BT05, a voltage transformation control circuit BT06, a voltage transformer circuit BT07, and a battery portion BT08 including a plurality of battery cells BT09 connected in series.

In the power storage device BT00 illustrated in FIG. 21, a portion formed of the terminal pair BT01, the terminal pair BT02, the switching control circuit BT03, the switching circuit BT04, the switching circuit BT05, the voltage transformation control circuit BT06, and the voltage transformer circuit BT07 can be referred to as a battery management unit.

The switching control circuit BT03 controls operations of the switching circuits BT04 and BT05. Specifically, the switching control circuit BT03 selects battery cells to be discharged (a discharge battery cell group) and battery cells to be charged (a charge battery cell group) in accordance with the voltage measured for every battery cell BT09.

Furthermore, the switching control circuit BT03 outputs a control signal S1 and a control signal S2 on the basis of the selected discharge battery cell group and the selected charge battery cell group. The control signal S1 is output to the switching circuit BT04. This control signal S1 is a signal that controls the switching circuit BT04 so that the terminal pair BT01 and the discharge battery cell group are connected. In addition, the control signal S2 is output to the switching circuit BT05. The control signal S2 is a signal that controls the switching circuit BT05 so that the terminal pair BT02 and the charge battery cell group are connected.

The switching control circuit BT03 generates the control signal S1 and the control signal S2 on the basis of the structure of the switching circuit BT04, the switching circuit BT05, and the voltage transformer circuit BT07 so that terminals having the same polarity of the terminal pair BT02 and the charge battery cell group are connected with each other.

The operations of the switching control circuit BT03 will be described in detail.

First, the switching control circuit BT03 measures the voltage of each of the plurality of battery cells BT09. Then, the switching control circuit BT03 determines that the battery cell BT09 having a voltage higher than a predetermined threshold value is a high-voltage battery cell (high-voltage cell) and that the battery cell BT09 having a voltage lower than the predetermined threshold value is a low-voltage battery cell (constant-voltage cell), for example.

As a method to determine whether a battery cell is a high-voltage cell or a low-voltage cell, any of various methods can be employed. For example, the switching control circuit BT03 may determine whether each battery cell BT09 is a high-voltage cell or a low-voltage cell on the basis of the voltage battery cell BT09 having the highest voltage or the lowest voltage among the plurality of battery cells BT09. In this case, the switching control circuit BT03 can determine whether each battery cell BT09 is a high-voltage cell or a low-voltage cell by, for example, determining whether or not the ratio of the voltage of each battery cell BT09 to the reference voltage is the predetermined value or more. Then, the switching control circuit BT03 determines a charge battery cell group and a discharge battery cell group on the basis of the determination result.

Note that high-voltage cells and low-voltage cells are mixed in various states in the plurality of battery cells BT09. For example, the switching control circuit BT03 selects a portion having the largest number of high-voltage cells connected in series as the discharge battery cell group in mixed high-voltage cells and low-voltage cells. Furthermore, the switching control circuit BT03 selects a portion having the largest number of low-voltage cells connected in series as the charge battery cell group. In addition, the switching control circuit BT03 may preferentially select the battery cells BT09 which are almost overcharged or over-discharged as the discharge battery cell group or the charge battery cell group.

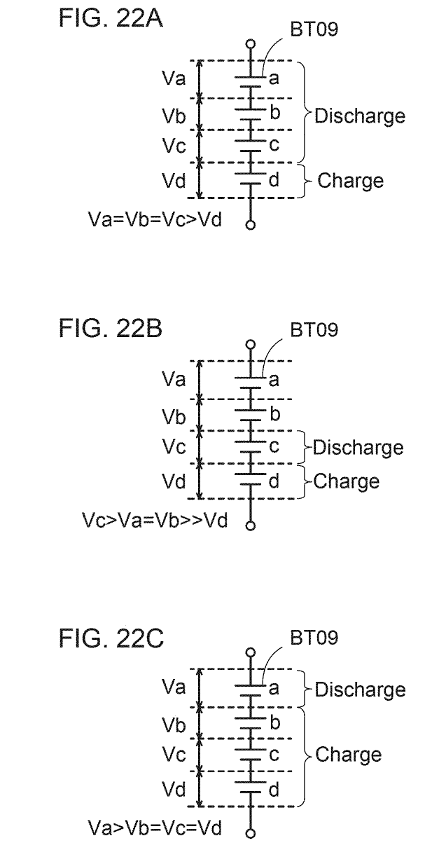

Here, operation examples of the switching control circuit BT03 in this embodiment will be described with reference to FIG. 22. FIG. 22 illustrates the operation examples of thee switching control circuit BT03. Note that FIG. 22 illustrates the case where four battery cells BT09 are connected in series as an example for convenience of explanation.

First, FIG. 22(A) shows the cases where the relation of Va=Vb=Vc>Vd holds where the voltages Va to Vd are the voltages of battery cells a to d. That is, a series of three high-voltage cells a to c and one low-voltage cell d are connected in series. In this case, the switching control circuit BT03 selects the series of three high-voltage cells a to c as the discharge battery cell group. In addition, the switching control circuit BT03 selects the low-voltage cell D as the charge battery cell group.

Net, FIG. 22(B) shows the case where the relation Vc>Vb=Vc>>Vd holds. That is, a series of two low-voltage cells a and b, one high-voltage cell c, and one low-voltage cell d which is almost over-discharged are connected in series. In this case, the switching control circuit BT03 selects the high-voltage cell c as the discharge battery cell group. Since the low-voltage cell d is almost over-discharged, the switching control circuit BT03 preferentially selects the low-voltage cell d as the charge battery cell group instead of the series of two low-voltage cells a and b.

Lastly, FIG. 22(C) shows the case where the relation Va>Vb=Vc=Vd holds. That is, one high-voltage cell a and a series of three low-voltage cells b to d are connected in series. In this case, the switching control circuit BT03 selects the high-voltage cell a as the discharge battery cell group. In addition, the switching control circuit BT03 selects the series of three low-voltage cells b to d as the charge battery cell group.

On the basis of the determination result shown in the examples of FIGS. 22(A) to (C), the switching control circuit BT03 outputs the control signal S1 and the control signal S2 to the switching circuit BT04 and the switching circuit BT05, respectively. Information showing the discharge battery cell group, which is the connection destination of the switching circuit BT04, is set in the control signal S1. Information showing the charge battery cell group, which is the connection destination of the switching circuit BT05, is set in the control signal S2.

The above is the detailed description of the operations of the switching control circuit BT03.

The switching circuit BT04 sets the connection destination of the terminal pair BT01 at the discharge battery cell group selected by the switching control circuit BT03, in response to the control signal S1 output from the switching control circuit BT03.

The terminal pair BT01 includes a pair of terminals A1 and A2. The switching circuit BT04 connects one of the pair of terminals A1 and A2 to a positive electrode terminal of the battery cell BT09 positioned on the most upstream side (on the high potential side) of the discharge battery cell group, and the other to a negative electrode terminal of the battery cell BT09 positioned on the most downstream side (on the low potential side) of the discharge battery cell group. Note that the switching circuit BT04 can recognize the position of the discharge battery cell group on the basis of the information set in the control signal S1.

The switching circuit BT05 sets the connection destination of the terminal pair BT02 at the charge battery cell group selected by the switching control circuit BT03, in response to the control signal S2 output from the switching control circuit BT03.

The terminal pair BT02 consists of a pair of terminals B1 and B2. The switching circuit BT05 sets the connection destination of the terminal pair BT02 by connecting one of the pair of terminals B1 and B2 to a positive electrode terminal of the battery cell BT09 positioned on the most upstream side (on the high potential side) of the charge battery cell group, and the other to a negative electrode terminal of the battery cell BT09 positioned on the most downstream side (on the low potential side) of the charge battery cell group. Note that the switching circuit BT05 can recognize the position of the charge battery cell group on the basis of the information set in the control signal S2.

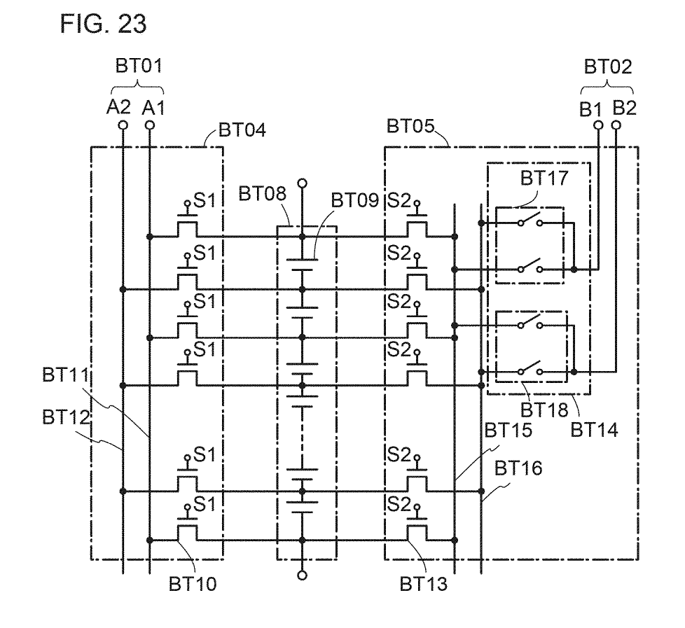

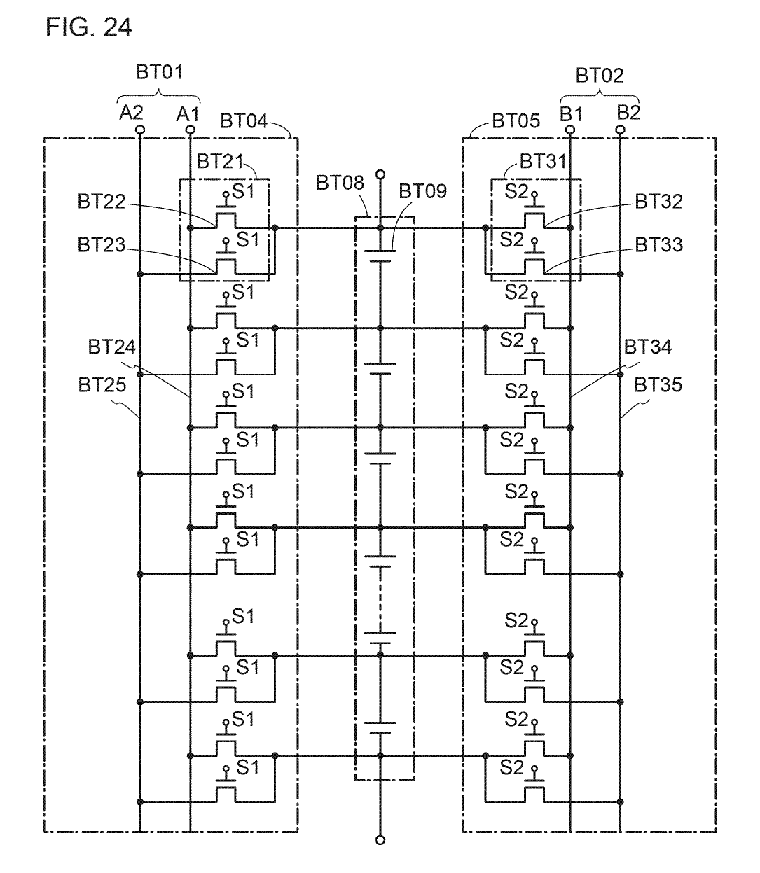

FIG. 23 and FIG. 24 are circuit diagrams showing configuration examples of the switching circuit BT04 and the switching circuit BT05.

In FIG. 23, the switching circuit BT04 includes a plurality of transistors BT10, a bus BT11, and a bus BT12. The bus BT11 is connected to the terminal A1. The bus BT12 is connected to the terminal A2. Either sources or drains of the plurality of transistors BT10 are connected alternately to the bus BT11 and the bus BT12. The other of the sources of the drains of the plurality of transistors BT10 are each connected between two adjacent battery cells BT09.

The other of the source or the drain of the transistor BT10 positioned on the most upstream side of the plurality of transistors BT10 is connected to the positive electrode terminal of the battery cell BT09 positioned on the most upstream side of the battery portion BT08. The other side of the source or the drain of the transistor BT10 positioned on the most downstream side of the plurality of transistors BT10 is connected to the negative electrode terminal of the battery cell BT09 positioned on the most downstream side of the battery portion BT08.

The switching circuit BT04 connects the discharge battery cell group to the terminal pair BT01 by bringing one of the plurality of transistors BT10 which are connected to the bus BT11 and one of the plurality of transistors BT10 which are connected to the bus BT12 into an on state in response to the control signal S1 supplied to gates of the plurality of transistors BT10. Accordingly, the positive electrode terminal of the battery cell BT09 positioned on the most upstream side of the discharge battery cell group is connected to one of the terminals A1 and A2 of the terminal pair. In addition, the negative electrode terminal of the battery cell BT09 positioned on the most downstream side of the discharge battery cell group is connected to the other of the terminals A1 and A2 of the terminal pair (i.e., a terminal which is not connected to the positive electrode terminal).

An OS transistor is preferably used as the transistor BT10. Since the off-state current of the OS transistor is low, the amount of charge that leaks from the battery cell which does not belong to the discharge battery cell group can be reduced, and reduction in capacity with the lapse of time can be suppressed. In addition, dielectric breakdown is unlikely to occur in the OS transistor when a high voltage is applied. Therefore, the battery cell BT09 and the terminal pair BT01, which are connected to the transistor BT10 in an off state, can be insulated from each other even when the output voltage of the discharge battery cell group is high.

In FIG. 23, the switching circuit BT05 includes a plurality of transistors BT13, a current control switch BT14, a bus BT15, and a bus BT16. The buses BT15 and BT16 are provided between the plurality of transistors BT13 and the current control switch BT14. Either sources or drains of the plurality of transistors BT13 are connected alternately to the buses BT15 and BT16. The other of the sources or the drains of the plurality of transistors BT13 are each connected between two adjacent battery cells BT09.

The other of the source or the drain of the transistor BT13 positioned on the most upstream side of the plurality of transistors BT13 is connected to the positive electrode terminal of the battery cell BT09 positioned on the most upstream side of the battery portion BT08. The other of the source or the drain of the transistor BT13 positioned on the most downstream side of the plurality of transistors BT13 is connected to the negative electrode terminal of the battery cell BT09 positioned on the most downstream side of the battery portion BT08.

An OS transistor is preferably used as the transistors BT13 like the transistors BT10. Since the off-state current of the OS transistor is low, the amount of charge that leaks from the battery cells which do not belong to the charge battery cell group can be reduced, and reduction in capacity with the lapse of time can be suppressed. In addition, dielectric breakdown is unlikely to occur in the OS transistor when a high voltage is applied. Therefore, the battery cell BT09 and the terminal pair BT02, which are connected to the transistor BT13 in an off state, can be insulated from each other even when a voltage for charging the charge battery cell group is high.

The current control switch BT14 includes a switch pair BT17 and a switch pair BT18. One end of the switch pair BT17 is connected to the terminal B1. The other end of the switch pair BT17 branches off by two switches. One switch is connected to the bus BT15, and the other switch is connected to the bus BT16. One end of the switch pair BT18 is connected to the terminal B2. The other end of the switch pair BT18 branches off by two switches. One switch is connected to the bus BT15, and the other switch is connected to the bus BT16.

OS transistors are preferably used for the switches included in the switch pair BT17 and the switch pair BT18 like the transistors BT10 and BT13.

The switching circuit BT05 connects the charge battery cell group and the terminal pair BT02 by controlling the combination of on/off states of the transistors BT13 and the current control switch BT14 in response to the control signal S2.

For example, the switching circuit BT05 connects the charge battery cell group and the terminal pair BT02 in the following manner.

The switching circuit BT05 brings a transistor BT13 connected to the positive electrode terminal of the battery cell BT09 on the most upstream side of the charge battery cell group into an on state in response to the control signal S2 supplied to gates of the plurality of transistors BT10. In addition, the switching circuit BT05 brings a switching switch 151 connected to the negative electrode terminal of the battery cell BT09 on the most downstream side of the charge battery cell group into an on state in response to the control signal S2 supplied to the gates of the plurality of transistors BT10.

The polarities of voltages applied to the terminal pair BT02 can vary in accordance with the configurations of the voltage transformer circuit BT07 and the discharge battery cell group connected to the terminal pair BT01. In order to let a current flow in the direction for charging the charge battery cell group, terminals with the same polarity of the terminal pair BT02 and the charge battery cell group are required to be connected to each other. In view of this, the current control switch 152 is controlled by the control signal S2 so that the connection destinations of the switch pair BT17 and the switch pair BT18 can each be changed in accordance with the polarities of the voltages applied to the terminal pair BT02.

The state were voltages are applied to the terminal pair BT02 so as to make the terminal B1 a positive electrode and the terminal B2 a negative electrode will be described as an example. Here, in the case where the battery cell BT09 positioned on the most downstream side of the battery portion BT08 is in the charge battery cell group, the switch pair BT17 is controlled to be connected to the positive electrode terminal of the battery cell BT09 in response to the control signal S2. That is, the switch of the switch pair BT17 connected to the bus BT16 is turned on, and the switch of the switch pair BT17 connected to the bus BT15 is turned off. In contrast, the switch pair BT18 is controlled to be connected to the negative electrode terminal of the battery cell BT09 in response to the control signal S2. That is, the switch of the switch pair BT18 connected to the bus BT15 is turned on, and the switch of the switch pair BT18 connected to the bus BT16 is turned off. In this manner, terminals with the same polarity of the terminal pair BT02 and the charge battery cell group are connected to each other. In addition, the direction of the current which flows from the terminal pair BT02 is controlled to be a direction for charging the charge battery cell group.

In addition, instead of the switching circuit BT05, the switching circuit BT04 may include the current control switch 152. In that case, the polarities of the voltages applied to the terminal pair BT02 are controlled by controlling the polarities of the voltages applied to the terminal pair BT01 in response to the control signal S1. Thus, the current control switch BT14 controls the direction of current which flows to the charge battery cell group from the terminal pair BT02.

FIG. 24 is a circuit diagram illustrating a configuration example of the switching circuit BT04 and the switching circuit BT04 which is different from that of FIG. 23.

In FIG. 24, the switching circuit BT04 includes a plurality of transistor pairs BT21, a bus BT24, and a bus BT25. The bus BT24 is connected to the terminal A1. The bus BT25 is connected to the terminal A2. One end of the plurality of transistor pairs BT21 branches off by a transistor BT22 and a transistor BT23. Either sources or drains of the transistors BT22 are connected to the bus BT24. Furthermore, either sources or drains of the transistors BT23 are connected to the bus BT25. In addition, the other end of each of the plurality of transistor pairs is connected between two adjacent battery cells BT09. The other end of the transistor pair BT21 positioned on the most upstream side of the plurality of transistor pairs BT21 is connected to the positive electrode terminal of the battery cell BT09 positioned on the most upstream side of the battery portion BT08. The other end of the transistor pair BT21 positioned on the most downstream side of the plurality of transistor pairs BT21 is connected to a negative electrode terminal of the battery cell BT09 positioned on the most downstream side of the battery portion BT08.

The switching circuit BT04 switches the connection destination of the transistor pair BT21 to one of the terminal A1 and the terminal A2 by turning on or off the transistor BT22 and the transistor BT23 in response to the control signal S1. Specifically, when the transistor BT22 is turned on, the transistor BT23 is turned off, so that the connection destination of the transistor pair BT21 is the terminal A1. On the other hand, when the transistor BT23 is turned on, the transistor BT22 is turned off, so that the connection destination of the transistor pair BT21 is the terminal A2. Which of the transistors BT22 and BT23 is turned on is determined by the control signal S1.

Two transistor pairs BT21 are used to connect the terminal pair BT01 and the discharge battery cell group. Specifically, the connection destinations of the two transistor pairs BT21 are determined on the basis of the control signal S1, and the discharge battery cell group and the terminal pair BT01 are connected. The connection destinations of the two transistor pairs BT21 are controlled by the control signal S1 so that one of the connection destinations is the terminal A1 and the other is the terminal A2.

The switching circuit BT05 includes a plurality of transistor pairs BT31, a bus BT34, and a bus BT35. The bus BT34 is connected to the terminal B1. The bus BT35 is connected to the terminal B2. One end of each of the plurality of transistor pairs BT31 branches off by a transistor BT32 and a transistor BT33. One end of the branch from the transistor BT32 is connected to the bus BT34. One end of the branch from the transistor BT33 is connected to the bus BT35. The other end of each of the plurality of transistor pairs BT31 is connected between two adjacent battery cells BT09. The other end of the switching switch pair 154 positioned on the mot upstream side of the plurality of switching switch pairs 154 is connected to the positive electrode terminal of the battery cell BT09 positioned on the most upstream side of the battery portion BT08. The other end of the transistor pair BT31 positioned on the most downstream side of the plurality of transistor pairs BT31 is connected to the negative electrode terminal of the battery cell BT09 positioned on the most downstream side of the battery portion BT08.

The switching circuit BT05 switches the connection destination of the transistor pair BT31 to one of the terminal B1 and the terminal B2 by turning on or off the transistor BT32 and the transistor BT33 in response to the control signal S2. Specifically, when the transistor BT32 is turned on, the transistor BT33 is turned off, so that the connection destination of the transistor pair BT31 is the terminal B1. On the other hand, when the transistor BT33 is turned on, the transistor BT32 is turned off, so that the connection destination of the transistor pair BT31 is the terminal B2. Which of the transistors BT32 and BT33 is turned on is determined by the control signal S2.

Two transistor pairs BT31 are used to connect the terminal pair BT02 and the charge battery cell group. Specifically, the connection destinations of the two transistor pairs BT31 are each determined on the basis of the control signal S2, and the charge battery cell group and the terminal pair BT02 are connected. The connection destinations of the two transistor pairs BT31 are controlled by the control signal S2 so that one of the connection destinations is the terminal B1 and the other is the terminal B2.

The connection destinations of the two transistor pairs BT31 are each determined by the polarities of the voltages applied to the terminal pair BT02. Specifically, in the case where voltages which make the terminal B1 a positive electrode and the terminal B2 a negative electrode are applied to the terminal pair BT02, the transistor pair BT31 on the upstream side is controlled by the control signal S2 so that the transistor BT32 is turned on and the transistor BT33 is turned off. In contrast, the transistor pair BT31 on the downstream side is controlled by the control signal S2 so that the transistor BT33 is turned on and the transistor BT32 is turned off. In the case where voltages which make the terminal B1 a negative electrode and the terminal B2 a positive electrode are applied to the terminal pair BT02, the transistor pair BT31 on the upstream side is controlled by the control signal S2 so that the transistor BT33 is turned on and the transistor BT32 is turned off. In contrast, the transistor pair BT31 on the downstream side is controlled by the control signal S2 so that the transistor BT32 is turned on and the transistor BT33 is turned off. In this manner, terminals with the same polarity of the terminal pair BT02 and the charge battery cell group are connected to each other. In addition, the direction of the current which flows from the terminal pair BT02 is controlled to be the direction for charging the charge battery cell group.

The voltage transformation control circuit BT06 controls the operation of the voltage transformer circuit BT07. The voltage transformation control circuit BT06 generates a voltage transformation signal S3 for controlling the operation of the voltage tranformer circuit BT07 on the basis of the number of the battery cells BT09 included in the discharge battery cell group and the number of the battery cells BT09 included in the charge battery cell group and outputs the voltage transformation signal S3 to the voltage transformer circuit BT07.

In the case where the number of battery cells BT09 included in the discharge battery cell group is larger than that included in the charge battery cell group, it is necessary to prevent a charging voltage which is too high from being applied to the charge battery cell group. Thus, the voltage transformation control circuit BT06 outputs the voltage transformation signal S3 for controlling the voltage transformer circuit BT07 so that a discharging voltage (Vdis) is lowered within a range where the charge battery cell group can be charged.

In the case where the number of battery cells BT09 included in the discharge battery cell group is less than or equal to that included in the charge battery cell group, a charging voltage necessary for charging the charge battery cell group needs to be ensured. Therefore, the voltage transformation control circuit BT06 outputs the voltage transformation signal S3 for controlling the voltage transformer circuit BT07 so that the discharging voltage (Vdis) is raised within a range where a charging voltage which is too high is not applied to the charge battery cell group.

The voltage value of the charging voltage which is too high can be determined in the light of product specifications and the like of the battery cell BT09 used in the battery portion BT08. The voltage which is raised or lowered by the voltage transformer circuit BT07 is applied as a charging voltage (Vcha) to the terminal pair BT02.

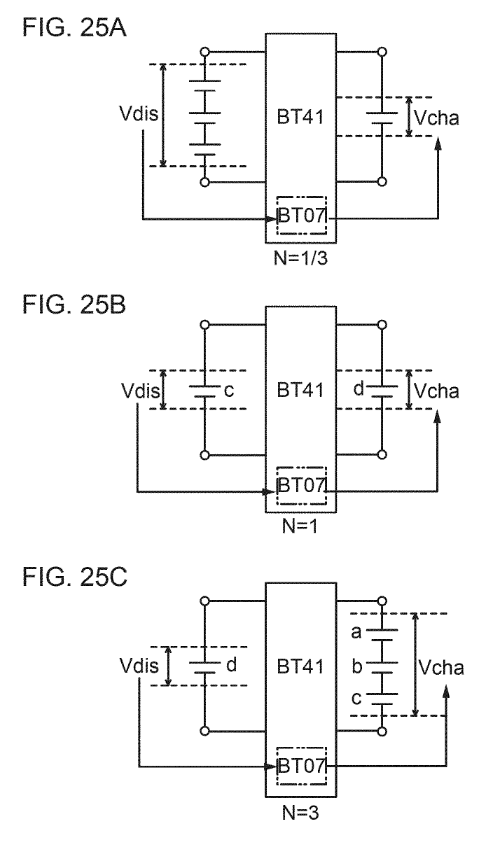

Here, operation examples of the voltage transformation control circuit BT06 in this embodiment will be described with reference to FIGS. 25(A) to 25(C). FIGS. 25(A) to (C) are conceptual diagrams for explaining the operation examples of the voltage transformation control circuits BT06 for the discharge battery cell groups and the charge battery cell groups described in FIGS. 22(A) to (C). FIGS. 25(A) to (C) each illustrate a battery management unit BT41. As described above, the battery management unit BT41 includes the terminal pair BT01, the terminal pair BT02, the switching control circuit BT03, the switching circuit BT04, the switching circuit BT05, the voltage transformation control circuit BT06, and the voltage transformer circuit BT07.

In an example illustrated in FIG. 25(A), the series of three high-voltage cells a to c and one low-voltage cell d are connected in series as described in FIG. 22(A). In this case, as described using FIG. 22(A), the switching control circuit BT03 determines the high-voltage cells a to c as the discharge battery cell group, and determines the low-voltage cell d as the charge battery cell group. The voltage transformation control circuit BT06 calculates a ratio N for raising or lowering voltage of the discharging voltage (Vdis) based on the ratio of the number of battery cells BT09 included in the charge battery cell group to the number of battery cells BT09 included in the discharge battery cell group.

In the case where the number of battery cells BT09 included in the discharge battery cell group is larger than that included in the charge battery cell group, when a discharging voltage is applied to the terminal pair BT02 as it is without transformation of the voltage, an overvoltage may be applied to the battery cells BT09 included in the charge battery cell group through the terminal pair BT02. Thus, in the case of FIG. 25(A), it is necessary that a charging voltage (Vcha) applied to the terminal pair BT02 be lower than the discharging voltage. In addition, in order to charge the charge battery cell group, it is necessary that the charging voltage be higher than the total voltage of the battery cells BT09 included in the charge battery cell group. Thus, the voltage transformation control circuit BT06 sets the ratio N for raising or lowering voltage larger than the ratio of the number of battery cells BT09 included in the charge battery cell group to the number of battery cells BT09 included in the discharge battery cell group.

Thus, the voltage transformation control circuit BT06 preferably sets the ratio N for raising or lowering voltage larger than the ratio of the number of battery cells BT09 included in the charge battery cell group to the number of battery cells BT09 included in the discharge battery cell group by about 1% to 10%. Here, the charging voltage is made higher than the voltage of the charge battery cell group, but the actual charging voltage is equal to the voltage of the charge battery cell group. Note that the voltage transformation control circuit BT06 feeds a current for charging the charge battery cell group in accordance with the ratio N for raising or lowering voltage in order to make the voltage of the charge battery cell group equal to the charging voltage. the value of the current is set by the voltage transformation control circuit BT06.

In the example illustrated in FIG. 25(A), since the number of battery cells BT09 included in the discharge battery cell group is three and the number of battery cells BT09 included in the charge battery cell group is one, the voltage transformation control circuit BT06 calculates the ratio N for raising or lowering voltage at a value which is slightly larger than ⅓. Then, the voltage transformation control circuit BT06 outputs the voltage transformation signal S3, which lowers the discharging voltage in accordance with the ration N for raising or lowering voltage and converts the voltage into charging voltage, to the voltage transformer circuit BT07. The voltage transformer circuit BT07 applies the charging voltage which is obtained by transformation in response to the voltage transformation signal S3 to the terminal pair BT02. Then, the battery cells BT09 included in the charge battery cell group are charged with the charging voltage applied to the terminal pair BT02.

In each of examples illustrated in FIG. 25(B) and FIG. 25(B), the ratio N for raising or lowering voltage is calculated in a manner similar to that of FIG. 25(A). In each of the examples illustrated in FIG. 25(B) and FIG. 25(C), since the number of battery cells BT09 included in the discharge battery cell group is less than or equal to the number of battery cells BT09 included in the charge battery cell group, the ratio N for raising or lowering voltage is 1 or more. Therefore, in this case, the voltage transformation control circuit BT06 outputs the voltage transformation signal S3 for raising the discharging voltage and converting the voltage into the charging voltage.

The voltage transformer circuit BT07 converts the discharging voltage applied to the terminal pair BT01 into a charging voltage in response to the voltage transformation signal S3. The voltage transformer circuit BT07 applies the charging voltage to the terminal pair BT02. Here, the voltage transformer circuit BT07 electrically insulates the terminal pair BT01 from the terminal pair BT02. Accordingly, the voltage transformer circuit BT07 prevents a short circuit due to a difference between the absolute voltage of the negative electrode terminal of the battery cell BT09 positioned on the most downstream side of the discharge battery cell group and the absolute voltage of the negative electrode terminal of the battery cell BT09 positioned on the most downstream side of the charge battery cell group. Furthermore, the voltage transformer circuit BT07 converts the discharging voltage, which is the total voltage of the discharge battery cell group, into the charging voltage in response to the voltage transformation signal S3 as described above.

An insulated DC (Direct Current)-DC converter or the like can be used in the voltage transformer circuit BT07, for example. In that case, the voltage transformation control circuit BT06 controls the charging voltage converted by the voltage transformer circuit BT07 by outputting a signal for controlling the on/off ratio (the duty ratio) of the insulated DC-DC converter as the voltage transformation signal S3.

Examples of the insulated DC-DC converter include a flyback converter, a forward converter, an RCC (Ringing Choke Converter), a push-pull converter, a half-bridge converter, and a full-bridge converter, and a suitable converter is selected in accordance with the value of the intended output voltage.

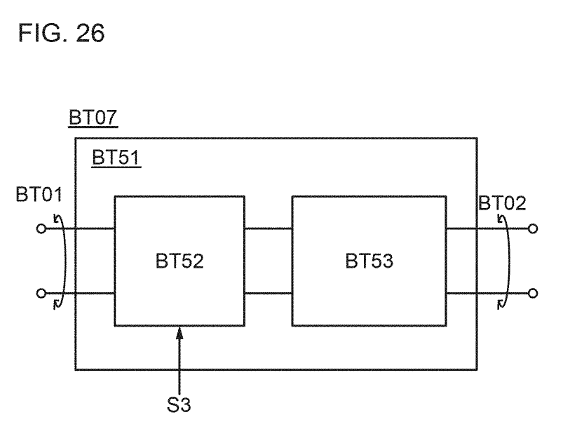

The configuration of the voltage transformer circuit BT07 including the insulated DC-DC converter is illustrated in FIG. 26. An insulated DC-DC converter BT51 includes switch portion BT52 and a transformer BT53. The switch portion BT52 is a switch for switching on/off of the insulated DC-DC converter, and a MOSFET (Metal-Oxide-Semiconductor Field-Effect Transistor, a bipolar transistor, or the like is used as the switch portion BT52, for example. The switch portion BT52 periodically turns on and off the insulated DC-DC converter BT51 in response to the voltage transformation signal S3 for controlling the on/off ratio which is output from the voltage transformation control circuit BT06. The switch portion BT52 can have any of various structures in accordance with the type of the insulated DC-DC converter which is used. The transformer BT53 converts the discharging voltage applied from the terminal pair BT01 into the charging voltage. In detail, the transformer BT53 operates in synchronization with the on/off state of the switch portion BT52 and converts the discharging voltage into the charging voltage in accordance with the on /off ratio. As the time during which the switch portion BT52 is on becomes longer in a switching period, the charging voltage is increased. On the other hand, as the time during which the switch portion BT52 is on becomes shorter in a switching period, the charging voltage is decreased. In the case where the insulated DC-DC converter is used, the terminal pair BT01 and the terminal pair BT02 can be insulated from each other inside the transformer BT53.

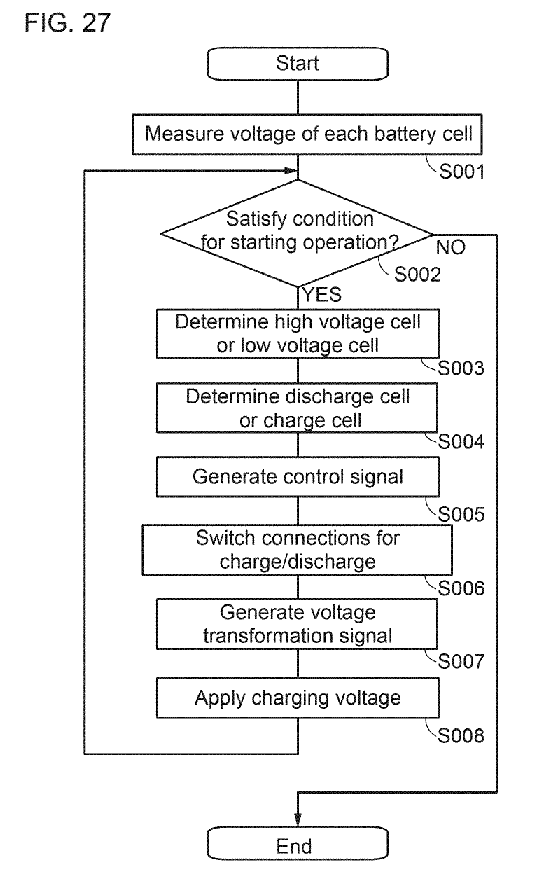

A flow of operations of the power storage device BT00 in this embodiment will be described with reference to FIG. 27. FIG. 27 is a flow chart showing the flow of the operations of the power storage device BT00.

First, the power storage device BT00 obtains a voltage measured for each of the plurality of battery cells BT09 (step S001). Then, the power storage device BT00 determines whether or not the condition for starting the operation of reducing variations in voltage of the plurality of battery cells BT09 is satisfied (step S002). For example, the condition that the difference between the maximum value and the minimum value of the voltage measured for each of the plurality of battery cells BT09 is higher than or equal to the predetermined threshold value can be used. In the case where the condition is not satisfied (step S002: NO), the power storage device BT00 does not perform the following operation because voltages of the battery cells BT09 are well balanced. In contrast, in the case where the starting condition is satisfied (step S002: YES), the power storage device BT00 performs the operation of reducing variations in the voltage of the battery cells BT09. In this operation, the power storage device BT00 determines whether each battery cell BT09 is a high voltage cell or a low voltage cell on the basis of the measured voltage of each cell (step S003). Then, the power storage device BT00 determines a discharge battery cell group and a charge battery cell group on the basis of the determination result (step S004). In addition, the power storage device BT00 generates the control signal S1 for setting the connection destination of the terminal pair BT01 to the determined discharge battery cell group, and the control signal S2 for setting the connection destination of the terminal pair BT02 to the determined charge battery cell group (step S005). The power storage device BT00 outputs the generated control signals S1 and S2 to the switching circuit BT04 and the switching circuit BT05, respectively. Then, the switching circuit BT04 connects the terminal pair BT01 and the discharge battery cell group, and the switching circuit BT05 connects the terminal pair BT02 and the discharge battery cell group (step S006). The power storage device BT00 generates the voltage transformation signal S3 based on the number of battery cells BT09 included in the discharge battery cell group and the number of battery cells BT09 included in the charge battery cell group (step S007). Then, the power storage device BT00 converts, in response to the voltage transformation signal S3, the discharging voltage applied to the terminal pair BT01 into a charging voltage and applies the charging voltage to the terminal pair BT02 (step S008). In this way, charge of the discharge battery cell group is transferred to the charge battery cell group.

Although the plurality of steps are shown in order in the flow chart of FIG. 27, the order of performing the steps is not limited to the shown order.

According to the above embodiment, when charge is transferred from the discharge battery cell group to the charge battery cell group, a structure where charge from the discharge battery cell group is temporarily stored, and the stored charge is sent to the charge battery cell group is unnecessary, unlike in the a capacitive type circuit. Accordingly, the charge transfer efficiency per unit time can be increased. In addition, the discharge battery cell group and the charge battery cell group are separately switched by the switching circuit BT04 and the switching circuit BT05.

Furthermore, the voltage transformer circuit BT07 converts the discharging voltage applied to the terminal pair BT01 into the charging voltage based on the number of battery cells BT09 included in the discharge battery cell group and the number of battery cells BT09 included in the charge battery cell group, and applies the charging voltage to the terminal pair BT02. Thus, charge can be transferred without any problems regardless of how the battery cells BT09 are selected as the discharge battery cell group and the charge battery cell group.

Furthermore, the use of OS transistors as the transistor BT10 and the transistor BT13 can reduce the amount of charge that leaks from the battery cells BT09 not belonging to the charge battery cell group or the discharge battery cell group. Accordingly, a decrease in the capacity of the battery cells BT09 which do not contribute to charging or discharging can be suppressed. In addition, the variations in characteristics of the OS transistor due to heat are smaller than those of an Si transistor. Accordingly, even when the temperature of the battery cells BT09 is increased, an operation such as switching between an on state and an off state in response to the control signals S1 and S2 can be performed normally.

### Embodiment 6

In this embodiment, an example of an electronic device which includes the secondary battery including the negative electrode described in the above embodiment will be described.

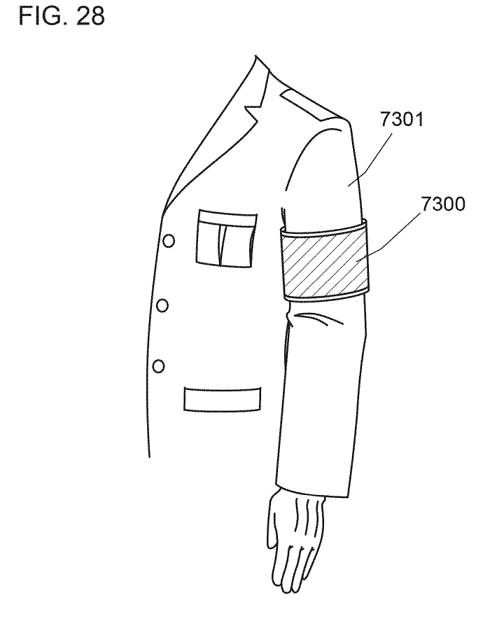

FIG. 28 illustrates an example of an armband electronic device including a flexible secondary battery. An armband device 7300 illustrated in FIG. 28 can be worn on an arm 7301 and includes a display portion having a curved surface and a bendable secondary battery.

Note that in the display portion, a display element, a display device which is a device including a display element, a light-emitting element, and a light-emitting device which is a device including a light-emitting element an employ a variety of modes or can include a variety of elements. The display element, the display device, the light-emitting element, or the light-emitting device includes at least one of an electroluminescent (EL) element (e.g., an EL element including organic and inorganic materials, an organic EL element, or an inorganic EL element), an LED (e.g., a white LED, a red LED, a green LED, or a blue LED), a transistor (a transistor that emits light depending on current), an electron emitter, a liquid crystal element, electronic ink, an electrophoretic element, a grating light valve (GLV), a plasma display (PDP), a display element using micro electro mechanical systems (MEMS), a digital micromirror device (DMD), a digital micro shutter (DMS), MIRASOL (registered trademark), an IMOD (interferometric modulation) element a MEMS shutter display element, an optical-interference-type MEMS display element, an electrowetting element, a piezoelectric ceramic display, a display element including a carbon nanotube, and the like. In addition to that, the display element, the display device, the light-emitting element, or the light-emitting device may include a display medium whose contrast, luminance, reflectivity, transmittance, or the like is changed by electrical or magnetic effect. Examples of a display device having an EL element include an EL display. Display devices having electron emitters include a field emission display (FED), an SED-type flat panel display (SED: surface-conduction electron-emitter display), and the like. Examples of a display device including a liquid crystal element include a liquid crystal display (e.g., a transmissive liquid crystal display, a transflective liquid crystal display, a reflective liquid crystal display, a direct-view liquid crystal display, or a projection liquid crystal display). Examples of a display device including electronic ink, electronic liquid powder (registered trademark), or electrophoretic elements include electronic paper. In the case of a transflective liquid crystal display or a reflective liquid crystal display, some or all of pixel electrodes function as reflective electrodes. For example, some or all of pixel electrodes are formed to contain aluminum, silver, or the like. In such a case, a memory circuit such as an SRAM can be provided under the reflective electrodes, leading to lower power consumption. Note that in the case of using an LED, graphene or graphite may be provided under an electrode or a nitride semiconductor of the LED. Graphene or graphite may be a multilayer film in which a plurality of layers are stacked. When graphene or graphite is provided in this manner, a nitride semiconductor, for example, an n-type GaN semiconductor layer including crystals can be easily formed thereover. Furthermore, a p-type GaN semiconductor layer including crystals or the like can be provided thereover, and thus the LED can be formed. Note that an AlN layer may be provided between the n-type GaN semiconductor layer including crystals and graphene or graphite. The GaN semiconductor layers included in the LED may be formed by MOCVD. Note that when the graphene is provided, the GaN semiconductor layers included in the LED can also be formed by a sputtering method.

The armband device 7300 preferably further includes one or more functional elements. For example, as a sensor, an element having a function of measuring force, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays can be used. The armband device 7300 may include a functional element such as a touch panel, an antenna, a power generation element, or a speaker.

For example, when a user wears the armband device 7300 on his or her arm and makes its display portion emit light at nighttime, traffic safety can be ensured. For another example, when a soldier, a security guard, or the like wears the armband device 7300 on an upper arm, he or she can check a chief's command, which is received in real time and displayed on a display portion of the novel device on the upper arm, while creeping. It is difficult for a soldier or a security guard to use a wireless device, a mobile phone, or a head-mounted device because he or she wears a helmet and has weapons or tools with both hands in executing his or her duties. Thus, it is useful that a soldier or a security guard can wear the novel device on his or her upper arm and operate it by, for example, voice input to an audio input portion such as a microphone even when his or her hands are full.

The armband device 7300 can also be effectively used in the field of sports. For example, it is difficult for a marathoner to check the time on his or her watch without stopping swinging his or her arms. Stopping swinging his or her arms might disturb his or her rhythm, obstructing his or her run. However, wearing the armband device 7300 on his or her upper arm enables him or her to check the time without stopping swinging of his or her arm. Furthermore, it can display other information (e.g., his or her position in a course or his or her health condition) on its display screen. It is more useful that it further has a function that allows an athlete to operate the novel device by voice input or the like without using both hands, seek instructions from his or her coach by a communication function, and listen the directions output by voice output from an audio output portion such as a speaker or view the instructions displayed on its display screen.

For another example, when a construction crew or the like who wears a helmet wears the armband device 7300 and operates it, he or she can exchange information by communication to easily obtain the positional information of other crews so that he or she can work safely.

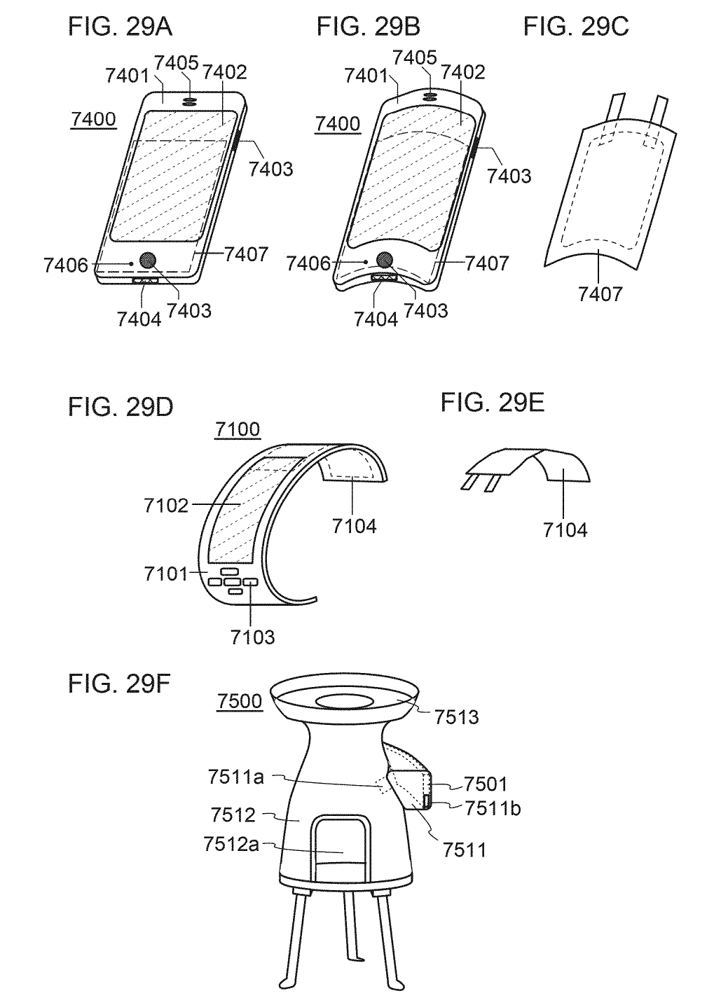

Examples of other electronic devices including flexible secondary batteries are illustrated in FIG. 29. Examples of an electronic device including a flexible secondary battery include television sets (also referred to as televisions or television receivers), monitors of computers or the like, cameras such as digital cameras or digital video cameras, digital photo frames, mobile phones (also referred to as cellular phones or mobile phone devices), portable game machines, portable information terminals, audio reproducing devices, and large game machines such as pachinko machines.

In addition, a flexible secondary battery can be incorporated along a curved inside/outside wall surface of a house or a building or a curved interior/exterior surface of an automobile.

FIG. 29(A) illustrates an example of a mobile phone. A mobile phone 7400 is provided with a display portion 7402 incorporated in a housing 7401, an operation button 7403, an external connection port 7404, a speaker 7405, a microphone 7406, and the like. Note that the mobile phone 7400 includes a secondary battery 7407.

FIG. 29(B) illustrates the mobile phone 7400 in a curved state. When the whole mobile phone 7400 is curved by external force, the secondary battery 7407 included in the mobile phone 7400 is also curved. FIG. 29(C) illustrates the state in which the secondary battery 7407 is bent. The secondary battery 7407 is a thin secondary battery. The secondary battery 7407 is fixed in the bent state. Note that the secondary battery 7407 includes a lead electrode 7408 electrically connected to a current collector 7409. The current collector 7409 is, for example, copper foil, and partly alloyed with gallium so as to improve the adhesion between the current collector 7409 and an active material layer in contact with the current collector 7409. Consequently, the secondary battery 7407 can have high reliability in the c state of being bent.

FIG. 29(D) illustrates an example of a bangle display device. A portable display device 7100 includes a housing 7101, a display portion 7102, an operation button 7103, and a secondary battery 7104. FIG. 29(E) illustrates the bent secondary battery 7104. When the bent secondary battery 7104 is on a user's arm, the housing changes its form and the curvature of a part or the whole of the secondary battery 704 is changed. Note that the radius of curvature of a curve at a point refers to the radius of the circular arc that best approximates the curve at that point. The reciprocal of the radius of curvature is curvature. Specifically, part or the whole of the housing or the main surface of the secondary battery 7104 is changed in the range of radius of curvature from 40 mm to 150 mm. When the radius of curvature at the main surface of the secondary battery 7104 is greater than or equal to 40 mm and les than or equal to 150 mm, the reliability can be kept high.

A secondary battery that can be curved can be provided with high space efficiency in a variety of electronic devices. For example, in a stove 7500 illustrated in FIG. 29(F), a module 7511 is attached to a main body 7512. The module 7511 includes the secondary battery 7501, a motor, a fan, an air outlet 7511a, and a thermoelectric generation device. In the stove 7510, after a fuel is injected through an opening 7512a and ignited, outside air can be sent through the air outlet 7511a to the inside of the stove 7510 by rotating the motor and the fan which are included in the module 7511 using power of the secondary battery 7501. In this manner, the stove can have strong heating power because outside air can be taken into the inside of the stove efficiently. In addition, cooking can be performed on an upper grill 7513 with thermal energy generated by the combustion of fuel. Furthermore, the thermal energy can be converted into power with the thermoelectric generation device of the module 7511, and the secondary battery 7501 can be charged. Moreover, the power charged into the secondary battery 7501 can be output through an external terminal 7511b.

This embodiment can be implemented in an appropriate combination with any of the other embodiments.

### Embodiment 7

In this embodiment, other examples of electronic devices that can include the secondary battery including the negative electrode described in the above embodiment will be described.

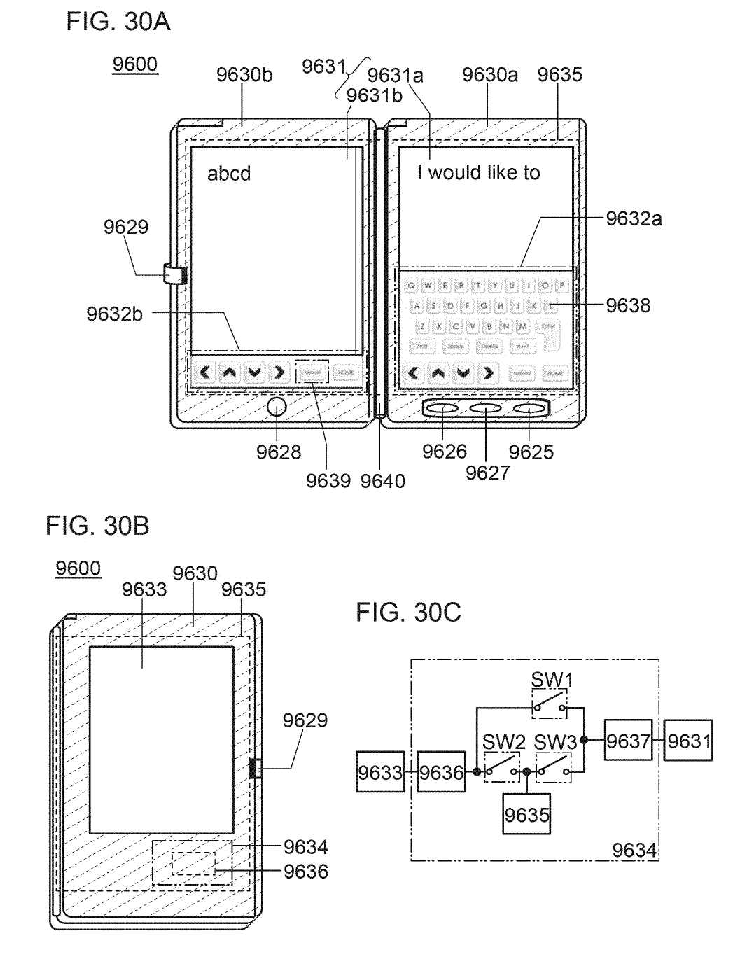

FIG. 30(A) and FIG. 30(B) illustrate an example of a tablet terminal that can be folded in half. A tablet terminal 9600 illustrated in FIG. 30(A) and FIG. 30(B) includes a housing 9630a, a housing 9630b, a movable portion 9640 connecting the housings 9630a and 9630b, a display portion 9631 including a display portion 9631a and a display portion 9631b, a display mode changing switch 9626, a power switch 9627, a power saving mode changing switch 9625, a fastener 9629, and an operation switch 9628. FIG. 30(A) illustrates the tablet terminal 9600 in an opened state, and FIG. 30(B) illustrates the tablet terminal 9600 in a closed state.

The tablet terminal 9600 includes a secondary battery 9635 inside the housings 9630a and 9630b. The secondary battery 9635 is provided across the housings 9630a and 9630b, passing through the movable portion 9640.

Part of the display portion 9631a can be a touch panel region 9632a, and data can be input by touching operation keys 9638 that are displayed. Note that although the structure in which half of the area of the display portion 9631a has only a display function and the other half of the area has a touch panel function, is illustrated as an example, the structure is not limited to this, and all the area of the display portion 9631a may have a touch panel function. For example, all the area of the display portion 9631a can display keyboard buttons and serve as a touch panel while the display portion 9631b can be used as a display screen.

As in the display portion 9631a, part of the display portion 9631b can be a touch panel region 9632b. When a keyboard display switching button 9639 displayed on the touch panel is touched with a finger a stylus, or the like, a keyboard can be displayed on the display portion 9631b.

Touch input can be performed in the touch panel region 9632a and the touch panel region 9632b at the same time.

The display mode changing switch 9626 allows switching between a landscape mode and a portrait mode, color display and black-and-white display, and the like. The power saving mode changing switch 9625 can control display luminance in accordance with the amount of external light in use of the tablet terminal 9600, which is measured with an optical sensor incorporated in the tablet terminal 9600. In addition to the optical sensor, other detecting devices such as sensors for determining inclination, such as a gyroscope or an acceleration sensor, may be incorporated in the tablet terminal.

Although an example in which the display portion 9631a and the display portion 9631b have the same display area is illustrated in FIG. 30(A) as an example, one embodiment of the present invention is not particularly limited to this example. The display portion 9631a and the display portion 9631b may have different sizes or different display qualities. For example, one of the display portions 9631a and 9631b may display higher definition images than the other.

The tablet terminal is closed in FIG. 30(B). The tablet terminal includes the housing 9630, a solar cell 9633, and a charge and discharge control circuit 9634 including a DC-DC converter 9636. The secondary battery of one embodiment of the present invention is used as the secondary battery 9635.

The tablet terminal 9600 can be folded in half such that the housings 9630a and 9630b overlap with each other when not in use. Thus, the display portions 9631a and 9631b can be protected, which increases the durability of the tablet terminal 9600. In addition, the secondary battery 9635 of one embodiment of the present invention has flexibility and can be repeatedly bent without a large decrease in charge and discharge capacity. Thus, a highly reliable tablet terminal can be provided.

The tablet terminal illustrated in FIG. 30(A) and FIG. 30(B) can also have a function of displaying various kinds of data (e.g., a still image, a moving image, and a text image), a function of displaying a calendar, a date, the time, or the like on the display portion, a touch-input function of operating or editing data displayed on the display portion by touch input, a function of controlling processing by various kinds of software (programs), and the like.

The solar cell 9633, which is attached on the surface of the tablet terminal, supplies electric power to a touch panel, a display portion, an image signal processor, and the like. Note that the solar cell 9633 can be provided on one or both surfaces of the housing 9630 and the secondary battery 9635 can be charged efficiently. The use of the secondary battery of one embodiment of the present invention as the secondary battery 9635 can inhibit a decrease in discharge capacity caused by repeated charge and discharge; thus a tablet terminal that can be used over a long period of time can be provided.

The structure and operation of the charge and discharge control circuit 9634 illustrated in FIG. 30(B) is described with reference to a block diagram of FIG. 30(C). The solar cell 9633, the secondary battery 9635, the DC-DC converter 9636, a converter 9637, switches SW1 to SW3, and the display portion 9631 are illustrated in FIG. 30(C), and the secondary battery 9635, the DC-DC converter 9636, the converter 9637, and the switches SW1 to SW3 correspond to the charge and discharge control circuit 9634 illustrated in FIG. 30(B).

First, an example of operation in the case where electric power is generated by the solar cell 9633 using external light will be described. The voltage of electric power generated by the solar cell is raised or lowered by the DC-DC converter 9636 to a voltage for charging the secondary battery 9635. When the display portion 9631 operates with the electric power from the solar cell 9633, the switch SW1 is turned on and the voltage of the electric power is raised or lowered by the converter 9637 to a voltage needed for operating the display portion 9631. When display on the display portion 9631 is not performed, the switch SW1 is turned off and the switch SW2 is turned on, so that the secondary battery 9635 can be charged.

Note that the solar cell 9633 is described as an example of a power generation means; however, one embodiment of the present invention is not limited to this example. The secondary battery 9635 may be charged using another power generation means such as a piezoelectric element or a thermoelectric conversion element (Peltier element). For example, the battery 9635 may be charged with a non-contact power transmission module capable of performing charging by transmitting and receiving electric power wirelessly (without contact), or any of the other charge means used in combination.

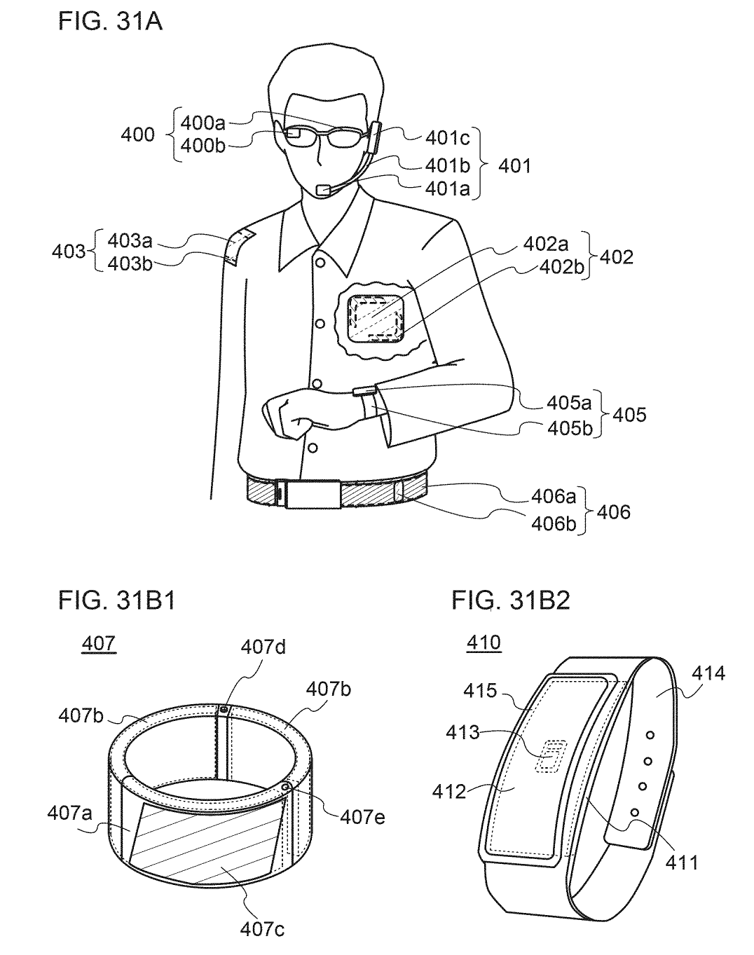

The secondary battery including the negative electrode described in the above embodiment can be provided in wearable devices illustrated in FIG. 31.

For example, the secondary battery can be provided in a glasses-type device 400 illustrated in FIG. 31(A). The glasses-type device 400 includes a frame 400a and a display portion 400b. The secondary battery is provided in a temple of the frame 400a having a curved shape, whereby the glasses-type device 400 can have a well-balanced weight and can be used continuously for a long time.

The secondary battery can be provided in a headset-type device 401. The headset-type device 401 includes at least a microphone portion 401a, a flexible pipe 401b, and an earphone portion 401c. The secondary battery can be provided in the flexible pipe 401b and the earphone portion 401c.

Furthermore, the secondary battery can be provided in a device 402 that can be attached directly to a body. A secondary battery 402b can be provided in a thin housing 402a of the device 402.

Furthermore, the secondary battery can be provided in a device 403 that can be attached to clothes. A secondary battery 403b can be provided in a thin housing 403a of the device 403.

Furthermore, the secondary battery can be provided in a watch-type device 405. The watch-type device 405 includes a display portion 405a and a belt portion 405b, and the secondary battery can be provided in the display portion 405a or the belt portion 405b.

Furthermore, the secondary battery can be provided in a belt-type device 406. The belt-type device 406 includes a belt portion 406a and a wireless power feeding and receiving portion 406b, and the secondary battery can be provided inside the belt portion 406a.

The secondary battery including the negative electrode described in the above embodiment can be provided in a wristband device 407 illustrated in FIG. 31(B1). The wristband device 407 includes two curved secondary batteries 407b in a case 407a. A curved display portion 407c is provided over a surface of the case 407a. For the display portion that can be used for the display portion 407c, the description of the display portion in FIG. 28 can be referred to. The wristband device 407 includes a connection portion 407d and a hinge portion 407e. A portion between the connection portion 407d and the hinge portion 407e can be flexibly moved using the hinge portion 407e as an axis. Charging or the like through an external terminal provided in the connection portion 407d is also possible.

The secondary battery including the negative electrode described in the above embodiment can be provided in a wearable device 410 illustrated in FIG. 31(B2). The wearable device 410 is provided with a curved secondary battery 412 and a sensor portion 413 in a main body 411. The wearable device 410 includes a display portion 415 and a band portion 414 and can be worn on a wrist, for example. For the display portion that can be used for the display portion 415, the description of the display portion in FIG. 28 can be referred to.

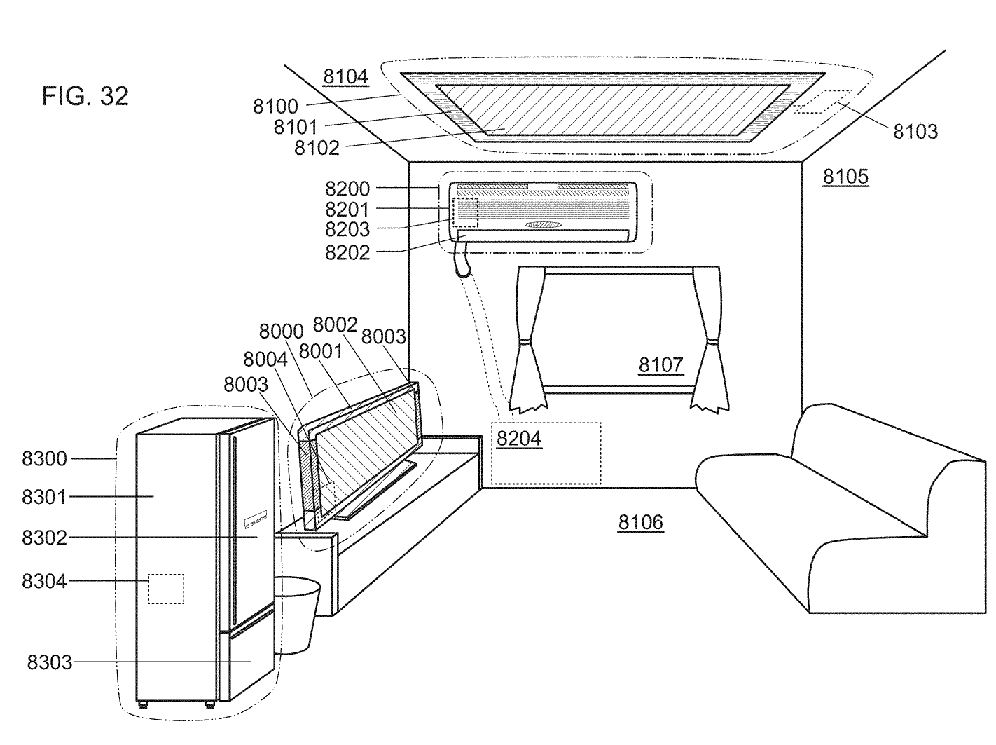

FIG. 32 illustrates other examples of electronic devices. In FIG. 32, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can receive electric power from a commercial power supply. Alternatively, the display device 8000 can use electric power stored in the secondary battery 8004. Thus, the display device 8000 can operate with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides TV broadcast reception.

In FIG. 32, an installation lighting device 8100 is an example of an electronic device including a secondary battery 8103 of one embodiment of the present invention. Specifically, the lighting device 8100 includes a housing 8101, a light source 8102, the secondary battery 8103, and the like. Although FIG. 32 illustrates the case where the secondary battery 8103 is provided in a ceiling 8104 on which the housing 8101 and the light source 8102 are installed, the secondary battery 8103 may be provided in the housing 8101. The lighting device 8100 can receive electric power from a commercial power supply. Alternatively, the lighting device 8100 can use electric power stored in the secondary battery 8103. Thus, the lighting device 8100 can operate with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 32 as an example, the secondary battery of one embodiment of the present invention can be used in an installation lighting device provided in, for example, a wall 8105, a floor 8106, or a window 8107 other than the ceiling 8104. Alternatively, the secondary battery of one embodiment of the present invention, can be used in a tabletop lighting device or the like.

As the light source 8102, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 32, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 32 illustrates the case where the secondary battery 8203 is provided m the indoor unit 8200, the secondary battery 8203 may be provided in the outdoor unit 8204. Alternatively, the secondary batteries 8203 may be provided in both the indoor unit 8200 and the outdoor unit 8204. The air conditioner can receive electric power from a commercial power supply. Alternatively, the air conditioner can use electric power stored in the secondary battery 8203. Particularly in the case where the secondary batteries 8203 are provided in both the indoor unit 8200 and the outdoor unit 8204, the air conditioner can operation with the use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 32 as an example, the secondary battery of one embodiment of the present invention can be used in an integral-type air conditioner in which the functions of an indoor unit and an outdoor unit are integrated in one housing.

In FIG. 32, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided in the housing 8301 in FIG. 32. The electric refrigerator-freezer 8300 can receive electric power from a commercial power supply. Alternatively, the electric refrigerator-freezer 8300 can use electric power stored in the secondary battery 8304. Thus, the electric refrigerator-freezer 8300 can operate with the use of the secondary battery 8304 of one embodiment of the present invention as an uninterruptible power supply even when electric power cannot be supplied from a commercial power supply due to power failure or the like.

This embodiment can be implemented in an appropriate combination with any of the other embodiments.

### Embodiment 8

In this embodiment, examples of vehicles including the secondary battery including the negative electrode described in the above embodiment will be described.

The use of secondary batteries in vehicles can lead to next-generation clean energy vehicles such as hybrid electric vehicles (HEVs), electric vehicles (EVs), and plug-in hybrid electric vehicles (PHEVs).

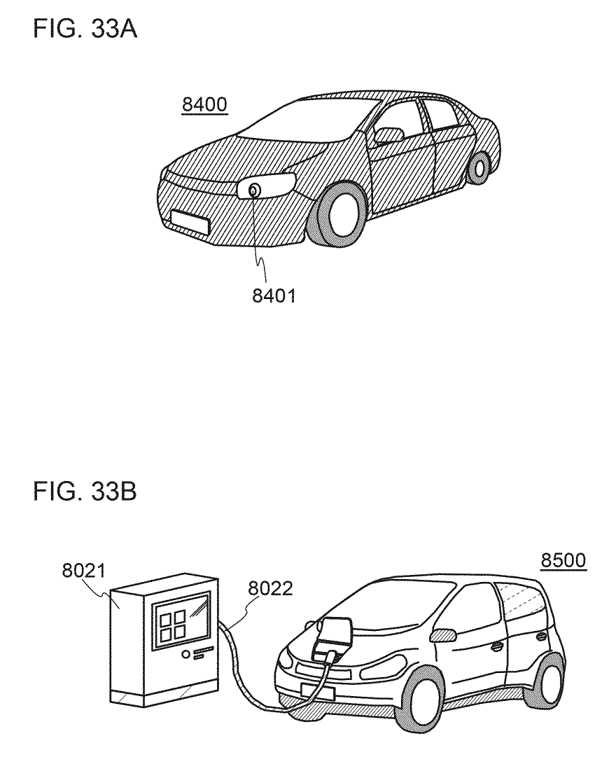

FIG. 33 illustrates examples of a vehicle using one embodiment of the present invention. An automobile 8400 illustrated in FIG. 33(A) is an electric vehicle which runs on the power of the electric motor. Alternatively, the automobile 8400 is a hybrid electric vehicle capable of driving using either the electric motor or the engine as appropriate. One embodiment of the present invention achieves a high-mileage vehicle. The automobile 8400 includes the secondary battery. The secondary battery is used not only for driving the electric motor, but also for supplying electric power to a light-emitting device such as a headlight 8401 or a room light (not illustrated).

The secondary battery can also supply electric power to a display device of a speedometer, a tachometer, or the like included in the automobile 8400. Furthermore, the secondary battery can supply electric power to a semiconductor device included in the automobile 8400, such as a navigation system.

The automobile 8500 illustrated in FIG. 33(B) can be charged when a secondary battery included in the automobile 8500 is supplied with electric power through external charging equipment by a plug-in system, a contactless power feeding system, or the like. In FIG. 33(B), the power storage device included in the automobile 8500 is charged with the use of a ground-based changing apparatus 8021 through a cable 8022. In charging a given method such as CHAdeMO (registered trademark) or Combined Charging System may be employed as a charging method, the standard of a connector, or the like as appropriate. The charging apparatus 8021 may be a charging station provided in a commerce facility or a power source in a house. For example, with the use of a plug-in technique, the secondary battery included in the automobile 8500 can be charged by being supplied with electric power from outside, for example. The charging can be performed by converting AC electric power into DC electric power through a converter such as an AC-DC converter.

Further, although not illustrated, the vehicle may include a power receiving device so as to be charged by being supplied with electric power from an above-ground power transmitting device in a contactless manner. In the case of the contactless power feeding system, by fitting a power transmitting device in a road or an exterior wall, charging can be performed not only when the electric vehicle is stopped but also when driven. In addition, the contactless power feeding system may be utilized to perform transmission and reception of electric power between vehicles. Furthermore, a solar cell may be provided in the exterior of the automobile to charge the secondary battery when the automobile stops or moves. To supply electric power in such a contactless manner, an electromagnetic induction method or a magnetic resonance method can be used.

Furthermore, the secondary battery included in the vehicle can be used as a power source for supplying electric power to products other than, the vehicle. In such a case, the use of a commercial power source can be avoided at peak time of electric power demand.

This embodiment can be implemented in an appropriate combination with any of the other embodiments.

### EXAMPLE 1

In this example, cross-sectional TEM observation results and ²⁹Si-NMR measurement results on a particle which is a mixture of Si, Li₂SiO₃, and Li₂O and ²⁹Si-NMR measurement results on SiO after one charge and discharge cycle are described.

<Manufacture of Particle which is a Mixture of Si, Li₂SiO₃, and Li₂O>

First, a copper foil was prepared as a negative electrode current collector. As a raw material of the particle which is the mixture of Si, Li₂SiO₃, and Li₂O, a SiO particle covered with carbon was prepared. As a binder, polyimide was prepared. As a conductive additive, acetylene black was prepared.

Next, a material in which the SiO particle, polyimide, and acetylene black were mixed at SiO particle:polyimide:acetylene black=80:5:15 (weight ratio) was applied over the negative electrode current collector as a negative electrode active material layer, and the negative electrode current collector and the negative electrode active material layer were processed into the shape of the negative electrode.

The thus fabricated electrode was used as one electrode and metallic lithium was used as the other electrode. These were made in contact with an electrolytic solution.

Next, the electrode fabricated above and metallic lithium were electrically connected to each other, a voltage of 0.4 V on the lithium basis was applied so that lithium was inserted into the SiO particle. The lithium insertion amount in the electric charge amount was 600 mAh/g per SiO weight.

The electrode in which the particle which is the mixture of Si, Li₂SiO₃, and Li₂O was formed by insertion of lithium into the SiO particle in the above-described step was referred to as Sample A.

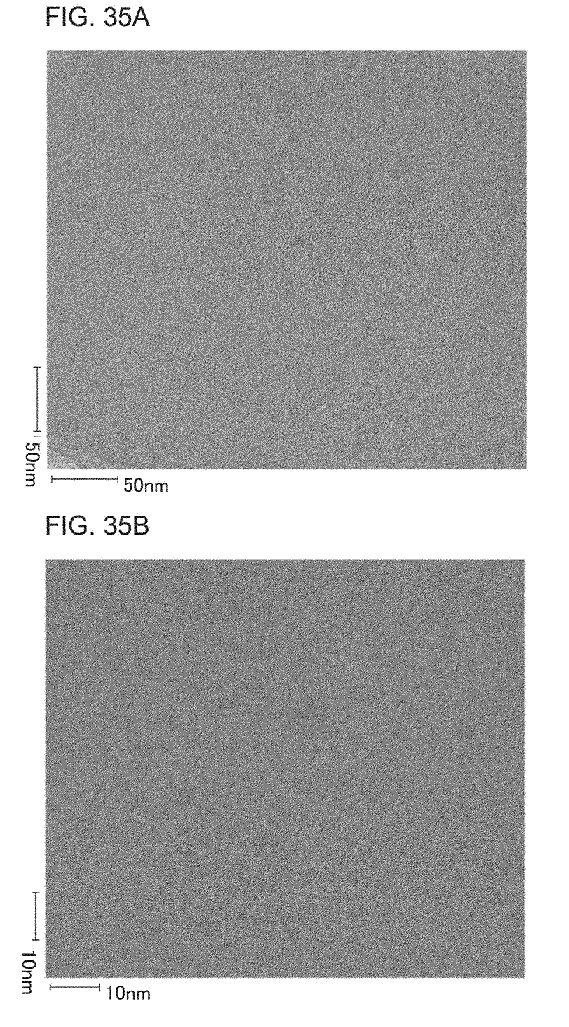

FIGS. 35(A) and (B) show cross-sectional TEM images of the particle which is the mixture of Si, Li₂SiO₃, and Li₂O included in Sample A. A crystal grain or the like is not observed in FIGS. 35(A) and (B), which proved that Si, Li₂SiO₃, and Li₂O were evenly mixed.

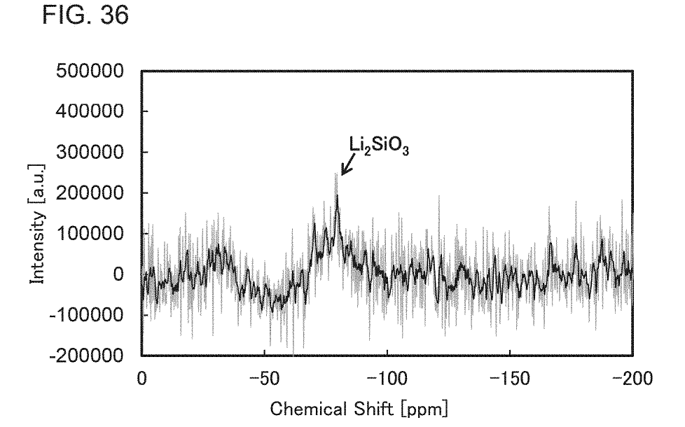

Furthermore, FIG. 36 shows ²⁹Si-NMR measurement results on the negative electrode active material layer separated from the negative electrode current collector in Sample A. A gray line shows the results of each of adjacent ten atoms, and a black line shows average movement of the ten atoms.

In the NMR spectrum in FIG. 36, a peak at −78 ppm of the chemical shift value indicating Li₂SiO₃ was observed, revealing that Sample A includes Li₂SiO₃, while no clear peak around −65 ppm of the chemical shift value indicating Li₄SiO₄ or around −108 ppm of the chemical shift value indicating SiO₂ was observed.

<Formation of SiO after One Charge and Discharge Cycle>

In the same manner as the formation of the negative electrode which is the mixture of Si, Li₂SiO₃, and Li₂O, an SiO particle polyimide, and acetylene black were applied over a negative electrode current collector to fabricate an electrode. Then, the electrode was used as one electrode and metallic lithium was used as the other electrode. These were trade in contact with an electrolytic solution.

Next, the electrode fabricated above and metallic lithium were electrically connected to each other, and one charge and discharge cycle was performed. Note that the discharge was performed with CCCV (constant current constant voltage) (termination conditions: after reaching 0.01 V, termination occurs when the current reached the value corresponding to 0.01 C), and the charge was performed with CC (constant current) (termination conditions: termination occurs when 1.5 V is reached).

The electrode fabricated through the above-described process was referred to as Sample B.

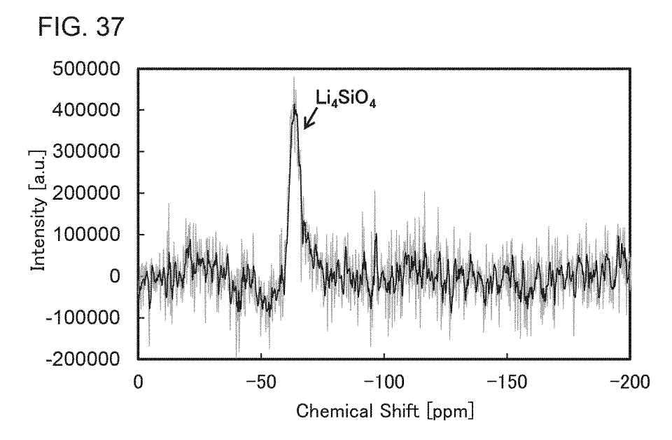

FIG. 37 shows ²⁹Si-NMR measurement results on the negative electrode active material layer separated from the negative electrode current collector in Sample B. A gray line shows the results of ten-time measurement, and a black line shows average values of the ten-time measurement.

In the NMR spectrum in FIG. 37, a peak at −65 ppm of the chemical shift value indicating Li₄SiO₄ was observed, revealing that Sample B includes Li₄SiO₄, while no clear peak around −108 ppm of the chemical shift value indicating SiO₂ or around −78 ppm of the chemical shift value indicating Li₂SiO₃ was observed.

The results in FIG. 36 and FIG. 37 show that Li₂SiO₃ is formed in the case where lithium is inserted at a voltage of 0.4 V which does not cause formation of alloyed LiₓSi and that Li₄SiO₄ is formed by one charge and discharge cycle. Thus it was found that the formed substance (Li₂SiO₃ or Li₄SiO₄) is different depending on the lithium insertion method and these can be identified by ²⁹Si-NMR.

### EXAMPLE 2

In this example, the discharge capacity was compared among the case where a particle which is a mixture of Si, Li₂SiO₃, and Li₂O was used as a negative electrode active material, the case where gallium was used, and the case where graphite was used, and the results are described.

<Secondary Battery using a Particle which is a Mixture of Si, Li₂SiO₃, and Li₂O as a Negative Electrode Active Material>

First, a negative electrode was fabricated in a manner similar to that of Sample A in Example 1.

Furthermore, a positive electrode was fabricated using, as a positive electrode active material included in a positive electrode active material layer, a particle represented by Li_{1.68}Mn_{0.8062}Ni_{0.318}O₃ covered with graphene that is formed by reducing graphene oxide.

A secondary battery fabricated using the above-described negative electrode and positive electrode was referred to as Sample C.

<Secondary Battery using Gallium as a negative Electrode Active Material>

First a negative electrode was fabricated using a copper foil as a negative electrode current collector and metallic gallium melted and mixed with a binder and a conductive additive (acetylene black or a carbon fiber formed by a vapor-phase method) as a negative electrode active material included in a negative electrode active material layer.

Furthermore, a positive electrode was fabricated using a particle represented by Li_{1.68}Mn_{0.8062}Ni_{0.318}O₃ as a positive electrode active material included in a positive electrode active material layer.

A secondary battery fabricated using the above-described negative electrode and positive electrode was referred to as Sample D.

<Secondary Battery using Graphite as a Negative Electrode Active Material>

Next, as a comparative example, a commercial battery using graphite as a negative electrode active material and lithium cobalt oxide (LiCoO₂) as a positive electrode active material was prepared. The battery was referred to as Sample E.

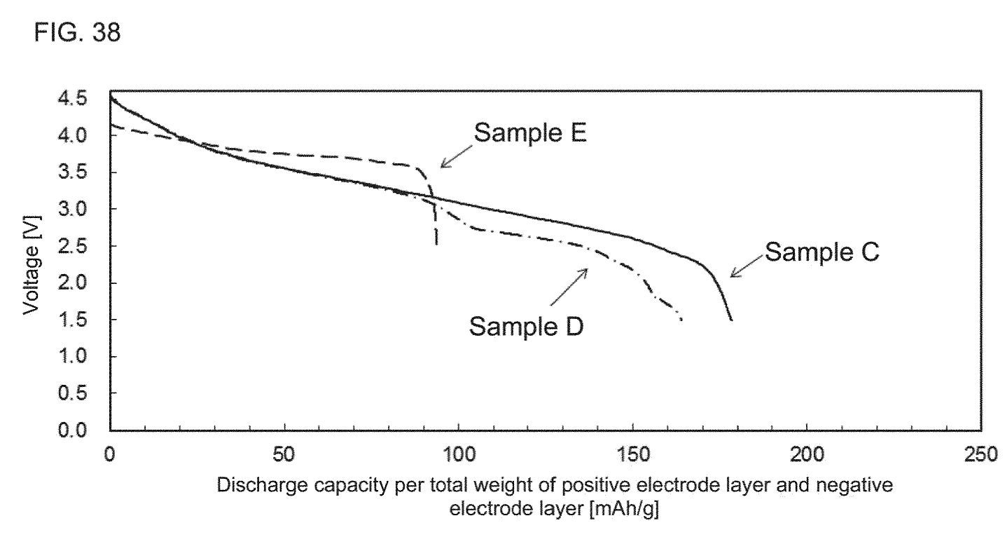

Charge and discharge was performed in Sample C, Sample D, and Sample E described above. The discharge capacity per total weight of the positive electrode active material layer and the negative electrode active material layer at this time is shown in FIG. 38. In the graph, a solid line, a dashed-dotted line, and a broken line represent discharge capacities of Sample C, Sample D, and Sample E, respectively.

FIG. 38 has revealed that the battery using the particle which is the mixture of Si, Li₂SiO₃, and Li₂O and the particle represented by Li_{1.68}Mn_{0.8062}Ni_{0.318}O₃ covered with graphene that is formed by reducing graphene oxide is a high-capacity battery having approximately twice as large capacity per weight of the active material as the commercial battery using graphite and lithium cobalt oxide.

Furthermore, it has also been revealed that the battery using the particle which is the mixture of Si, Li₂SiO₃, and Li₂O and the particle represented by Li_{1.68}Mn_{0.8062}Ni_{0.318}O₃ covered with graphene that is formed by reducing graphene oxide has higher capacity than the battery using gallium known as a high-capacity negative electrode material.

### EXAMPLE 3

In this example, cycle characteristics were compared between the case where the particle which is the mixture of Si, Li₂SiO₃, and Li₂O was used as a negative electrode active material and the case where gallium was used, and the results are described.

In this example, Sample C of Example 2 was used as a secondary battery using the particle which is the mixture of Si, Li₂SiO₃, and Li₂O, and Sample D of Example 2 was used as a battery using gallium.

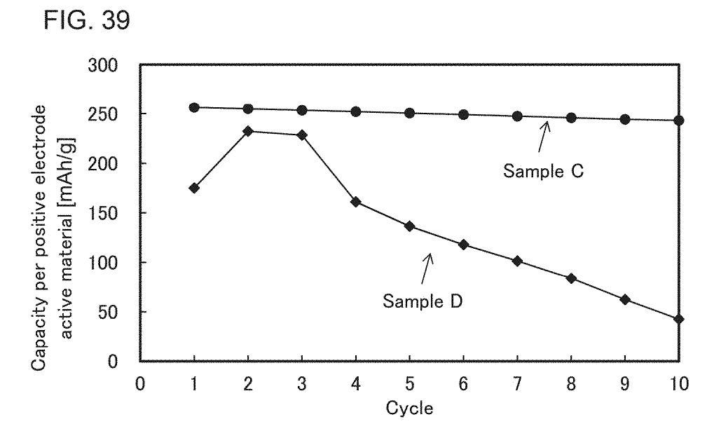

FIG. 39 shows results often charge and discharge cycles on Sample G and Sample D. In the drawing, a circular marker represents Sample C, and a quadrangular marker represents Sample B.

As shown in FIG. 39, the capacity of the secondary battery using gallium known as a high-capacity negative electrode material reduced to 50% or lower after ten cycles, while the capacity of the secondary battery using the particle which is the mixture of Si, Li₂SiO₃, and Li₂O as a negative electrode active material did not largely decrease even after ten cycles. Therefore, the particle which is the mixture of Si, Li₂SiO₃, and Li₂O was found to be a material having favorable cycle characteristics compared with gallium.

### REFERENCE NUMERALS

100 secondary battery
100a secondary battery
100b secondary battery
100c secondary battery
100d secondary battery
100e secondary battery
101 positive electrode current collector
102 positive electrode active material layer
103 separator
103a region
103b region
104 electrolytic solution
105 negative electrode current collector
105a negative electrode current collector
106 negative electrode active material layer
106a negative electrode active material layer
107 exterior body
111 positive electrode
111a positive electrode
113 negative electrode
115a negative electrode
115a negative electrode
115b negative electrode
115c negative electrode
115d negative electrode
116 negative electrode active material layer
120 sealing layer
121 positive electrode lead
125 negative electrode lead
130 electrode assembly
131 electrode assembly
135 electrode
151 switch
152 current control switch
154 switch pair
200 electrode processing device
201 lithium
203 separator
204 electrolytic solution
207 container
210 voltage application device
211a terminal
211b terminal
221 hole
321 graphene
322 negative electrode active material
323 conductive additive
331 first region
332 second region
333 third region
400 glasses-type device
400a frame
400b display region
401 headset-type device
401a microphone portion
401b flexible pipe
401c earphone portion
402 device
402a housing
402b secondary battery
403 device
403a housing
403b secondary battery
405 watch-type device
405a display portion
405b belt portion
406 belt-type device
406a belt portion
406b wireless power feeding and receiving portion
407 wristband device
407a case
407b secondary battery
407c display portion
407d connection portion
407e hinge portion
410 wearable device
411 main body
412 secondary battery
413 sensor portion
414 band portion
415 display portion
600 secondary portion
601 positive electrode cap
602 battery can
603 positive electrode terminal
604 positive electrode
605 separator
606 negative electrode
607 negative electrode terminal
608 insulating plate
609 insulating plate
611 PTC element
612 safety valve mechanism
900 circuit board
910 label
911 terminal
912 circuit
913 secondary battery
914 antenna
915 antenna
916 layer
917 layer
918 antenna
919 terminal
920 display device
921 sensor
922 terminal
951 terminal
952 terminal
981 film
982 film
990 secondary battery
991 exterior body
992 exterior body
993 wound body
994 negative electrode
995 positive electrode
996 separator
997 lead electrode
998 lead electrode
7100 portable display device
7101 housing
7102 display portion
7103 operation button
7104 secondary battery
7300 armband device
7301 arm
7400 mobile phone
7401 housing
7402 display portion
7403 operation button
7404 external connection port
7405 speaker
7406 microphone
7407 secondary battery
7408 lead electrode
7409 current collector
7500 stove
7501 secondary battery
7510 stove
7511 module
7511a air outlet
7511b external terminal
7512 main body
7512a opening
7513 grill
8000 display device
8001 housing
8002 display portion
8003 speaker portion
8004 secondary battery
8021 charging apparatus
8022 cable
8100 lighting device
8101 housing
8102 light source
8103 secondary battery
8104 ceiling
8105 wall
8106 floor
8107 window
8200 indoor unit
8201 housing
8202 air outlet
8203 secondary battery
8204 outdoor unit
8300 electric refrigerator-freezer
8301 housing
8302 refrigerator door
8303 freezer door
8304 secondary battery
8400 automobile
8401 headlight
8500 automobile
9600 tablet terminal
9625 switch
9626 switch
9627 power switch
9628 operation switch
9629 fastener
9630 housing
9630a housing
9630b housing
9631 display portion
9631a display portion
9631b display portion
9632a region
9632b region
9633 solar cell
9634 charge and discharge control circuit
9635 secondary battery
9636 DC-DC converter
9637 converter
9638 operation key
9639 button
9640 movable portion
BT00 power storage device
BT01 terminal pair
BT02 terminal pair
BT03 control circuit
BT04 circuit
BT05 circuit
BT06 voltage transformation control circuit
BT07 voltage transformer circuit
BT08 battery portion
BT09 battery cell
BT10 transistor

### BT11 bus

### BT12 bus

BT13 transistor
BT14 current control switch

### BT15 bus

### BT16 bus

BT17 switch pair
BT18 switch pair
BT21 transistor pair
BT22 transistor
BT23 transistor

### BT24 bus

### BT25 bus

BT31 transistor pair
BT32 transistor
BT33 transistor

### BT34 bus

### BT35 bus

BT41 battery management unit
BT51 insulated DC-DC converter
BT52 switch portion
BT53 transformer
S1 control signal
S2 control signal
S3 voltage transformation signal
SW1 switch
SW2 switch
SW3 switch

1. A negative electrode active material for a lithium-ion secondary battery, the negative electrode active material being a particle including Si, Li₂SiO₃, and Li₂O,
wherein in a ²⁹Si-NMR spectrum of the particle, an intensity at −78 ppm of the ²⁹Si-NMR spectrum is higher than or equal to 50 times an intensity at −108 ppm.

2. A manufacturing method of a negative electrode for a lithium-ion secondary battery, comprising:
a step of applying a particle including silicon over a negative electrode current collector;
a step of making the negative electrode current collector over which the particle including silicon is applied and lithium be in contact with an electrolytic solution; and
a step of electrically connecting the negative electrode current collector over which the particle including silicon is applied and the lithium and inserting lithium into the particle including silicon at a voltage of higher than or equal to 0.3 V and lower than or equal to 0.6 V on a lithium basis,
wherein the negative electrode active material for the lithium-ion secondary battery according to claim 1 is formed after the step of inserting the lithium.

3. A lithium-ion secondary battery comprising a positive electrode and a negative electrode,
wherein the positive electrode comprises a positive electrode active material,
wherein the positive electrode active material comprises a positive electrode active material particle satisfying LiₐMn_{b}Ni_{c}O_{d}(1.6≦a≦1.848, 0.19≦c/b≦0.935, 2.5≦d≦3),
wherein the negative electrode comprises a negative electrode active material,
wherein the negative electrode active material comprises a negative electrode active material particle including Si, Li₂SiO₃, and Li₂O, and
wherein in a ²⁹Si-NMR spectrum of the negative electrode active material particle, an intensity at −78 ppm of the ²⁹Si-NMR spectrum is higher than or equal to 50 times an intensity at −108 ppm.

4. A manufacturing method of a negative electrode for a lithium-ion secondary battery, comprising:
a step of applying a particle including silicon over a negative electrode current collector;
a step of making the negative electrode current collector over which the particle including silicon is applied and lithium be in contact with an electrolytic solution; and
a step of electrically connecting the negative electrode current collector over which the particle including silicon is applied and the lithium and inserting lithium into the particle including silicon at a voltage of higher than or equal to 0.3 V and lower than or equal to 0.6 V on a lithium basis.

5. A processing device of a negative electrode, for a lithium-ion secondary battery, comprising:
a terminal capable of being electrically connected to a current collector; lithium; and an electrolytic solution,
wherein the terminal and the lithium can be electrically connected to each other; and
wherein a voltage higher than or equal to 0.3 V and lower than or equal to 0.6 V on a lithium basis can be applied between the terminal and the lithiu
